(19) United States
(12) Patent Application Publication
(10) Pub. No.: US 2026/0064033 A1
(43) Pub. Date: Mar. 5, 2026

(54) LIGHT SCANNING APPARATUS AND IMAGE FORMING APPARATUS INCLUDING THE SAME

(71) Applicant: CANON KABUSHIKI KAISHA, Tokyo (JP)

(72) Inventors: Kazumi KIMURA, Saitama (JP); Hiroki YOSHIDA, Tochigi (JP); Hayato KATO, Tochigi (JP)

(21) Appl. No.: 19/303,748

(22) Filed: Aug. 19, 2025

(30) Foreign Application Priority Data
Aug. 30, 2024 (JP) 2024-148571

(51) Int. Cl. G03G 15/043; G02B 26/12; G03G 15/04

(52) U.S. Cl. CPC G03G 15/0435; G02B 26/123; G03G 15/04072; G03G 15/0409; G03G 2215/0404

(57) ABSTRACT

A light scanning apparatus according to the present disclosure includes a deflecting unit configured to deflect a light flux from a light source to scan a surface in a main scanning direction, and a first optical system configured to guide the light flux deflected by the deflecting unit to the surface to be scanned, in which a width of the light flux immediately before being incident on a first deflecting surface of the deflecting unit is smaller than a width of the first deflecting surface in a main scanning cross section, and only a part of the light flux incident on the deflecting unit is deflected toward the surface to be scanned by the first deflecting surface when the first deflecting surface is at a first angle in the main scanning cross section.

### BACKGROUND

### Field of the Technology

The present disclosure is related to a light scanning apparatus, and more particularly to a light scanning apparatus suitably used in an image forming apparatus such as a laser beam printer or a multi-function printer having an electrophotographic process.

### Description of the Related Art

Conventionally, a light scanning apparatus has been used as an exposure apparatus mounted on an image forming apparatus such as a laser beam printer using an electrophotographic process.

The light scanning apparatus can be classified into an underfilled scan (UFS) type and an overfilled scan (OFS) type according to a relationship between a size of an incident light flux incident on a deflecting unit and a size of a deflecting surface.

Specifically, in the UFS type, a width of the incident light flux incident on the deflecting unit is smaller than a width of the deflecting surface of the deflecting unit in a main scanning cross section, whereas, in the OFS type, the width of the incident light flux incident on the deflecting unit is larger than the width of the deflecting surface of the deflecting unit in the main scanning cross section.

Japanese Patent Laid-open No. 2005-92129 discloses a light scanning apparatus adopting the UFS type.

### SUMMARY

A light scanning apparatus according to the present disclosure includes a deflecting unit configured to deflect a light flux from a light source to scan a surface in a main scanning direction, and a first optical system configured to guide the light flux deflected by the deflecting unit to the surface to be scanned, in which a width of the light flux immediately before being incident on a first deflecting surface of the deflecting unit is smaller than a width of the first deflecting surface in a main scanning cross section, and only a part of the light flux incident on the deflecting unit is deflected toward the surface to be scanned by the first deflecting surface when the first deflecting surface is at a first angle in the main scanning cross section.

Features of the present disclosure will become apparent from the following description of embodiments with reference to the attached drawings. The following description of embodiments is described by way of example.

### BRIEF DESCRIPTION OF THE DRAWINGS

FIG. 1 is a main scanning cross sectional view of a light scanning apparatus according to a first embodiment of the present invention.

FIG. 2A is a partially enlarged main scanning cross sectional view of the light scanning apparatus according to the first embodiment.

FIG. 2B is a partially enlarged main scanning cross sectional view of the light scanning apparatus according to the first embodiment.

FIG. 2C is a partially enlarged main scanning cross sectional view of the light scanning apparatus according to the first embodiment.

FIG. 2D is a partially enlarged main scanning cross sectional view of the light scanning apparatus according to the first embodiment.

FIG. 3 is a graph showing an angle dependence of a light flux width of a light flux in the light scanning apparatus according to the first embodiment.

FIG. 4A is a main scanning cross sectional view of a light scanning apparatus according to a second embodiment of the present invention.

FIG. 4B is a graph showing an angle dependence of a light flux width of a light flux in the light scanning apparatus according to the second embodiment.

FIG. 5A is a main scanning cross sectional view of a light scanning apparatus according to a third embodiment of the present invention.

FIG. 5B is a graph showing an angle dependence of a light flux width of a light flux in the light scanning apparatus according to the third embodiment.

FIG. 6A is a main scanning cross sectional view of a light scanning apparatus according to a fourth embodiment of the present invention.

FIG. 6B is a graph showing an angle dependence of a light flux width of a light flux in the light scanning apparatus according to the fourth embodiment.

FIG. 7A is a main scanning cross sectional view of a light scanning apparatus according to a fifth embodiment of the present invention.

FIG. 7B is a graph showing an angle dependence of a light flux width of a light flux in the light scanning apparatus according to the fifth embodiment.

FIG. 8 is a partially enlarged main scanning cross sectional view of the light scanning apparatus according to the fifth embodiment.

FIG. 9A is a main scanning cross sectional view of a light scanning apparatus according to a sixth embodiment of the present invention.

FIG. 9B is a graph showing an angle dependence of a light flux width of a light flux in the light scanning apparatus according to the sixth embodiment.

FIG. 10A is a main scanning cross sectional view of a light scanning apparatus according to a seventh embodiment of the present invention.

FIG. 10B is a graph showing an angle dependence of a light flux width of a light flux in the light scanning apparatus according to the seventh embodiment.

FIG. 11A is a main scanning cross sectional view of a light scanning apparatus according to an eighth embodiment of the present invention.

FIG. 11B is a graph showing an angle dependence of a light flux width of a light flux in the light scanning apparatus according to the eighth embodiment.

FIG. 12A is a main scanning cross sectional view of a light scanning apparatus according to a ninth embodiment of the present invention.

FIG. 12B is a graph showing an angle dependence of a light flux width of a light flux in the light scanning apparatus according to the ninth embodiment.

FIG. 13A is a main scanning cross sectional view of a light scanning apparatus according to a tenth embodiment of the present invention.

FIG. 13B is a graph showing an angle dependence of a light flux width of a light flux in the light scanning apparatus according to the tenth embodiment.

FIG. 14 is a sub-scanning cross sectional view of a main part of an image forming apparatus according to the present embodiments.

### DESCRIPTION OF THE EMBODIMENTS

Hereinafter, a light scanning apparatus according to the present embodiments is described in detail with reference to the accompanying drawings. Note that the drawings described below may be drawn on a scale different from an actual scale in order to facilitate understanding of the present disclosure.

In the following description, a main scanning direction is a direction perpendicular to a rotation axis of a polygon mirror 5 and an optical axis of an imaging optical system 85 (a direction in which the polygon mirror 5 scans a surface to be scanned 7), and a sub-scanning direction is a direction parallel to the rotation axis of the polygon mirror 5.

A main scanning cross section is a cross section including the optical axis of the imaging optical system 85 and perpendicular to the sub-scanning direction, and a sub-scanning cross section is a cross section including the optical axis of the imaging optical system 85 and perpendicular to the main scanning direction.

Further, the main scanning direction is defined as a Y direction, the sub-scanning direction is defined as a Z direction, and a direction parallel to the optical axis of the imaging optical system 85 is defined as an X direction.

### First Embodiment

Conventionally, a light scanning apparatus has been used as an exposure apparatus mounted on an image forming apparatus such as a laser beam printer using an electrophotographic process.

In the light scanning apparatus, a light flux modulated in accordance with an image signal from, for example, a personal computer and emitted from a light source is guided to a deflecting unit such as a polygon mirror (rotary polygon mirror) by an incident optical system, and is then deflected by a deflecting surface of the deflecting unit.

Then, the deflected light flux is condensed in a spot shape on a photosensitive surface of a photosensitive drum as a surface to be scanned by an imaging optical system, and the condensed light flux scans the surface to perform exposure recording of image information.

Further, there have been proposed various color image forming apparatuses for forming a color image by scanning photosensitive surfaces of a plurality of photosensitive drums by using a plurality of light scanning apparatuses.

In addition, the light scanning apparatus can be classified into an underfilled scan (UFS) type and an overfilled scan (OFS) type according to a relationship between a size of an incident light flux incident on the deflecting unit and a size of the deflecting surface.

Specifically, in the UFS type, a width of the incident light flux incident on the deflecting unit is smaller than a width of the deflecting surface of the deflecting unit in a main scanning cross section, whereas, in the OFS type, the width of the incident light flux incident on the deflecting unit is larger than the width of the deflecting surface of the deflecting unit in the main scanning cross section.

In the UFS type, the entire incident light flux incident on the deflecting surface of the deflecting unit is deflected by the deflecting surface to be guided to an imaging optical system (Fθ lens).

On the other hand, in the OFS type, a deflecting surface of a polygon mirror (rotary polygon mirror) forming the deflecting unit moves in the incident light flux incident on the deflecting surface of the deflecting unit with performing a function of a stop in a main scanning direction, so that the incident light flux is deflected to be cut off. The deflected light flux is guided to the imaging optical system (Fθ lens).

Therefore, in the OFS type, since the polygon mirror forming the deflecting unit can be easily downsized as compared with the UFS type, it is possible to achieve high-speed and high-definition printing in the light scanning apparatus.

In any of the OFS type and the UFS type, the light flux guided to the surface to be scanned by the imaging optical system is condensed as a beam spot on a printed area on the surface by an imaging performance of the imaging optical system.

At this time, a uniform spot diameter and a uniform light amount distribution are obtained over the entire printed area on the surface to be scanned in the UFS type.

On the other hand, in the UFS type, when the number of deflecting surfaces of the deflecting unit is increased in order to increase the speed, the size of the deflecting unit is increased, so that the size of the light scanning apparatus is increased, and a driving force of a motor for driving the deflecting unit is increased to increase a driving power, a driving noise and a vibration.

Further, in the OFS type, even when the number of deflecting surfaces is increased, the increase in size of the deflecting unit can be suppressed as compared with the UFS type. However, since a spot diameter and a light amount vary in accordance with an image height on the surface to be scanned, it is difficult to achieve uniform printing.

Therefore, in the related art, there has been proposed a light scanning apparatus including a deflecting unit that deflects all of an incident light flux in the vicinity of an on-axis image height on a surface to be scanned as in the UFS type, and deflects the incident light flux so as to vignette a part thereof in the vicinity of an outermost off-axis image height on the surface as in the OFS type.

However, it is difficult to reduce a size and cost of the light scanning apparatus. Specifically, in order to reduce the size of the light scanning apparatus, it is effective to perform wide-angle scanning in which a maximum scanning angle of view is set to be large so as to reduce a distance between the deflecting unit and the surface to be scanned.

However, in the above-described light scanning apparatus, since the maximum scanning angle of view is as small as 22° to 45°, the wide-angle scanning is not performed. Therefore, it is difficult to achieve downsizing.

On the other hand, when the maximum scanning angle of view is increased in order to reduce the size of the above-described light scanning apparatus, enlargement of a spot and variation in a light amount on the surface to be scanned become more significant as described below.

In the above-described light scanning apparatus, a value of a ratio of a width of the light flux scanning the on-axis image height to the width of the light flux scanning the outermost off-axis image height on the surface to be scanned is set to 1.2 or less in the main scanning cross section. That is, the maximum scanning angle of view is set such that the incident light flux is vignetted by 20% when the incident light flux is deflected toward the outermost off-axis image height by the deflecting surface.

However, in the above-described light scanning apparatus, when the incident light flux is deflected toward the outermost off-axis image height with being vignetted by 20% by the deflecting surface, the spot diameter increases by 20%, and the light amount decreases by 20% at the outermost off-axis image height.

In a conventional electrophotographic process, when the spot diameter in a print scanning region increases by 20% and the light amount decreases by 20%, it is difficult to perform uniform printing.

In this case, it is possible to suppress the enlargement of the spot and the variation of the light amount in the print scanning region by adjusting a light emission time and a light emission amount of a light source by providing an electrical correction circuit, but the provision of the electrical correction circuit causes an increase in size and cost of the light scanning apparatus.

Further, the polygon mirror as the deflecting unit provided in the above-described light scanning apparatus is large in size, and as the size of the polygon mirror increases, a material cost, the number of processes for processing reflecting surfaces of the polygon mirror, and a cost for forming films on the reflection surfaces increase.

Furthermore, in the case where the polygon mirror is large in size, the light scanning apparatus is increased in size and a driving force of a motor for driving the polygon mirror is increased, so that there also arises a problem that a driving electrical power, a driving noise and a vibration are increased.

In addition, in the above-described light scanning apparatus, synchronization detection for determining a timing at which scanning on the surface to be scanned is started is not sufficiently considered.

In light scanning apparatuses, the synchronization detection is performed by scanning a synchronization detection light receiving element at a timing of scanning an outside of a printed region of a surface to be scanned.

Therefore, in the above-described light scanning apparatus, since the synchronization detection is performed by deflecting the incident light flux by the deflecting surface such that a part thereof is vignetted to scan the synchronization detection light receiving element, the light scanning apparatus becomes increased in size unless an arrangement of a synchronization detection optical system is sufficiently considered.

Accordingly, an object of the present embodiment is to provide a light scanning apparatus which is downsized with maintaining high-speed and high-quality image recording by appropriately arranging a deflecting unit and each optical element.

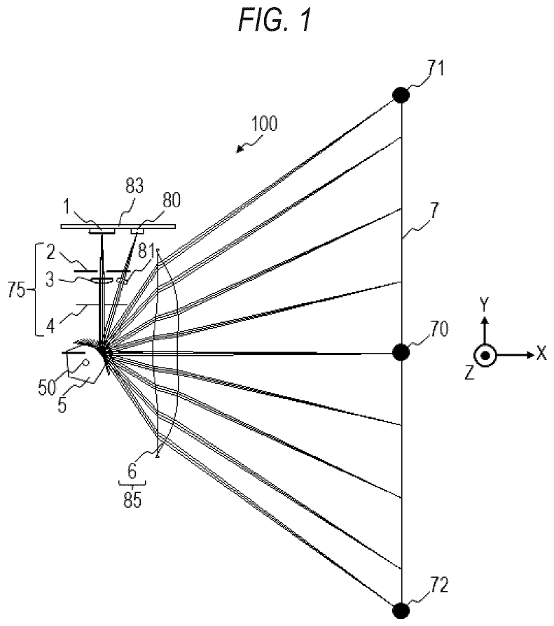

FIG. 1 shows a schematic main scanning cross sectional view of a light scanning apparatus 100 according to the first embodiment of the present invention.

The light scanning apparatus 100 according to the present embodiment includes a light source 1, a sub-scanning stop 2, an anamorphic collimator lens 3, a main scanning stop 4 and a polygon mirror 5 (deflecting unit).

Further, the light scanning apparatus 100 according to the present embodiment includes a scanning imaging lens 6 (imaging optical element), a synchronization detection light receiving element 80 (light receiving element), and a synchronization detection imaging element 81 (optical element).

The light source 1 is formed by, for example, a semiconductor laser and has at least one light emitting point.

The sub-scanning stop 2 limits a light flux width in the sub-scanning direction of a light flux emitted from the light source 1.

The anamorphic collimator lens 3 is a coupling optical element that has different powers in the main-scanning cross section and the sub-scanning cross section, and performs a function of coupling the light flux that has passed through the sub-scanning stop 2.

Specifically, the anamorphic collimator lens 3 converts the light flux that has passed through the sub-scanning stop 2 into a parallel light flux or a weakly converging light flux in the main scanning cross section, and converges the light flux so as to be condensed in the vicinity of a deflecting surface 51 of the polygon mirror 5 in the sub-scanning cross section.

The main scanning stop 4 limits a light flux width in the main scanning direction of the light flux that has passed through the anamorphic collimator lens 3.

The light scanning apparatus 100 according to the present embodiment employs a split stop type in which the sub-scanning stop 2 and the main scanning stop 4 are provided.

That is, in the light scanning apparatus 100 according to the present embodiment employing the split stop type, a plurality of light fluxes can be brought close to each other on the deflecting surface 51 of the polygon mirror 5 when the light source 1 has a plurality of light emitting points by providing the main scanning stop 4 at a position close to the polygon mirror 5.

As described later, in the light scanning apparatus 100 according to the present embodiment, the light flux is divided in accordance with the scanning angle of view on the deflecting surface 51 of the polygon mirror 5.

Therefore, it is possible to reduce a difference between division ratios of the plurality of light fluxes by bringing the plurality of light fluxes close to each other on the deflecting surface 51 of the polygon mirror 5.

Further, in the light scanning apparatus 100 according to the present embodiment, it is possible to form a conjugate image of the sub-scanning stop 2 by the anamorphic collimator lens 3 in the vicinity of the scanning imaging lens 6 by providing the sub-scanning stop 2 on a light source 1 side of the anamorphic collimator lens 3.

Thereby, since the plurality of light fluxes emitted from the light source 1 having the plurality of light emitting points pass through positions close to each other in the scanning imaging lens 6, it is possible to reduce a difference between optical characteristics of the plurality of light fluxes.

The difference between the optical characteristics of the plurality of light fluxes includes, for example, a difference in spot shape corresponding to a coma aberration caused by a curvature in the sub-scanning cross section of the scanning imaging lens 6, a shift in printing position caused by a refractive index distribution inside the scanning imaging lens 6, or the like.

Further, the difference between the optical characteristics of the plurality of light fluxes includes a difference in polarization state caused by a birefringence index distribution of the scanning imaging lens 6, a difference in light amount distribution caused by a difference in polarization dependency of reflectivity or transmissivity of an optical element provided on an optical path, or the like.

From the above discussion, it is preferred that the light scanning apparatus 100 according to the present embodiment employs the split stop type.

In the light scanning apparatus 100 according to the present embodiment, an incident optical system 75 (second optical system) is formed by the sub-scanning stop 2, the anamorphic collimator lens 3 and the main scanning stop 4.

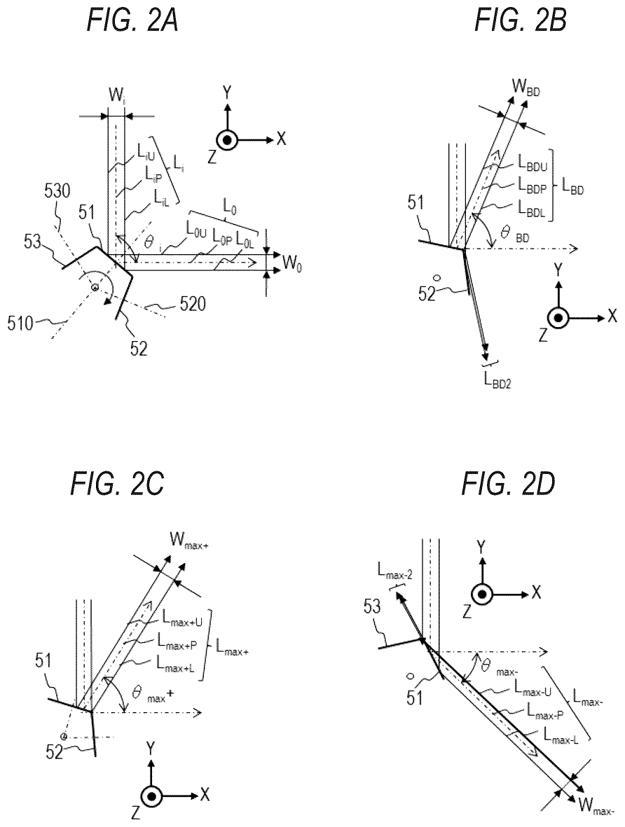

The polygon mirror 5 is a rotary polygon mirror having a function as the deflecting unit for deflecting the light flux emitted from the light source 1 and guided to the deflecting surface 51 by the incident optical system 75 toward the surface to be scanned 7 with rotating at a constant speed around a rotation shaft of a polygon motor (not shown) (see FIGS. 2A to 2D).

The polygon mirror 5 has a regular pentagon shape in the main scanning cross section so as to have five deflecting surfaces 51 which are optical reflecting surfaces each having a planar shape.

A position of the rotation shaft of the polygon motor for driving the polygon mirror 5 coincides with a center 50 of an inscribed circle inscribed in each of the deflecting surfaces 51 of the polygon mirror 5 or a center of a circumscribed circle passing through corners of each of the deflecting surfaces 51 in the main scanning cross section.

The polygon mirror 5 can be formed by cutting a metal block or by forming a base material by resin molding using a mold to apply a vapor deposition film on the deflecting surface 51.

In the light scanning apparatus 100 according to the present embodiment, a width of the light flux immediately before being incident on the deflecting surface 51 of the polygon mirror 5 by the incident optical system 75 is smaller than a width of the deflecting surface 51 in the main scanning cross section.

The scanning imaging lens 6 (scanning imaging element) condenses (guides) the light flux deflected by the polygon mirror 5 onto the surface to be scanned 7 such that a beam spot is formed on the surface 7.

Specifically, the scanning imaging lens 6 includes an incident surface and an exit surface each having a free curved surface shape expressed by an aspheric polynomial.

The scanning imaging lens 6 may have a constant speed characteristic of Y=Fθ for scanning the surface to be scanned 7 at a constant speed, or may have a non-constant speed characteristic of Y=tan θ or the like.

The scanning imaging lens 6 can be formed by molding an optical plastic using a mold.

As the polygon mirror 5 rotates, a printed region on the surface to be scanned 7 is scanned from a positive-side outermost off-axis image height 71 on a light source 1 side (a positive side in the Y direction) to a negative-side outermost off-axis image height 72 on a side opposite to the light source 1 (a negative side in the Y direction).

In the light scanning apparatus 100 according to the present embodiment, an imaging optical system 85 (first optical system) is formed by the scanning imaging lens 6.

In the light scanning apparatus 100 according to the present embodiment, the imaging optical system 85 is formed by the single scanning imaging lens 6 in order to reduce the cost, but the present invention is not limited thereto, and the imaging optical system 85 may be formed by a plurality of scanning imaging lenses.

In the light scanning apparatus 100 according to the present embodiment, an optical axis of the incident optical system 75 and an optical axis of the imaging optical system 85 are both within the main scanning cross section.

Therefore, a principal ray of the light flux emitted from the light emitting point of the light source 1 arranged in the main scanning cross section is deflected toward the surface to be scanned 7 in the main scanning cross section by the polygon mirror 5.

That is, the light scanning apparatus 100 according to the present embodiment adopts an in-deflecting-surface scanning type as described above.

The light scanning apparatus 100 according to the present embodiment is not limited thereto, and may not adopt the in-deflecting-surface scanning type, for example, the incident optical system 75 may be formed as an oblique incident optical system that causes the light flux to be obliquely incident on the deflecting surface 51 of the polygon mirror 5 in the sub-scanning cross section.

In the light scanning apparatus 100 according to the present embodiment, the optical axis of the incident optical system 75 is arranged so as to be parallel to the main scanning direction.

That is, an angle between the optical axis of the incident optical system 75 and the optical axis of the imaging optical system 85, in other words, an angle θᵢ formed by a traveling direction of the principal ray of the incident light flux Lᵢ immediately before being incident on the polygon mirror 5 in the main scanning cross section with respect to the X-axis is set to 90°.

Further, in the light scanning apparatus 100 according to the present embodiment, the light flux deflected by the polygon mirror 5 at a scanning angle of view outside a printed range on the surface to be scanned 7 (hereinafter, referred to as a synchronization detection light flux) is guided onto the synchronization detection light receiving element 80 by the synchronization detection imaging element 81.

Thereby, it is possible to determine a timing of a start of printing on the surface 7 in synchronization with the rotation of the polygon mirror 5.

Specifically, the synchronization detection imaging element 81 has a power for condensing the synchronization detection light flux deflected by the polygon mirror 5 at least in the main scanning cross section.

Further, in the light scanning apparatus 100 according to the present embodiment, a synchronization detection slit (not shown) extending in the sub-scanning direction and a synchronization detection edge portion (not shown) extending in the sub-scanning direction of the synchronization detection light receiving element 80 are arranged on a condensed point of the synchronization detection light flux by the synchronization detection imaging element 81.

In the light scanning apparatus 100 according to the present embodiment, a synchronization detection optical system is formed by the synchronization detection imaging element 81.

Specifically, as shown in FIG. 1, the synchronization detection optical system is provided such that an optical axis thereof is arranged between a traveling direction of the light flux incident on the deflecting surface 51 of the polygon mirror 5 and a traveling direction of the light flux traveling toward the positive-side outermost off-axis image height 71 when it is deflected by the deflecting surface 51.

Further, it is desirable that the synchronization detection light flux deflected by the polygon mirror 5 is condensed in the vicinity of the synchronization detection light receiving element 80 in the sub-scanning cross section by the synchronization detection imaging element 81.

However, if the synchronization detection light flux is excessively condensed in the sub-scanning cross section by the synchronization detection imaging element 81, a detection timing of the synchronization detection light receiving element 80 may vary depending on a linearity and a tolerance of installation angle of the synchronization detection edge portion (not shown).

Therefore, in general, a power in the sub-scanning cross section of the synchronization detection imaging element 81 is set such that the synchronization detection light flux is not excessively condensed in the sub-scanning cross section by the synchronization detection imaging element 81.

On the other hand, a case is considered in which the synchronization detection light flux is weakly condensed by the synchronization detection imaging element 81 such that a width of the synchronization detection light flux on the light receiving surface of the synchronization detection light receiving element 80 is substantially the same as a width of the light receiving surface in the sub-scanning cross section.

In this case, when the synchronization detection light flux is shifted in the sub-scanning direction due to tolerance or the like, a light amount of the synchronization detection light flux received by the synchronization detection light receiving element 80 varies, resulting in a decrease in detection accuracy.

The power in the sub-scanning cross section of the synchronization detection imaging element 81 may be determined in consideration of the above.

Note that the power in the main scanning cross section and that in the sub-scanning cross section of the synchronization detection imaging element 81 may be different from each other, and the synchronization detection imaging element 81 may have rotationally symmetric power.

Further, in the light scanning apparatus 100 according to the present embodiment, the synchronization detection optical system formed by the synchronization detection imaging element 81 is provided, but the present invention is not limited thereto, and the synchronization detection optical system may not be provided in a case where a variation in the synchronization detection timing is allowable.

In the light scanning apparatus 100 according to the present embodiment, the light source 1 and the synchronization detection light receiving element 80 are mounted on a single electrical mounting substrate 83 (substrate) as shown in FIG. 1.

In other words, in the light scanning apparatus 100 according to the present embodiment, the synchronization detection light receiving element 80 is arranged on the side where the light source 1 is arranged with respect to the optical axis of the imaging optical system 85 in the main scanning cross section.

Further, a light emission controller (light amount adjusting unit) (not shown) for controlling a light emission state of the light source 1 based on an output of the synchronization detection light receiving element 80 is provided on the electrical mounting substrate 83.

The light emission controller drives the light source 1 to emit light by determining timing of start of a print synchronized with an output timing of the synchronization detection light receiving element 80.

Further, the light emission controller drives the light source 1 to emit light with a light emission amount determined in advance or the light emission amount set at the time of assembly adjustment.

Furthermore, the light emission controller sets the light emission amount according to the number of deflecting surfaces 51 of the polygon mirror 5 at the time of assembly adjustment.

In addition, the light emission controller has a function of adjusting the light emission amount of the light source 1 in accordance with a sensitivity of the synchronization detection light receiving element 80 when performing the synchronization detection.

As described later, in the light scanning apparatus 100 according to the present embodiment, since the width of the synchronization detection light flux is smaller than the width of the light flux for scanning the surface to be scanned 7, an energy amount of the synchronization detection light flux decreases.

Therefore, when it is difficult for the synchronization detection light receiving element 80 to detect the synchronization detection light flux due to a large decrease in the energy amount of the synchronization detection light flux, the light emission amount of the light source 1 may be increased at a timing at which the synchronization detection is performed by the synchronization detection light receiving element 80.

Alternatively, a light receiving sensitivity adjusting unit for adjusting a light receiving sensitivity of the synchronization detection light receiving element 80 may be provided on the electrical mounting substrate 83.

The light receiving sensitivity adjusting unit may adjust the light receiving sensitivity of the synchronization detection light receiving element 80 in accordance with the number of deflecting surfaces 51 of the polygon mirror 5.

FIGS. 2A, 2B, 2C and 2D show partially enlarged schematic main scanning cross sectional views in the vicinity of the polygon mirror 5 of the light scanning apparatus 100 according to the present embodiment.

Specifically, FIGS. 2A and 2B show a view when an on-axis image height 70 on the surface to be scanned 7 is scanned and a view when the synchronization detection light receiving element 80 is scanned, respectively.

Further, FIGS. 2C and 2D show a view when a positive-side outermost off-axis image height 71 on the surface 7 is scanned and a view when a negative-side outermost off-axis image height 72 on the surface 7 is scanned, respectively.

As shown in FIG. 2A, when the on-axis image height 70 on the surface 7 is scanned, an incident light flux Lᵢ incident on the deflecting surface 51 of the polygon mirror 5 is deflected by the deflecting surface 51 so as to travel along the X axis as a scanning light flux L₀.

At this time, an angle (scanning angle of view) formed by the traveling direction of the scanning light flux L₀ with respect to the X axis is 0 degrees.

A width in the main scanning cross section of the incident light flux Lᵢ immediately before being incident on the deflecting surface 51 of the polygon mirror 5 is represented by Wᵢ, and a width in the main scanning cross section of the scanning light flux L₀ immediately after being deflected by the deflecting surface 51 is represented by W₀.

A normal 510 of the deflecting surface 51 passes through a rotation center 50 of the polygon mirror 5, a deflecting surface 52 adjacent to the deflecting surface 51 on a downstream side in a rotation direction has a normal 520, and a deflecting surface 53 adjacent to the deflecting surface 51 on an upstream side in the rotation direction has a normal 530.

The incident light flux Lᵢ has a principal ray Lip and marginal rays L_{iU} and L_{iL}, and the scanning light flux L₀ has a principal ray Lop and marginal rays L_{0U} and L_{0L}.

As shown in FIG. 2A, the width of the deflecting surface 51 of the polygon mirror 5 is larger than the width Wᵢ of the incident light flux Lᵢ in the main scanning cross section.

Since the scanning light flux L₀ for scanning the on-axis image height 70 is deflected in the vicinity of a central portion of the deflecting surface 51 of the polygon mirror 5, the width Wᵢ of the incident light flux Lᵢ is maintained in the scanning light flux L₀ such that W₀=Wᵢ is satisfied.

Next, as shown in FIG. 2B, when the synchronization detection light receiving element 80 is scanned, the incident light flux Lᵢ is incident on the deflecting surface 51 (first deflecting surface) of the polygon mirror 5 arranged at a predetermined angle (first angle) in the main scanning cross section.

The predetermined angle is an angle formed by the normal 510 of the deflecting surface 51 with respect to the X axis.

Then, the incident light flux Lᵢ incident on the deflecting surface 51 of the polygon mirror 5 arranged at the predetermined angle is deflected by the deflecting surface 51 so as to travel as a scanning light flux L_{BD} in a direction forming a predetermined angle with respect to the X axis.

At this time, an angle formed by a traveling direction of a principal ray of the scanning light flux L_{BD} immediately after being deflected by the polygon mirror 5 with respect to the X axis is represented by θ_{BD}, and a width in the main scanning cross section of the scanning light flux L_{BD} immediately after being deflected by the deflecting surface 51 is represented by W_{BD}.

The scanning light flux L_{BD} has the principal ray L_{BDP} and marginal rays L_{BDU} and L_{BDL}.

Here, as shown in FIG. 2B, when the synchronization detection light receiving element 80 is scanned, a part (another part) of the incident light flux Lᵢ is incident on the deflecting surface 52 (second deflecting surface) adjacent to the deflecting surface 51 of the polygon mirror 5 on the downstream side in the rotation direction.

Then, the part of the incident light flux Lᵢ incident on the deflecting surface 52 is deflected as a scanning light flux L_{BD2}.

That is, in the light scanning apparatus 100 according to the present embodiment, the incident light flux Lᵢ is deflected by the polygon mirror 5 so as to be separated (divided) into the two scanning light fluxes L_{BD} and L_{BD2} when the synchronization detection light receiving element 80 is scanned.

In other words, in the light scanning apparatus 100 according to the present embodiment, only a part of the incident light flux Lᵢ incident on the polygon mirror 5 whose deflecting surface 51 is arranged at the predetermined angle in the main scanning cross section is deflected by the deflecting surface 51.

Then, the scanning light flux L_{BD} scans a center of a light receiving surface of the synchronization detection light receiving element 80 via the synchronization detection imaging element 81.

On the other hand, the scanning light flux L_{BD2} travels in a direction forming an angle different from an angle θ_{BD} of the scanning light flux L_{BD} with respect to the X axis.

Specifically, the scanning light flux L_{BD2} travels in a direction forming an angle of (θ_{BD}−360/N×2) degrees with respect to the X axis. Here, N is the number of deflecting surfaces 51 of the polygon mirror 5.

At this time, if the scanning imaging lens 6 is arranged so as to be sufficiently separated from the polygon mirror 5, the scanning light flux L_{BD2} is not incident on the scanning imaging lens 6 and thus is not guided to the surface to be scanned 7, namely the scanning light flux L_{BD2} travels toward an outside of an effective region of the surface 7.

Then, the scanning light flux L_{BD2} is shielded by a wall surface, a rib or the like of a housing (not shown) of the light scanning apparatus 100.

Further, the angle θ_{BD} and the number N of the deflecting surfaces 51 of the polygon mirror 5 may be set such that the scanning light flux L_{BD2} does not reach a scanned region (printed region) on the surface 7 when being incident on the scanning imaging lens 6.

In the light scanning apparatus 100 according to the present embodiment, the incident light flux Lᵢ is separated (divided) into the two scanning light fluxes L_{BD} and L_{BD2} as described above when the synchronization detection light receiving element 80 is scanned.

Therefore, the width W_{BD} in the main scanning cross section of the scanning light flux L_{BD} scanning the synchronization detection light receiving element 80 is smaller than the width Wᵢ in the main scanning cross section of the incident light flux Lᵢ.

When W_{BD}<Wᵢ/2 is satisfied, a width of the scanning light flux L_{BD2} is larger than the width W_{BD} of the scanning light flux L_{BD} in the main scanning direction, so that a light amount of the scanning light flux L_{BD2} is larger than that of the scanning light flux L_{BD}.

In this case, the synchronization detection may be performed by providing the synchronization detection light receiving element 80 and the synchronization detection imaging element 81 on an optical path of the scanning light flux L_{BD2}.

Further, the scanning light flux L_{BD2} may be reflected by a synchronization detection reflecting element to be guided to the synchronization detection light receiving element 80 provided on the electrical mounting substrate 83.

Next, as shown in FIG. 2C, when the positive-side outermost off-axis image height 71 on the surface to be scanned 7 is scanned, the incident light flux Lᵢ incident on the deflecting surface 51 of the polygon mirror 5 is deflected by the deflecting surface 51 so as to travel as a scanning light flux Lₘₐₓ₊ in a direction forming a predetermined angle with respect to the X axis.

At this time, an angle formed by a traveling direction of a principal ray of the scanning light flux Lₘₐₓ₊ immediately after being deflected by the polygon mirror 5 with respect to the X axis is represented by θₘₐₓ₊, and a width in the main scanning cross section of the scanning light flux Lₘₐₓ₊ immediately after being deflected by the deflecting surface 51 is represented by Wₘₐₓ₊.

The scanning light flux Lₘₐₓ₊ has a principal ray Lₘₐₓ₊ P and marginal rays L_{max+U} and L_{max+L}.

When the positive-side outermost off-axis image height 71 on the surface 7 is scanned, the incident light flux Lᵢ is deflected in the vicinity of one end portion in the main scanning direction of the deflecting surface 51, but the entire incident light flux Lᵢ is deflected by the deflecting surface 51 as described later.

Therefore, the width Wᵢ of the incident light flux Lᵢ is maintained in the scanning light flux Lₘₐₓ₊ such that Wₘₐₓ₊=Wᵢ is satisfied.

Next, as shown in FIG. 2D, when the negative-side outermost off-axis image height 72 on the surface to be scanned 7 is scanned, the incident light flux Lᵢ is incident on the deflecting surface 51 (first deflecting surface) of the polygon mirror 5 arranged at a predetermined angle (second angle) in the main scanning cross section.

Then, the incident light flux Lᵢ incident on the deflecting surface 51 of the polygon mirror 5 arranged at the predetermined angle is deflected by the deflecting surface 51 so as to travel as a scanning light flux Lₘₐₓ₋ in a direction forming a predetermined angle with respect to the X axis.

At this time, an angle formed by a traveling direction of a principal ray of the scanning light flux Lₘₐₓ₋ immediately after being deflected by the polygon mirror 5 with respect to the X axis is represented by θₘₐₓ₋, and a width in the main scanning cross section of the scanning light flux Lₘₐₓ₋ immediately after being deflected by the deflecting surface 51 is represented by Wₘₐₓ₋.

The scanning light flux Lₘₐₓ₋ has a principal ray Lₘₐₓ₋ p and marginal rays L_{max-U} and L_{max-L}.

As shown in FIG. 2D, when the negative-side outermost off-axis image height 72 on the surface 7 is scanned, a part of the incident light flux Lᵢ is incident on the deflecting surface 53 adjacent to the deflecting surface 51 of the polygon mirror 5 on the downstream side in the rotation direction.

Then, the part of the incident light flux Lᵢ incident on the deflecting surface 53 is deflected as a scanning light flux Lₘₐₓ₋₂.

That is, in the light scanning apparatus 100 according to the present embodiment, when the negative-side outermost off-axis image height 72 on the surface 7 is scanned, the incident light flux Lᵢ is deflected by the polygon mirror 5 so as to be separated (divided) into the two scanning light fluxes Lₘₐₓ₋ and Lₘₐₓ₋₂.

In other words, in the light scanning apparatus 100 according to the present embodiment, only a part of the incident light flux Lᵢ incident on the polygon mirror 5 whose deflecting surface 51 is arranged at the predetermined angle in the main scanning cross section is deflected by the deflecting surface 51.

Then, the scanning light flux Lₘₐₓ₋ scans the negative-side outermost off-axis image height 72 on the surface 7.

On the other hand, the scanning light flux Lₘₐₓ₋₂ travels in a direction forming an angle different from the angle θₘₐₓ₋ of the scanning light flux Lₘₐₓ₋ with respect to the X axis.

Specifically, the scanning light flux Lₘₐₓ₋₂ travels in a direction forming an angle of (θₘₐₓ₋+360/N×2) degrees with respect to the X axis.

At this time, if the scanning imaging lens 6 is arranged so as to be sufficiently separated from the polygon mirror 5, the scanning light flux Lₘₐₓ₋₂ is not incident on the scanning imaging lens 6 and thus is not guided to the surface to be scanned 7, so that the scanning light flux Lₘₐₓ₋₂ is shielded by a wall surface, a rib or the like of a housing (not shown) of the light scanning apparatus 100.

Further, when the scanning light flux Lₘₐₓ₋₂ is incident on the scanning imaging lens 6, the angle θₘₐₓ₋ and the number N of the deflecting surfaces 51 of the polygon mirror 5 may be set such that the scanning light flux Lₘₐₓ₋₂ does not reach the scanned region (printed region) on the surface 7.

In the light scanning apparatus 100 according to the present embodiment, the incident light flux Lᵢ is separated into the two scanning light fluxes Lₘₐₓ₋ and Lₘₐₓ₋₂ as described above when the negative-side outermost off-axis image height 72 on the surface 7 is scanned.

Therefore, the width Wₘₐₓ₋ in the main scanning direction of the scanning light flux Lₘₐₓ₋ for scanning the negative-side outermost off-axis image height 72 on the surface 7 is smaller than the width Wᵢ in the main scanning direction of the incident light flux Lᵢ.

In the light scanning apparatus 100 according to the present embodiment, it is preferred that the following Inequality (1) be satisfied:

$${W}_{BD} < {W}_{max -} < {W}_{max +} . \qquad ( 1 )$$

Satisfying Inequality (1) means that the widths Wₘₐₓ₋ and Wₘₐₓ₊ of the scanning light fluxes Lₘₐₓ₋ and Lₘₐₓ₊ for scanning both end portions in the scanned region on the surface 7 are larger than the width W_{BD} of the scanning light flux L_{BD}, namely the synchronization detection light flux.

In order to obtain a uniform printed image, it is preferred that a variation between widths of scanning light fluxes for scanning respective image heights in the scanned region on the surface 7 be small.

This is because a uniformity (allowable tolerance) of printing is determined in accordance with requirements and specifications of an electrophotographic process and a photosensitive drum provided in an image forming apparatus in which the light scanning apparatus 100 according to the present embodiment is mounted.

On the other hand, the synchronization detection light flux received by the synchronization detection light receiving element 80 may have a necessary light amount according to a light receiving sensitivity of the synchronization detection light receiving element 80.

Further, the synchronization detection light receiving element 80 can be selected in consideration of a magnitude of the light receiving sensitivity according to a light amount energy of the received synchronization detection light flux.

In addition, it is possible to adjust the light amount of the synchronization detection light flux received by the synchronization detection light receiving element 80 by adjusting the light receiving sensitivity of the synchronization detection light receiving element 80 and a light emission amount of the light source 1 in the electrical mounting substrate 83.

However, it is not preferred to excessively reduce a light amount energy of the synchronization detection light flux by significantly reducing a light flux width of the synchronization detection light flux since a cost is increased when the electrical mounting substrate 83 capable of performing the adjustment is used.

In general, the increase in cost can be suppressed by setting a light flux width of the synchronization detection light flux so as to have a light flux width of ½ to ⅓ or more of the light flux width of the scanning light flux that scans the surface 7.

In the light scanning apparatus 100 according to the present embodiment, it is more preferred that the following Inequality (1′) be satisfied:

$${W}_{max +} = {W}_{i} . \qquad ( {1}^{′} )$$

In the light scanning apparatus 100 according to the present embodiment, it is preferred that a difference between the width Wₘₐₓ₋ of the scanning light flux Lₘₐₓ₋ and the width Wₘₐₓ₊ of the scanning light flux Lₘₐₓ₊ be as small as possible.

In the case where a surface to be scanned is scanned by deflecting all of an incident light flux by a deflecting surface of a deflecting unit in the conventional UFS type, the difference can be set to 0.

However, in such UFS type, it is necessary to increase a width in the main scanning cross section of the deflecting surface in order to deflect all of light fluxes by the same deflecting surface.

Therefore, when the number of deflecting surfaces of the deflecting unit is increased, a size of the deflecting unit is increased.

On the other hand, in the light scanning apparatus 100 according to the present embodiment, a light flux width of each scanning light flux is set so as to satisfy the Inequality (1).

Thereby, it is possible to suppress an increase in the size of the polygon mirror 5, the light scanning apparatus 100 according to the present embodiment, and the image forming apparatus in which the light scanning apparatus 100 according to the present embodiment is mounted.

In the light scanning apparatus 100 according to the present embodiment, the width W_{BD} of the scanning light flux L_{BD} for scanning the synchronization detection light receiving element 80 is smaller than the width Wᵢ of the incident light flux Lᵢ when Inequality (1) is satisfied.

Thereby, a width in the main scanning cross section of an optical surface, especially an incident surface of the synchronization detection imaging element 81 can be made smaller than a width in the main scanning cross section of the optical surface closest to the polygon mirror 5 on the optical path of the incident optical system 75, namely the exit surface of the anamorphic collimator lens 3.

That is, in the light scanning apparatus 100 according to the present embodiment, it is possible to downsize the synchronization detection imaging element 81 when Inequality (1) is satisfied.

As shown in FIG. 1, in the light scanning apparatus 100 according to the present embodiment, the synchronization detection imaging element 81 is provided between the anamorphic collimator lens 3 and the scanning imaging lens 6 in the main scanning cross section.

Therefore, it is necessary to increase an interval between the anamorphic collimator lens 3 and the scanning imaging lens 6 when the synchronization detection imaging element 81 is increased in size.

Accordingly, in the light scanning apparatus 100 according to the present embodiment, it is possible to achieve a reduction in size thereof, and thus a reduction in size of the image forming apparatus in which it is mounted by making the optical surface of the synchronization detection imaging element 81 smaller than the optical surface of the anamorphic collimator lens 3.

In the light scanning apparatus 100 according to the present embodiment, it is preferred that the following Inequality (2) be satisfied:

$$5.5 \leq φ - K \times N \times ( N - 1 ) \leq 13. . \qquad ( 2 )$$

In Inequality (2), φ is a diameter [mm] of a circumscribed circle in the main scanning cross section of the polygon mirror 5, N is the number of the deflecting surfaces 51 of the polygon mirror 5, and K is a predetermined value of 0.52 or more and 0.56 or less.

In the light scanning apparatus 100 according to the present embodiment, it is more preferred that Inequality (2) be satisfied when K is a predetermined value of 0.53 or more and 0.55 or less.

Inequality (2) defines an appropriate relationship between the number N of the deflecting surfaces 51 of the polygon mirror 5 and the diameter φ of the circumscribed circle of the polygon mirror 5 in the light scanning apparatus 100 according to the present embodiment.

If the value falls below the lower limit value in Inequality (2), the number N of deflecting surfaces 51 increases with respect to a size of the polygon mirror 5, and thus a size of each of the N deflecting surfaces 51 decreases.

Then, when the size of the deflecting surface 51 is too small, it is difficult to achieve uniform printing since the widths W_{BD}, Wₘₐₓ₋, and Wₘₐₓ₊ of the scanning light fluxes L_{BD}, Lₘₐₓ₋, and Lₘₐₓ₊ are too smaller than the width Wᵢ of the incident light flux Lᵢ.

On the other hand, if the value exceeds the upper limit value in Inequality (2), the number N of the deflecting surfaces 51 decreases with respect to the size of the polygon mirror 5, or the size of the polygon mirror 5 increases with respect to the number N of the deflecting surfaces 51.

Then, when the size of the polygon mirror 5 increases, a size of the light scanning apparatus 100 according to the present embodiment, and thus a size of the image forming apparatus on which the light scanning apparatus 100 according to the present embodiment is mounted, increase.

That is, in the light scanning apparatus 100 according to the present embodiment, it is possible to achieve downsizing by satisfying Inequality (2).

In Inequality (2), an optimum specification of the polygon mirror 5 can be found by setting the constant K to about 0.54.

In the light scanning apparatus 100 according to the present embodiment, it is preferred that the following Inequality (3) be satisfied:

$$6. < \frac{ϕ + 15}{N} < 7 \text{.40} . \qquad ( 3 )$$

Inequality (3) defines another appropriate relationship between the number N of the deflecting surfaces 51 of the polygon mirror 5 and the diameter φ of the circumscribed circle of the polygon mirror 5 in the light scanning apparatus 100 according to the present embodiment.

If the ratio is equal to or less than the lower limit value in Inequality (3), the number N of deflecting surfaces 51 increases with respect to the size of the polygon mirror 5, and thus the size of each of the N deflecting surfaces 51 decreases.

Then, when the size of the deflecting surface 51 is too small, it is difficult to achieve uniform printing since the widths W_{BD}, Wₘₐₓ₋, and Wₘₐₓ₊ of the scanning light fluxes L_{BD}, Lₘₐₓ₋, and Lₘₐₓ₊ are too smaller than the width Wᵢ of the incident light flux Lᵢ.

On the other hand, if the ratio is equal to or larger than the upper limit value in Inequality (3), the number N of the deflecting surfaces 51 decreases with respect to the size of the polygon mirror 5, or the size of the polygon mirror 5 increases with respect to the number N of the deflecting surfaces 51.

Then, when the size of the polygon mirror 5 increases, the size of the light scanning apparatus 100 according to the present embodiment, and thus the size of the image forming apparatus on which the light scanning apparatus 100 according to the present embodiment is mounted, increase.

In the light scanning apparatus 100 according to the present embodiment, it is possible to obtain a more preferable relationship between the number N of the deflecting surfaces 51 of the polygon mirror 5 and the diameter φ of the circumscribed circle of the polygon mirror 5 by satisfying Inequality (3).

In the light scanning apparatus 100 according to the present embodiment, it is more preferred that the following Inequality (3a) be satisfied instead of Inequality (3):

$$6.2 < \frac{ϕ + 15}{N} < 7.2 . \qquad ( 3 a )$$

In the light scanning apparatus 100 according to the present embodiment, it is preferred that the following Inequality (4) be satisfied:

$$22.6 < \frac{{Y}_{max +}}{( \frac{ϕ}{N} )} < 37 \text{.00} . \qquad ( 4 )$$

In Inequality (4), Yₘₐₓ₊ is a distance [mm] in the Y direction between the on-axis image height 70 and the positive-side outermost off-axis image height 71.

Inequality (4) defines an appropriate relationship among the number N of the deflecting surfaces 51 of the polygon mirror 5, the diameter φ of the circumscribed circle of the polygon mirror 5, and a position of the positive-side outermost off-axis image height 71 in the light scanning apparatus 100 according to the present embodiment.

If the ratio is equal to or less than the lower limit value in Inequality (4), a scanning angle of view when a scanned region on the surface to be scanned 7 is scanned by the deflecting surface 51 of the polygon mirror 5 is small.

Then, when the scanning angle of view is small, it is necessary to increase an interval between the polygon mirror 5 and the surface 7, so that the size of the light scanning apparatus 100 according to the present embodiment, and thus the size of the image forming apparatus in which the light scanning apparatus 100 according to the present embodiment is mounted, increase.

On the other hand, if the ratio is equal to or larger than the upper limit value in Inequality (4), the number N of deflecting surfaces 51 increases with respect to the size of the polygon mirror 5, and thus the size of each of the N deflecting surfaces 51 decreases.

Then, when the size of the deflecting surface 51 is too small, it is difficult to achieve uniform printing since the widths W_{BD}, Wₘₐₓ₋, and Wₘₐₓ₊ of the scanning light fluxes L_{BD}, Lₘₐₓ₋, and Lₘₐₓ₊ are too smaller than the width Wᵢ of the incident light flux Lᵢ.

In the light scanning apparatus 100 according to the present embodiment, it is more preferred that the following Inequality (4a) be satisfied instead of Inequality (4):

$$27. < \frac{{Y}_{max +}}{( \frac{ϕ}{N} )} < 34 \text{.00} . \qquad ( 4 a )$$

As shown in FIG. 1, the scanning light flux L_{BD} guided to the synchronization detection light receiving element 80 by the polygon mirror 5 travels on a light source 1 side with respect to an optical axis of the imaging optical system 85 in the light scanning apparatus 100 according to the present embodiment.

Then, in the light scanning apparatus 100 according to the present embodiment, the synchronization detection imaging element 81 is arranged between the incident optical system 75 and the scanning imaging lens 6 in the main scanning cross section.

This makes it possible to achieve a reduction in the size of the light scanning apparatus 100 according to the present embodiment as compared with a case where synchronization detection is performed by causing the scanning light flux L_{BD} to travel on a side opposite to the light source 1 with respect to the optical axis of the imaging optical system 85.

In addition, in the light scanning apparatus 100 according to the present embodiment, the synchronization detection light receiving element 80 and the light source 1 are mounted on the same electrical mounting substrate 83, and thus it is possible to achieve a reduction in size and cost.

As described above, the width W_{BD} of the scanning light flux L_{BD} for scanning the synchronization detection light receiving element 80 is smaller than the width Wᵢ of the incident light flux Lᵢ, but it is preferred that the width W_{BD} be as large as possible in the light scanning apparatus 100 according to the present embodiment.

This is because the width W_{BD} becomes too small, and thus the light amount of the scanning light flux L_{BD} decreases if the angle θ_{BD} formed between the traveling direction of the scanning light flux L_{BD} and the X axis is not appropriately set when the scanning light flux L_{BD} travels on the light source 1 side with respect to the optical axis of the imaging optical system 85.

Although there is no problem when the decrease in the light amount of the scanning light flux L_{BD} is included in a range of light receiving sensitivity of the synchronization detection light receiving element 80, an accuracy of the synchronization detection is reduced when the light amount of the scanning light flux L_{BD} decreases beyond the range of the light receiving sensitivity of the synchronization detection light receiving element 80.

In the light scanning apparatus 100 according to the present embodiment, it is preferred that the following Inequality (5) be satisfied:

$$1.78 < \frac{{θ}_{i} + {θ}_{m ax +}}{{θ}_{B D}} < 2.33 . \qquad ( 5 )$$

In Inequality (5), θᵢ (°) is an angle formed by an optical axis of the imaging optical system 85 and an optical axis of the incident optical system 75 in the main scanning cross section.

Further, in Inequality (5), θₘₐₓ₊ (°) is an angle formed by a traveling direction of a principal ray of the scanning light flux Lₘₐₓ₊ traveling toward the positive-side outermost off-axis image point 71 immediately after being deflected by the polygon mirror 5 with respect to the optical axis of the imaging optical system 85 in the main scanning cross section.

Furthermore, in Inequality (5), θ_{BD} (°) is an angle formed by a traveling direction of a principal ray of the scanning light flux L_{BD} traveling toward a center of a light receiving surface of the synchronization detection light receiving element 80 immediately after being deflected by the polygon mirror 5 with respect to the optical axis of the imaging optical system 85 in the main scanning cross section.

In particular, when the synchronization detection imaging element 81 is provided in order to improve a synchronization detection accuracy, the synchronization detection imaging element 81 is provided between the anamorphic collimator lens 3 and the scanning imaging lens 6, and thus it is necessary to consider an interference therebetween.

If the ratio is equal to or less than the lower limit value in Inequality (5), a difference between the angle θᵢ and the angle θ_{BD} becomes small, and thus the interference between an optical path in the incident optical system 75 and an optical path in the synchronization detection optical system is likely to occur.

In addition, since the width W_{BD} of the scanning light flux L_{BD} is excessively smaller than the width Wᵢ of the incident light flux Lᵢ, it is difficult to maintain the accuracy of the synchronization detection.

On the other hand, if the ratio is equal to or larger than the upper limit value in Inequality (5), the angle θ_{BD} becomes small.

In this case, the accuracy of synchronization detection can be improved by increasing the width W_{BD} of the scanning light flux L_{BD}, but the interference is likely to occur between the optical path in the synchronization detection optical system and the optical path in the imaging optical system 85.

In addition, the interval between the synchronization detection light receiving element 80 and the light source 1 increases, and thus the size of the light scanning apparatus 100 according to the present embodiment increases.

As described above, in the light scanning apparatus 100 according to the present embodiment, it is important to set the angle θ_{BD} in consideration of both of the interference between the optical path of the synchronization detection optical system and the optical path of the incident optical system 75 or the optical path of the imaging optical system 85, and the decrease in the width W_{BD} of the scanning light flux L_{BD}.

Thereby, it is possible to achieve a reduction in the size of the light scanning apparatus 100 according to the present embodiment in which the polygon mirror 5 and the synchronization detection optical system are appropriately arranged.

Further, a method for appropriately setting the angle θ_{BD} of the scanning light flux L_{BD} varies depending on the configurations of the imaging optical system 85 and the synchronization detection optical system.

First, the synchronization detection optical system generally adopts any of the following two types.

One type is referred to as a separate optical path type in which the synchronization detection light flux reaches the synchronization detection light receiving element without passing through each scanning imaging lens provided in the imaging optical system.

The other type is referred to as a shared optical path type in which the synchronization detection light flux reaches the synchronization detection light receiving element by passing through at least one scanning imaging lens provided in the imaging optical system.

In the shared optical path type, the number of optical elements can be reduced, but it is necessary to bend the optical path of the synchronization detection light flux toward the synchronization detection light receiving element by a folding mirror.

In the case where the scanning imaging lens is a glass lens, cost reduction can be achieved by adopting the shared optical path type.

Further, in the shared optical path type, it is necessary to increase a size of the scanning imaging lens in the main scanning direction such that the synchronization detection light flux traveling at an angle larger than an angle of the scanning light flux for scanning a surface to be scanned with respect to the optical axis of the imaging optical system passes through the scanning imaging lens.

At this time, in a case where the scanning imaging lens is a resin lens, a size of the scanning imaging lens in the main scanning direction increases, and thus a thickness of a central portion thereof increases since it is necessary to provide a certain thickness in the vicinity of an edge portion in consideration of a residual stress of a resin in the resin lens.

Then, when the thickness of the central portion of the scanning imaging lens increases, a time required for molding tact when forming the scanning imaging lens increases, resulting in an increase in cost.

Therefore, when the scanning imaging lens is a resin lens, it is not always possible to reduce the cost by adopting the shared optical path type.

On the other hand, the separate optical path type has an advantage that it is possible to suppress a decrease in the accuracy of synchronization detection when a temperature of the light scanning apparatus increases.

When the temperature of the light scanning apparatus increases, a wavelength of laser forming the light source greatly varies, or a refractive index greatly varies in a case where the scanning imaging lens is a resin lens.

In the shared optical path type, a lateral chromatic aberration is generated since the synchronization detection light flux passes through a portion other than that on the optical axis of at least one scanning imaging lens provided in the imaging optical system.

That is, the accuracy of the synchronization detection decreases since an apparent off-axis image height in the synchronization detection light receiving element varies.

The above-described variation appears as a registration shift in a color image forming apparatus in which images of a plurality of colors are superimposed on each other, and therefore becomes a serious problem.

Therefore, in recent years, cases in which the separate optical path type is adopted in a light scanning apparatus used in the color image forming apparatus and the shared optical path type is adopted in a light scanning apparatus used in a monochrome image forming apparatus have been increasing.

Next, the number of scanning imaging lenses forming an imaging optical system provided in a light scanning apparatus is discussed.

An imaging optical system provided in a light scanning apparatus may be formed by a single scanning imaging lens in order to reduce a cost, or may be formed by a plurality of scanning imaging lenses in order to improve an optical performance.

However, in general, the cost reduction can be achieved by forming the imaging optical system with the single scanning imaging lens, but there are cases where the cost reduction cannot be achieved when an angle of view is widened as a result of shortening an optical path in order to achieve downsizing.

As described above, when the scanning imaging lens is a resin lens, the resin lens needs to have a certain thickness in the vicinity of the edge portion in consideration of the residual stress of the resin.

Therefore, a size in the main scanning direction of the scanning imaging lens increases along with the widening of the angle of view, and thus a thickness of the central portion thereof increases.

Then, when the thickness of the central portion of the scanning imaging lens increases, a time required for molding tact when the scanning imaging lens is formed increases, resulting in an increase in cost.

In such case, there is a possibility that a total cost can be reduced by forming the imaging optical system with a plurality of scanning imaging lenses whose power is shared.

In addition, a degree of freedom of arrangement is reduced, and thus a magnification is likely to increase when the imaging optical system is formed by a single scanning imaging lens.

Therefore, when the imaging optical system is formed by the single scanning imaging lens, the separate optical path type is often adopted rather than the shared optical path type.

On the other hand, in a case where the imaging optical system is formed by a plurality of scanning imaging lenses, it is possible to select one of the separate optical path type and the shared optical path type according to the configuration since there are fewer restrictions than in the case where the imaging optical system is formed by the single scanning imaging lens.

In the light scanning apparatus 100 according to the present embodiment, downsizing is achieved by appropriately arranging the synchronization detection optical system in consideration of the above.

First, in a case where the imaging optical system 85 is formed by the single scanning imaging lens 6 in the light scanning apparatus 100 according to the present embodiment, it is preferred that the following Inequality (6) be satisfied:

$$0.23 < \frac{{θ}_{B D} - {θ}_{m ax +}}{( \frac{360}{N} )} < 0 \text{.35} . \qquad ( 6 )$$

In particular, when the synchronization detection imaging element 81 is provided in order to improve the accuracy of the synchronization detection, the synchronization detection imaging element 81 is arranged between the anamorphic collimator lens 3 and the scanning imaging lens 6, so that it is necessary to consider interference between the synchronization detection imaging element 81 and them.

If the ratio is equal to or less than the lower limit value in Inequality (6), the angle θ_{BD} becomes small.

In this case, the accuracy of synchronization detection can be improved by increasing the width W_{BD} of the scanning light flux L_{BD}, but the interference is likely to occur between the optical path in the synchronization detection optical system and the optical path in the imaging optical system 85.

In addition, the size of the light scanning apparatus 100 according to the present embodiment increases since an interval between the synchronization detection light receiving element 80 and the light source 1 increases.

On the other hand, if the ratio is equal to or larger than the upper limit value in Inequality (6), the interference between the optical path in the incident optical system 75 and the optical path in the synchronization detection optical system is likely to occur since the difference between the angle θᵢ and the angle θ_{BD} decreases.

In addition, it is difficult to maintain the accuracy of synchronization detection since the width W_{BD} of the scanning light flux L_{BD} is excessively smaller than the width Wᵢ of the incident light flux Lᵢ.

Therefore, it is important to set the angle θ_{BD} of the synchronization detection light flux in consideration of both of the interference between the optical path in the synchronization detection optical system and the optical path in the incident optical system 75 or the optical path in the imaging optical system 85, and the decrease in the width W_{BD} of the synchronization detection light flux.

Thereby, downsizing can be achieved by appropriately arranging the polygon mirror 5 and the synchronization detection optical system in the light scanning apparatus 100 according to the present embodiment.

Next, in a case where the imaging optical system 85 is formed by a plurality of scanning imaging lenses 6 and the separate optical path type in which the synchronization detection light flux does not pass through any of the scanning imaging lenses 6 is adopted in the light scanning apparatus 100 according to the present embodiment, it is preferred that the following Inequality (7) be satisfied:

$$\frac{360}{N} - 45 < {θ}_{B D} - {θ}_{max +} < \frac{( \frac{360}{N} )}{2} . \qquad ( 7 )$$

In particular, when the synchronization detection imaging element 81 is provided in order to improve the accuracy of the synchronization detection, the synchronization detection imaging element 81 is arranged between the anamorphic collimator lens 3 and the scanning imaging lens 6, so that it is necessary to consider the interference between the synchronization detection imaging element 81 and them.

If the value is equal to or less than the lower limit value in Inequality (7), the angle θ_{BD} becomes small.

In this case, the accuracy of synchronization detection can be improved by increasing the width W_{BD} of the scanning light flux L_{BD}, but the interference is likely to occur between the optical path in the synchronization detection optical system and the optical path in the imaging optical system 85.

In addition, the size of the light scanning apparatus 100 according to the present embodiment increases since the interval between the synchronization detection light receiving element 80 and the light source 1 increases.

On the other hand, when the value is equal to or larger than the upper limit value in Inequality (7), the interference between the optical path in the incident optical system 75 and the optical path in the synchronization detection optical system is likely to occur since the difference between the angle θᵢ and the angle θ_{BD} decreases.

In addition, it is difficult to maintain the accuracy of the synchronization detection since the width W_{BD} of the scanning light flux L_{BD} is excessively smaller than the width Wᵢ of the incident light flux Lᵢ.

Therefore, it is important to set the angle θ_{BD} of the synchronization detection light flux in consideration of both of the interference between the optical path in the synchronization detection optical system and the optical path in the incident optical system 75 or the optical path in the imaging optical system 85, and the decrease in the width W_{BD} of the synchronization detection light flux.

Thereby, downsizing can be achieved by appropriately arranging the polygon mirror 5 and the synchronization detection optical system in the light scanning apparatus 100 according to the present embodiment.

Next, a case where the imaging optical system 85 is formed by the plurality of scanning imaging lenses 6 and the shared optical path type in which the synchronization detection light flux passes through at least one scanning imaging lens 6 is adopted is considered in the light scanning apparatus 100 according to the present embodiment.

In this case, it is preferred that the following Inequality (8) be satisfied:

$$0.145 < \frac{{θ}_{B D} - {θ}_{max +}}{( \frac{360}{N} )} < 0.1 82. \qquad ( 8 )$$

In particular, when the synchronization detection imaging element 81 is provided in order to improve the accuracy of the synchronization detection, the synchronization detection imaging element 81 is arranged between the anamorphic collimator lens 3 and the scanning imaging lens 6, so that it is necessary to consider the interference between the synchronization detection imaging element 81 and them.

If the ratio is equal to or less than the lower limit value in Inequality (8), the angle θ_{BD} becomes small.

In this case, the accuracy of synchronization detection can be improved by increasing the width W_{BD} of the scanning light flux L_{BD}, but the interference is likely to occur between the optical path in the synchronization detection optical system and the optical path in the imaging optical system 85.

In addition, the size of the light scanning apparatus 100 according to the present embodiment increases since the interval between the synchronization detection light receiving element 80 and the light source 1 increases.

On the other hand, when the ratio is equal to or larger than the upper limit value in Inequality (8), the interference between the optical path in the incident optical system 75 and the optical path in the synchronization detection optical system is likely to occur since the difference between the angle θᵢ and the angle θ_{BD} decreases.

In addition, it is difficult to maintain the accuracy of the synchronization detection since the width W_{BD} of the scanning light flux L_{BD} is excessively smaller than the width Wᵢ of the incident light flux Lᵢ.

Therefore, it is important to set the angle θ_{BD} of the synchronization detection light flux in consideration of both of the interference between the optical path in the synchronization detection optical system and the optical path in the incident optical system 75 or the optical path in the imaging optical system 85, and the decrease in the width W_{BD} of the synchronization detection light flux.

Thereby, downsizing can be achieved by appropriately arranging the polygon mirror 5 and the synchronization detection optical system in the light scanning apparatus 100 according to the present embodiment.

In the light scanning apparatus 100 according to the present embodiment, it is more preferred that the following Inequality (8a) be satisfied instead of Inequality (8):

$$0.148 < \frac{{θ}_{B D} - {θ}_{m ax +}}{( \frac{360}{N} )} < 0 \text{.173} . \qquad ( 8 a )$$

Further, in the light scanning apparatus 100 according to the present embodiment, when the imaging optical system is formed by the plurality of scanning imaging lenses 6 and adopts the shared optical path type, it is preferred that the synchronization detection light flux passes through the scanning imaging lens 6 closest to the polygon mirror 5 on the optical path among the plurality of scanning imaging lenses 6.

In the light scanning apparatus 100 according to the present embodiment, it is preferred that the following Inequality (9) be satisfied:

$$0.103 < \frac{E A}{{Y}_{max +} - {Y}_{max -}} < 0 \text{.397} . \qquad ( 9 )$$

In Inequality (9), Yₘₐₓ₋ is a distance [mm] in the Y direction between the on-axis image height 70 and the negative-side outermost off-axis image height 72.

Further, in Inequality (9), EA is a maximum value (larger value) [mm] of sizes in the main scanning direction of an incident surface and an exit surface of the scanning imaging lens 6 closest to the polygon mirror 5 among the plurality of scanning imaging lenses 6.

In the light scanning apparatus 100 according to the present embodiment, it is possible to adopt the shared optical path type with suppressing an increase in size of the scanning imaging lens 6 when Inequality (9) is satisfied.

In the light scanning apparatus 100 according to the present embodiment, it is preferred that the following Inequality (10) be satisfied:

$$4 \leq N \leq 6. \qquad ( 10 )$$

Conventionally, a speed is increased by increasing the number N of the deflecting surfaces 51 of the polygon mirror 5, whereas the size of the light scanning apparatus 100 according to the present embodiment, and the size of the image forming apparatus on which the light scanning apparatus 100 according to the present embodiment is mounted are increased as the number N of the deflecting surfaces 51 of the polygon mirror 5 is increased.

Therefore, in the light scanning apparatus 100 according to the present embodiment, it is preferred that Inequality (10) be satisfied in consideration of the above.

In the light scanning apparatus 100 according to the present embodiment, it is preferred that the following Inequality (11) be satisfied:

$$47. \leq {θ}_{max +} \leq 57. . \qquad ( 11 )$$

If the value falls below the lower limit value in Inequality (11), it becomes difficult to downsize the light scanning apparatus 100 according to the present embodiment since widening of the angle of view of the imaging optical system 85 is not sufficiently achieved.

On the other hand, if the value exceeds the upper limit value in Inequality (11), the width in the main scanning direction of the scanning light flux for scanning the surface to be scanned 7 becomes excessively smaller than the width Wᵢ in the main scanning direction of the incident light flux Lᵢ, so that the variation in the light amount and the spot between the image heights on the surface 7 increases.

Further, in the light scanning apparatus 100 according to the present embodiment, it is preferred to arrange the light source 1 and the synchronization detection light receiving element 80 on the single electrical mounting substrate 83 in order to compactly arrange the synchronization detection light receiving element 80.

If an electrical mounting substrate different from the electrical mounting substrate 83 is provided in order to arrange the synchronization detection light receiving element 80, additional holding mechanism and cables are required for the different electrical mounting substrate, so that the reduction in size and cost is suppressed.

On the other hand, in the light scanning apparatus 100 according to the present embodiment, the synchronization detection light flux is generated by the part of the incident light flux Lᵢ being vignetted as described above.

Therefore, the arrangement of the light source 1 and the synchronization detection light receiving element 80 on the single electrical mounting substrate 83 leads to an increase in the angle θ_{BD} of the synchronization detection light flux and an increase in the vignetted amount of the incident light flux Lᵢ when the synchronization detection light flux is generated.

Accordingly, in the light scanning apparatus 100 according to the present embodiment, it is preferred to provide at least one reflecting element for reflecting the synchronization detection light flux deflected by the polygon mirror 5 toward the synchronization detection light receiving element 80.

In addition, it is preferred that the at least one reflecting element be provided such that an angle θ_{BDm} is larger than the angle θ_{BD}, namely an inequality of θ_{BD}<θ_{BDm} is satisfied.

Here, the angle θ_{BDm} (°) is an angle formed by the optical axis of the imaging optical system 85 and the traveling direction of the principal ray of the scanning light flux L_{BD} traveling toward the center of the light receiving surface of the synchronization detection light receiving element 80 immediately after being reflected by the at least one reflecting element in the main scanning cross section.

Further, in the light scanning apparatus 100 according to the present embodiment, it is preferred that the following Inequality (12) be satisfied:

$${θ}_{B D} < {θ}_{i} \leq {θ}_{B D m} . \qquad ( 12 )$$

In the light scanning apparatus 100 according to the present embodiment, the synchronization detection light flux can easily travel toward the synchronization detection light receiving element 80 arranged on the electrical mounting substrate 83 on which the light source 1 is arranged by increasing the angle θ_{BDm} of the synchronization detection light flux in accordance with the configuration described above.

Next, main specification values of the light scanning apparatus 100 according to the present embodiment, and an arrangement of each optical element provided in the incident optical system 75 and the imaging optical system 85 are shown in the following Tables 1 and 2, respectively.

Further, an aspherical shape of the anamorphic collimator lens 3 and an aspherical shape of the scanning imaging lens 6 provided in the light scanning apparatus 100 according to the present embodiment are shown in the following Tables 3 and 4, respectively.

Furthermore, an arrangement of each optical element provided in the synchronization detection optical system in the light scanning apparatus 100 according to the present embodiment is shown in the following Table 5.

TABLE 1

| | |
|---|---|
| Wavelength of light source 1 [nm] | 790 |
| Angle θi [°] between optical axis of imaging optical system 85 and optical | 90.0 |
| axis of incident optical system 75 | |
| Diameter φ [mm] of circumscribed circle in main scanning cross section of | 17.481 |
| polygon mirror 5 | |
| Number N of deflecting surface 51 of polygon mirror 5 | 5 |
| Width in main scanning cross section of deflecting surface 51 of polygon | 10.275 |
| mirror 5 [mm] | |
| Diameter φin [mm] of inscribed circle in main scanning cross section of | 14.142 |
| polygon mirror 5 | |
| Distance φin/2 between center of polygon mirror 5 and end in main scanning | 7.071 |
| direction of deflecting surface 51 | |
| Coordinate in X direction of rotation center of polygon mirror 5 | −6.016 |
| Coordinate in Y direction of rotation center of polygon mirror 5 | −3.984 |
| Fθ coefficient | 110.0 |
| Coordinate Ymax+ in Y direction of positive-side outermost off-axis image | 107.0 |
| height 71 | |
| Coordinate Ymax− in Y direction of negative-side outermost off-axis image | −107.0 |
| height 72 | |
| Printed width Ywidth = (Ymax+) − (Ymax−) on surface to be scanned 7 | 214.0 |
| Maximum angle of view θmax+ [°] corresponding to positive-side outermost | 55.7 |
| off-axis image height 71 | |
| Maximum angle of view θmax− [°] corresponding to negative-side outermost | −55.7 |
| off-axis image height 72 | |
| Angle of view θBD [°] of synchronization detection light flux | 72.9 |

TABLE 2

| | Surface | | | | | | | | |
|---|---|---|---|---|---|---|---|---|---|
| | number | R | N | x | y | z | gx(x) | gx(y) | gx(z) |
| Light emitting point of light | 1 | 0.000 | −1.511 | 0.000 | 50.000 | 0.000 | 0.000 | 1.000 | 0.000 |
| source 1 | | | | | | | | | |
| | 2 | 0.000 | −1.000 | 0.000 | 49.750 | 0.000 | 0.000 | 1.000 | 0.000 |
| Sub-scanning stop 2 | 3 | 0.000 | −1.000 | 0.000 | 34.000 | 0.000 | 0.000 | 1.000 | 0.000 |
| Incident surface of | 4 | aspherical | −1.529 | 0.000 | 31.000 | 0.000 | 0.000 | 1.000 | 0.000 |
| anamorphic collimator lens 3 | | | | | | | | | |
| Exit surface of anamorphic | 5 | aspherical | −1.000 | 0.000 | 29.000 | 0.000 | 0.000 | 1.000 | 0.000 |
| collimator lens 3 | | | | | | | | | |
| Main scanning stop 4 | 6 | 0.000 | −1.000 | 0.000 | 20.000 | 0.000 | 0.000 | 1.000 | 0.000 |
| Deflecting surface 51 of | 7 | 0.000 | 1.000 | −1.016 | 1.016 | 0.000 | 0.707 | 0.707 | 0.000 |
| polygon mirror 5 | | | | | | | | | |
| Incident surface of scanning | 8 | aspherical | 1.529 | 21.300 | 0.000 | 0.000 | 1.000 | 0.000 | 0.000 |
| imaging lens 6 | | | | | | | | | |
| Exit surface of scanning | 9 | aspherical | 1.000 | 31.800 | 0.000 | 0.000 | 1.000 | 0.000 | 0.000 |
| imaging lens 6 | | | | | | | | | |
| Surface to be scanned 7 | 12 | 0.000 | 1.000 | 125.600 | 0.000 | 0.000 | 1.000 | 0.000 | 0.000 |

| | |
|---|---|
| Aperture width in sub- | 0.900 |
| scanning direction of sub- | |
| scanning stop 2 | |
| Aperture width in main | 1.880 |
| scanning direction of main | |
| scanning stop 4 | |

TABLE 3
Incident surface of anamorphic collimator lens 3

| r | k | C2 | C4 | C6 | C8 | C10 |
|---|---|---|---|---|---|---|
| 0.00E+00 | 0.00E+00 | 0.00E+00 | 0.00E+00 | 0.00E+00 | 0.00E+00 | 0.00E+00 |

Exit surface of anamorphic collimator lens 3

| Ru | Ku | B2u | B4u | B6u | B8u | B10u |
|---|---|---|---|---|---|---|
| 1.02E+01 | 0.00E+00 | 0.00E+00 | 3.26E−05 | 0.00E+00 | 0.00E+00 | 0.00E+00 |
| Rl | Kl | B2l | B4l | B6l | B8l | B10l |
| 1.02E+01 | 0.00E+00 | 0.00E+00 | 3.26E−05 | 0.00E+00 | 0.00E+00 | 0.00E+00 |

| ru | E2u | E4u | E6u | E8u | E10u |
|---|---|---|---|---|---|
| 6.24E+00 | 0.00E+00 | 0.00E+00 | 0.00E+00 | 0.00E+00 | 0.00E+00 |
| rl | E2l | E4l | E6l | E8l | E10l |
| 6.24E+00 | 0.00E+00 | 0.00E+00 | 0.00E+00 | 0.00E+00 | 0.00E+00 |

| E1 | E3 | E5 |
|---|---|---|
| 0.00E+00 | 0.00E+00 | 0.00E+00 |

TABLE 4

Incident surface of scanning imaging lens 6

| Ru | Ku | B2u | B4u | B6u | B8u | B10u |
|---|---|---|---|---|---|---|
| 6.28E+01 | 8.27E−01 | 0.00E+00 | −1.09E−05 | 5.28E−09 | −1.27E−12 | 0.00E+00 |
| Rl | Kl | B2l | B4l | B6l | B8l | B10l |
| 6.28E+01 | 8.27E−01 | 0.00E+00 | −1.09E−05 | 5.28E−09 | −1.27E−12 | 0.00E+00 |

| ru | E2u | E4u | E6u | E8u | E10u |
|---|---|---|---|---|---|
| −2.96E+01 | 1.07E−04 | −5.30E−08 | 3.61E−13 | −8.33E−18 | 0.00E+00 |
| rl | E21 | E41 | E61 | E81 | E101 |
| −2.96E+01 | 1.07E−04 | −5.30E−08 | 3.61E−13 | −8.33E−18 | 0.00E+00 |

| E1 | E3 | E5 |
|---|---|---|
| 0.00E+00 | 0.00E+00 | 0.00E+00 |

Exit surface of scanning imaging lens 6

| Ru | Ku | B2u | B4u | B6u | B8u | B10u |
|---|---|---|---|---|---|---|
| 2.92E+02 | −2.98E+00 | 0.00E+00 | −4.94E−06 | −3.17E−10 | 5.88E−13 | 0.00E+00 |
| Rl | Kl | B2l | B4l | B6l | B8l | B10l |
| 2.92E+02 | −2.98E+00 | 0.00E+00 | −4.94E−06 | −3.17E−10 | 5.88E−13 | 0.00E+00 |

| ru | E2u | E4u | E6u | E8u | E10u |
|---|---|---|---|---|---|
| −9.69E+00 | 9.19E−05 | −8.91E−08 | 9.13E−11 | −3.78E−14 | 0.00E+00 |
| rl | E2l | E4l | E6l | E8l | E10l |
| −9.69E+00 | 1.06E−04 | −1.24E−07 | 1.28E−10 | −5.09E−14 | 0.00E+00 |

| E1 | E3 | E5 |
|---|---|---|
| 0.00E+00 | 0.00E+00 | 0.00E+00 |

TABLE 5

| | Surface | | | | | | | | |
|---|---|---|---|---|---|---|---|---|---|
| | number | R | N | x | y | z | gx(x) | gx(y) | gx(z) |
| Light source 1 | 1 to 6 | Common | Common | Common | Common | Common | Common | Common | Common |
| to main | | | | | | | | | |
| scanning stop 4 | | | | | | | | | |
| Deflecting | 7 | 0.000 | 1.0000 | −4.965 | 3.008 | 0.000 | 0.149 | 0.989 | 0.000 |
| surface 51 of | | | | | | | | | |
| polygon mirror | | | | | | | | | |
| 5 | | | | | | | | | |
| Incident surface | 8 | 12.100 | 1.5287 | 8.189 | 28.881 | 0.000 | 0.294 | 0.956 | 0.000 |
| of | | | | | | | | | |
| synchronization | | | | | | | | | |
| detection | | | | | | | | | |
| imaging | | | | | | | | | |
| element 81 | | | | | | | | | |
| Exit surface of | 9 | 0.000 | 1.0000 | 8.777 | 30.792 | 0.000 | 0.294 | 0.956 | 0.000 |
| synchronization | | | | | | | | | |
| detection | | | | | | | | | |
| imaging | | | | | | | | | |
| element 81 | | | | | | | | | |
| Synchronization | 10 | 0.000 | 1.0000 | 14.687 | 50.004 | 0.000 | — | — | — |
| detection light | | | | | | | | | |
| receiving | | | | | | | | | |
| element 80 | | | | | | | | | |

In Tables 3 and 4, “E-X” indicates “×10^{-X}”, and this is also applied to the following tables.

An incident surface of the anamorphic collimator lens 3 provided in the light scanning apparatus 100 according to the present embodiment is a rotationally symmetric aspheric surface and has a shape expressed by the following Expression (13):

$$X = \frac{\frac{{h}^{2}}{r}}{1 + \sqrt{1 - ( 1 + k ) {( \frac{h}{r} )}^{2}}} + {C}_{2} {h}^{2} + {C}_{4} {h}^{4} + {C}_{6} {h}^{6} + {C}_{8} {h}^{8} + {C}_{10} {h}^{10} . \qquad ( 13 )$$

In Expression (13), h is (Y²+Z²)^{1/2}.

Further, meridional line shapes (shapes in the main scanning cross section) of an exit surface of the anamorphic collimator lens 3, and an incident surface and an exit surface of the scanning imaging lens 6 provided in the light scanning apparatus 100 according to the present embodiment are expressed by the following Expression (14):

$$x = \frac{\frac{{y}^{2}}{R}}{1 + \sqrt{1 - ( 1 + K ) {( \frac{y}{R} )}^{2}}} + {B}_{2} {y}^{2} + {B}_{4} {y}^{4} + {B}_{6} {y}^{6} + {B}_{8} {y}^{8} + {B}_{10} {y}^{10} . \qquad ( 14 )$$

In Expression (14), a local coordinate system is used in which an intersection point between a lens surface (optical surface) of each lens and an optical axis, which is a surface vertex of the lens surface, is set as an origin.

Specifically, an axis in a traveling direction of light, namely an optical axis is defined as an x-axis, an axis orthogonal to the x-axis in the main scanning cross section is defined as a y-axis, and an axis perpendicular to the x-axis and the y-axis, namely perpendicular to the main scanning cross section is defined as a z-axis.

Further, in Expression (14), R is a curvature radius (curvature radius of meridional line) in the main scanning cross section, and K, B₂, B₄, B₆, B₈ and B₁₀ are aspheric coefficients.

Note that numerical values of the aspheric coefficients K, B₂, B₄, B₆, B₈ and B₁₀ may be different between a positive side and a negative side of the Y-axis.

Thereby, the meridional line shape can be set to be asymmetrical to each other with respect to the optical axis in the main scanning direction.

Specifically, in Tables 3 and 4, the aspherical coefficients on a light source side with respect to the optical axis are represented by Kᵤ, B₂ᵤ, B₄ᵤ, B₆ᵤ, B₈ᵤ and B₁₀ᵤ, and the aspherical coefficients on an opposite light source side with respect to the optical axis are represented by Kₗ, B₂ₗ, B₄ₗ, B₆ₗ, B₈ₗ and B₁₀ₗ.

In addition, a degree of freedom in design can be improved by adding an odd-order term of Y in Expression (14).

Further, sagittal line shapes (shapes in the sub-scanning cross section) of the exit surface of the anamorphic collimator lens 3, and the incident surface and the exit surface of the scanning imaging lens 6 provided in the light scanning apparatus 100 according to the present embodiment are expressed by the following Expression (15):

$$S = \frac{\frac{{z}^{2}}{{r}^{′}}}{1 + \sqrt{1 - {( \frac{z}{{r}^{′}} )}^{2}}} . \qquad ( 15 )$$

In Expression (15), r′ is a curvature radius (curvature radius of sagittal line) in the sub-scanning cross section at a position away from the optical axis by Y in the main scanning direction, and is expressed by the following Expression (16):

$${r}^{′} = r ( 1 + {\sum }_{i = 1}^{10} {E}_{i} {y}^{i} ) . \qquad ( 16 )$$

In Expression (16), r is a curvature radius in the sub-scanning cross section on the optical axis, and E₁, E₂, E₃, . . . , and E₁₀ are sagittal line variation coefficients.

Note that numerical values of the sagittal line variation coefficient E₂, E₄, E₆, E₈ and E₁₀ may be different between a positive side and a negative side of the Y-axis.

Thereby, the sagittal line shapes can be set to be asymmetric to each other with respect to the optical axis in the main scanning direction.

Specifically, in Tables 3 and 4, the sagittal line variation coefficients on the light source side with respect to the optical axis are represented by E₂ᵤ, E₄ᵤ, E₆ᵤ, E₈ᵤ and E₁₀ᵤ, and the sagittal line variation coefficients on the opposite light source side with respect to the optical axis are represented by E₂ₗ, E₄ₗ, E₆ₗ, E₈ₗ and E₁₀ₗ.

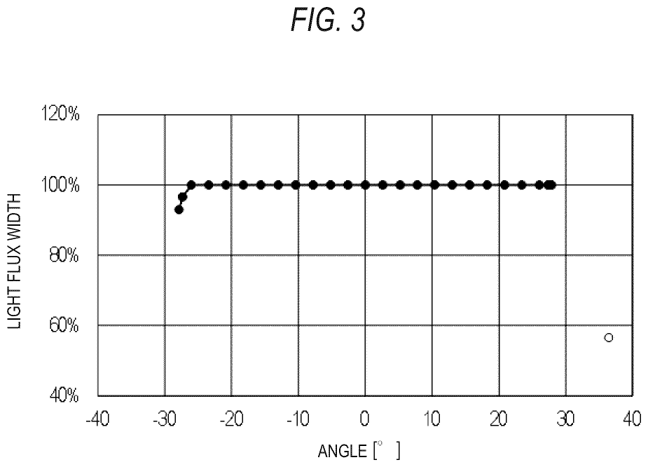

FIG. 3 shows an angle dependence of a light flux width in the main scanning cross section of a light flux deflected by the polygon mirror 5 in the light scanning apparatus 100 according to the present embodiment.

Specifically, an angle on a horizontal axis in FIG. 3 is a rotation angle (θₘₐₓ₋/2 to θₘₐₓ₊/2) of the deflecting surface 51 in the polygon mirror 5.

That is, with respect to the angle on the horizontal axis in FIG. 3, 0°, an angle on a positive side, and an angle on a negative side correspond to the on-axis light flux traveling to the on-axis image height 70, an off-axis light flux traveling to an off-axis image height on the light source 1 side, and the off-axis light flux traveling to an off-axis image height on a side opposite to the light source 1, respectively.

Further, a light flux width on a vertical axis in FIG. 3 is expressed by a ratio to the width Wᵢ of the incident light flux Lᵢ.

In FIG. 3, black circles indicate light fluxes for scanning respective image heights on the surface to be scanned 7, and a white circle indicates a synchronization detection light flux that reaches the center of the light receiving surface of the synchronization detection light receiving element 80.

As shown in FIG. 3, in the light scanning apparatus 100 according to the present embodiment, Inequalities (1) and (1′) are satisfied.

Further, as shown in FIG. 3, any light flux for scanning the respective image heights on the surface to be scanned 7 has a light flux width of 90% or more of the width Wᵢ of the incident light flux Lᵢ in the light scanning apparatus 100 according to the present embodiment.

Furthermore, as shown in Table 1, the angles of the light fluxes for scanning the positive-side outermost off-axis image height 71 and the negative-side outermost off-axis image height 72 are +55.7° and −55.7°, respectively.

A spot diameter by an incident light flux increases when a light flux width of the incident light flux decreases such that a spot diameter by the incident light flux increases by 10% when a light flux width of the incident light flux decreases by 10% on the surface to be scanned 7.

On the other hand, in a conventional light scanning apparatus, a depth width is set so as to allow an increase in spot diameter by about 15% with respect to the spot diameter in an in-focus state.

Therefore, even if the spot diameter varies as described above in the light scanning apparatus 100 according to the present embodiment, printing performance is sufficient when the light scanning apparatus 100 is used in an image forming apparatus.

Further, in the light scanning apparatus 100 according to the present embodiment, the light amount decreases due to the reduction in the light flux width of the synchronization detection light flux as shown in FIG. 3, but this can also be sufficiently allowed as described above.

Next, the light scanning apparatus 100 according to the present embodiment and a light scanning apparatus according to a comparative example are compared with each other.

Main specification values of the light scanning apparatus according to the comparative example are shown in the following Table 6.

TABLE 6

| | |
|---|---|
| Diameter φ [mm] of circumscribed circle in main scanning cross section of | 20 |
| polygon mirror 5 | |
| Number N of deflecting surface 51 of polygon mirror 5 | 4 |
| Width in main scanning cross section of deflecting surface 51 of polygon | 14.142 |
| mirror 5 [mm] | |
| Diameter φin [mm] of inscribed circle in main scanning cross section of | 14.142 |
| polygon mirror 5 | |
| Distance φin/2 between center of polygon mirror 5 and end in main scanning | 7.071 |
| direction of deflecting surface 51 | |
| Coordinate in X direction of rotation center of polygon mirror 5 | −6.016 |
| Coordinate in Y direction of rotation center of polygon mirror 5 | −3.984 |

The light scanning apparatus according to the comparative example has the same configuration as that of the light scanning apparatus 100 according to the present embodiment except that the light scanning apparatus according to the comparative example uses a polygon mirror 5 with four surfaces in which the number of deflecting surfaces 51 is smaller by one than that of the light scanning apparatus 100 according to the present embodiment. Therefore, the same members are denoted by the same reference numerals, and description thereof is omitted.

That is, a distance between the rotation center 50 of the rotation axis of the polygon mirror 5 and the deflecting surface 51 in the main scanning cross section, in other words, a radius of the inscribed circle of the polygon mirror 5 in the light scanning apparatus according to the comparative example is the same size as that of the light scanning apparatus 100 according to the present embodiment.

Thereby, in the light scanning apparatus according to the comparative example, a coordinate of a deflection point on the deflecting surface 51 at each rotation angle of the polygon mirror 5 can be set to be the same as that in the light scanning apparatus 100 according to the present embodiment.

Therefore, in the light scanning apparatus according to the comparative example, the same imaging optical system 85, incident optical system 75, and synchronization detection optical system as those of the light scanning apparatus 100 according to the present embodiment can be used since a variation of a focus position caused by the rotation of the polygon mirror 5 is suppressed.

In other words, in the light scanning apparatus 100 according to the present embodiment, sufficient optical performance can be obtained when the same imaging optical system 85, incident optical system 75, and synchronization detection optical system are used for any of the polygon mirror 5 with five surfaces and the polygon mirror 5 with four surfaces.

In still other words, in the light scanning apparatus 100 according to the present embodiment, the polygon mirror 5 with five surfaces and the polygon mirror 5 with four surfaces can be selectively mounted.

On the other hand, in the light scanning apparatus 100 according to the present embodiment, it is possible to increase the number of times of scanning on the surface to be scanned 7 when the polygon mirror 5 rotates once since the number of deflecting surfaces 51 is larger than that of the light scanning apparatus according to the comparative example.

That is, it is possible to improve a printing speed of the image forming apparatus in which the light scanning apparatus 100 according to the present embodiment is mounted by increasing the number of times of scanning on the surface 7 when the polygon mirror 5 rotates once.

Alternatively, it is possible to reduce the number of rotations per unit time of the polygon mirror 5 with maintaining the printing speed of the image forming apparatus in which the light scanning apparatus 100 according to the present embodiment is mounted by increasing the number of times of scanning on the surface 7 when the polygon mirror 5 rotates once.

Thereby, a polygon motor for rotationally driving the polygon mirror 5 can be simplified and reduced in power consumption.

Further, in the light scanning apparatus 100 according to the present embodiment, the number of light emitting points in the light source 1 can be reduced by increasing the number of times of scanning on the surface 7 when the polygon mirror 5 rotates once.

For example, printing speed of an image forming apparatus in which the light scanning apparatus according to the comparative example including the light source 1 with five light emitting points is mounted is the same as that in which the light scanning apparatus 100 according to the present embodiment including the light source 1 with four light emitting points is mounted.

Further, for example, a case where the light source 1 has two light emitting points in the light scanning apparatus according to the comparative example is considered.

Then, the printing speed of the image forming apparatus in which the light scanning apparatus according to the comparative example is mounted is the same as that in which the light scanning apparatus 100 according to the present embodiment is mounted when the light source 1 has a single light emitting point and the rotation speed of the polygon mirror 5 is 1.6 times higher in the light scanning apparatus 100 according to the present embodiment.

However, in any of the above-described cases, it is necessary to adjust a light emission amount of each light emitting point of the light source 1.

In this way, it is possible to reduce costs of the light source 1, a controller for driving the light source 1 and the like by reducing the number of light emitting points of the light source 1 in the light scanning apparatus 100 according to the present embodiment.

Next, values of Inequalities in the light scanning apparatus 100 according to the present embodiment and the light scanning apparatus according to the comparative example are shown in the following Table 7.

TABLE 7

| | First | Comparative |
|---|---|---|
| | embodiment | example |
| Inequalities | | |
| Inequality (2): 5.50 ≤ φ − K × N × (N − 1) ≤ 13.00 (K = 0.52) | 7.08 | 13.76 |
| Inequality (2): 5.50 ≤ φ − K × N × (N − 1) ≤ 13.00 (K = 0.54) | 6.68 | 13.52 |
| Inequality (2): 5.50 ≤ φ − K × N × (N − 1) ≤ 13.00 (K = 0.56) | 6.28 | 13.28 |
| Inequality (3): 6.00 < (φ + 15)/N < 7.40 | 6.50 | 8.75 |
| Inequality (3a): 6.20 < (φ + 15)/N < 7.20 | | |
| Inequality (4): 22.60 < Ymax+/(φ/N) < 37.00 | 30.61 | 21.40 |
| Inequality (4a): 27.00 < Ymax+/(φ/N) < 34.00 | | |
| Inequality (5): 1.78 < (θi + θmax+)/θBD < 2.33 | 2.00 | 2.00 |
| Inequality (6): 0.23 < (θBD − θmax+)/(360/N) < 0.35 | 0.24 | 0.19 |
| With respect to Inequality (1): WBD < Wmax− < Wmax+ | | |
| and Inequality (1′): Wmax+ = Wi | | |
| Width Wi of incident light flux Li | 1.78 | 1.78 |
| Width WBD of synchronization detection light flux | 1.01 | 1.78 |
| Width Wmax+ of light flux traveling to positive-side | 1.78 | 1.78 |
| outermost off-axis image height 71 | | |
| Width Wcenter of light flux traveling to on-axis image | 1.78 | 1.78 |
| height 70 | | |
| Width Wmax− of light flux traveling to negative-side | 1.65 | 1.78 |
| outermost off-axis image height 72 | | |
| Angle θBD [°] of scanning light flux LBD | 72.9 | 72.9 |
| Angle θBD − 360/N × 2 [°] of scanning light flux LBD2 | −71.1 | x |
| Angle θmax+ [°] of scanning light flux Lmax+ | 55.7 | 55.7 |
| Angle θmax− [°] of scanning light flux Lmax− | −55.7 | −55.7 |
| Angle θmax− + 360/N × 2 [°] of scanning light flux Lmax− | 88.3 | x |
| 2 | | |

As shown in Tables 1 and 6, the width in the main scanning cross section of the deflecting surface 51 of the polygon mirror 5 in the light scanning apparatus according to the comparative example is considerably larger than that in the light scanning apparatus 100 according to the present embodiment.

Therefore, as shown in Table 7, the width W_{BD} of the synchronization detection light flux and the width Wₘₐₓ₋ of the scanning light flux Lₘₐₓ₋ traveling to the negative-side outermost off-axis image height 72 are the same as the width Wᵢ of the incident light flux Lᵢ, namely are not reduced in the light scanning apparatus according to the comparative example.

On the other hand, the diameter of the circumscribed circle as an outer shape of the polygon mirror 5 in the light scanning apparatus 100 according to the present embodiment is smaller than that in the light scanning apparatus according to the comparative example.

That is, it is possible to downsize the light scanning apparatus 100 according to the present embodiment and the image forming apparatus on which the light scanning apparatus 100 is mounted since downsizing of the polygon mirror 5 is achieved in the light scanning apparatus 100 according to the present embodiment.

Further, the polygon motor for rotationally driving the polygon mirror 5 can also be reduced in size since downsizing of the polygon mirror 5 is achieved.

This is because a rotational moment of the polygon mirror 5 increases as a size in the main scanning cross section of the polygon mirror 5 increases.

Furthermore, it is also possible to reduce a power consumption of the polygon motor along with downsizing of the polygon motor due to downsizing of the polygon mirror 5.

In addition, a wind noise generated from the polygon mirror 5 is reduced, so that a structure for shielding the wind noise can be simplified and downsized when the diameter of the circumscribed circle of the polygon mirror 5 decreases.

As described above, the light scanning apparatus 100 according to the present embodiment can be downsized.

Further, as shown in Table 7, both of Inequality (2) in the case where K is a constant of 0.52 or more and 0.56 or less and Inequality (2) in the case where K is a constant of 0.53 or more and 0.55 or less are satisfied in the light scanning apparatus 100 according to the present embodiment.

On the other hand, in the light scanning apparatus according to the comparative example, any of Inequality (2) in the case where K is a constant of 0.52 or more and 0.56 or less and Inequality (2) in the case where K is a constant of 0.53 or more and 0.55 or less is not satisfied.

Further, Inequalities (3), (3a), (4), (4a) and (6) are satisfied in the light scanning apparatus 100 according to the present embodiment, but are not satisfied in the light scanning apparatus according to the comparative example.

Inequality (5) is satisfied in the light scanning apparatus 100 according to the present embodiment.

Inequality (1) is satisfied in the light scanning apparatus 100 according to the present embodiment, but is not satisfied in the light scanning apparatus according to the comparative example.

Inequality (1′) is satisfied in the light scanning apparatus 100 according to the present embodiment.

As described above, the size of the light scanning apparatus 100 according to the present embodiment can be reduced by satisfying each Inequality.

Further, as shown in Table 7, any of the angle (θ_{BD}−360/N×2) of the scanning light flux L_{BD2} and the angle (θₘₐₓ₋+360/N×2) of the scanning light flux Lₘₐₓ₋₂ is not within a range between the angle θₘₐₓ₊ and the angle θₘₐₓ₋ in the light scanning apparatus 100 according to the present embodiment.

Therefore, in the light scanning apparatus 100 according to the present embodiment, both of the scanning light flux L_{BD2} and the scanning light flux Lₘₐₓ₋₂ can be shielded by a member such as a housing, a rib other than the optical surface of the scanning imaging lens 6, or the like.

Even if the scanning light flux L_{BD2} or the scanning light flux Lₘₐₓ₋₂ is incident on the scanning imaging lens 6, the scanning light flux L_{BD2} or the scanning light flux Lₘₐₓ₋₂ does not reach the printed area of the surface to be scanned 7, so that there is no problem in printing.

As described above, in the light scanning apparatus 100 according to the present embodiment, it is possible to reduce the size of the polygon mirror 5, to reduce the size of the polygon motor by reducing the weight of the polygon mirror 5, and to simplify a soundproof member, compared to the light scanning apparatus according to the comparative example and a light scanning apparatus of the related art.

Thereby, the size of the light scanning apparatus 100 according to the present embodiment can be reduced, so that it is possible to provide a compact light scanning apparatus suitable for high-quality image recording and an image forming apparatus equipped with the light scanning apparatus.

That is, as the light scanning apparatus mounted on the image forming apparatus such as a printer, it is possible to obtain a light scanning apparatus which is downsized with maintaining high-speed and high-quality image recording by appropriately arranging the deflecting unit and each optical element.

The light scanning apparatus 100 according to the present embodiment is configured to scan a single surface to be scanned 7, but is not limited thereto.

That is, the above-described structure can also be applied to a both-side scanning system in which a plurality of imaging optical systems are provided on both sides of the polygon mirror 5 to scan a plurality of surfaces to be scanned.

Further, the above-described structure can also be applied to a light scanning apparatus employing an obliquely incident optical system for causing a light flux to be obliquely incident on the polygon mirror 5 in the sub-scanning cross section.

Furthermore, the above-described structure can also be applied to a one sided scanning system in which a plurality of light fluxes are obliquely incident on a predetermined deflecting surface of the polygon mirror 5, and the plurality of light fluxes deflected by the predetermined deflecting surface are guided by a plurality of imaging optical systems provided on one side of the polygon mirror 5 to scan a plurality of surfaces to be scanned.

In addition, the above-described structure can also be applied to a both-side scanning system in which a plurality of light fluxes are obliquely incident on two deflecting surfaces of the polygon mirror 5, and the plurality of light fluxes deflected by the two deflecting surfaces are guided by a plurality of imaging optical systems provided on both sides of the polygon mirror 5 to scan a plurality of surfaces to be scanned.

That is, the above-described structure can also be applied to a color image forming apparatus capable of forming a color image by scanning the plurality of surfaces to be scanned.

Although the anamorphic collimator lens 3 is used in the light scanning apparatus 100 according to the present embodiment, a rotationally symmetric coupling lens and a cylinder lens having power only in the sub-scanning direction may be used instead.

### Second Embodiment

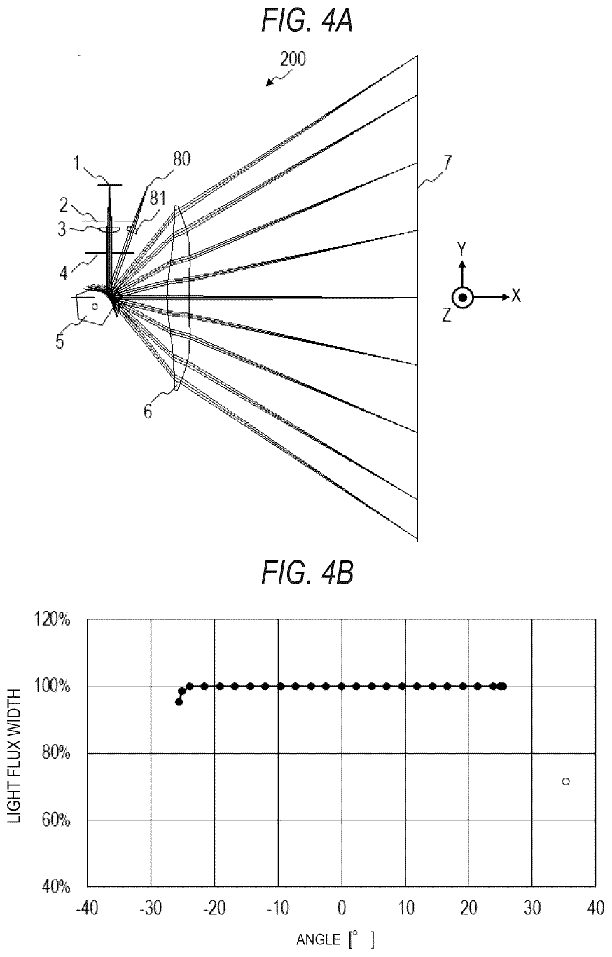

FIG. 4A shows a schematic main scanning cross sectional view of a light scanning apparatus 200 according to a second embodiment of the present invention. In FIG. 4A, the electrical mounting substrate 83 is not shown.

Further, FIG. 4B shows an angle dependence of a light flux width in the main scanning cross section of a light flux deflected by a polygon mirror 5 in the light scanning apparatus 200 according to the second embodiment (corresponding to FIG. 3).

Specifically, an angle on a horizontal axis of FIG. 4B is a rotation angle (θₘₐₓ₋/2 to θₘₐₓ₊/2) of a deflecting surface 51 of the polygon mirror 5.

The light scanning apparatus 200 according to the present embodiment has the same structure as the light scanning apparatus 100 according to the first embodiment except that each numerical value is different, so that the same members are denoted by the same reference numerals and the description thereof is omitted.

Main specification values of the light scanning apparatus 200 according to the present embodiment, and the arrangement of each optical element provided in the incident optical system 75 and the imaging optical system 85 are shown in the following Tables 8 and 9, respectively.

An aspherical shape of the anamorphic collimator lens 3 and an aspherical shape of the scanning imaging lens 6 provided in the light scanning apparatus 200 according to the present embodiment are shown in the following Tables 10 and 11, respectively.

An arrangement of each optical element provided in the synchronization detection optical system of the light scanning apparatus 200 according to the present embodiment is shown in the following Table 12.

Main specification values of the light scanning apparatus according to the comparative example is shown in the following Table 13.

TABLE 8

| | |
|---|---|
| Wavelength of light source 1 [nm] | 790 |
| Angle θi [°] between optical axis of imaging optical system 85 and optical | 90.0 |
| axis of incident optical system 75 | |
| Diameter φ [mm] of circumscribed circle in main scanning cross section of | 17.481 |
| polygon mirror 5 | |
| Number N of deflecting surface 51 of polygon mirror 5 | 5 |
| Width in main scanning cross section of deflecting surface 51 of polygon | 10.275 |
| mirror 5 [mm] | |
| Diameter φin [mm] of inscribed circle in main scanning cross section of | 14.142 |
| polygon mirror 5 | |
| Distance φin/2 between center of polygon mirror 5 and end in main scanning | 7.071 |
| direction of deflecting surface 51 | |
| Coordinate in X direction of rotation center of polygon mirror 5 | −5.839 |
| Coordinate in Y direction of rotation center of polygon mirror 5 | −4.161 |
| Fθ coefficient | 120.0 |
| Coordinate Ymax+ in Y direction of positive-side outermost off-axis image | 107.0 |
| height 71 | |
| Coordinate Ymax− in Y direction of negative-side outermost off-axis image | −107.0 |
| height 72 | |
| Printed width Ywidth = (Ymax+) − (Ymax−) on surface to be scanned 7 | 214.0 |
| Maximum angle of view θmax+ [°] corresponding to positive-side outermost | 51.1 |
| off-axis image height 71 | |
| Maximum angle of view θmax− [°] corresponding to negative-side outermost | −51.1 |
| off-axis image height 72 | |
| Angle of view θBD [°] of synchronization detection light flux | 70.5 |

TABLE 9

| | Surface | | | | | | | | |
|---|---|---|---|---|---|---|---|---|---|
| | number | R | N | x | y | z | gx(x) | gx(y) | gx(z) |
| Light emitting point of light | 1 | 0.000 | −1.511 | 0.000 | 50.000 | 0.000 | 0.000 | 1.000 | 0.000 |
| source 1 | | | | | | | | | |
| | 2 | 0.000 | −1.000 | 0.000 | 49.750 | 0.000 | 0.000 | 1.000 | 0.000 |
| Sub-scanning stop 2 | 3 | 0.000 | −1.000 | 0.000 | 34.000 | 0.000 | 0.000 | 1.000 | 0.000 |
| Incident surface of | 4 | aspherical | −1.529 | 0.000 | 31.000 | 0.000 | 0.000 | 1.000 | 0.000 |
| anamorphic collimator lens 3 | | | | | | | | | |
| Exit surface of anamorphic | 5 | aspherical | −1.000 | 0.000 | 29.000 | 0.000 | 0.000 | 1.000 | 0.000 |
| collimator lens 3 | | | | | | | | | |
| Main scanning stop 4 | 6 | 0.000 | 1.000 | 0.000 | 20.000 | 0.000 | 0.000 | 1.000 | 0.000 |
| Deflecting surface 51 of | 7 | 0.000 | 1.000 | 0.522 | −1.072 | 0.000 | 0.900 | 0.437 | 0.000 |
| polygon mirror 5 | | | | | | | | | |
| Incident surface of scanning | 8 | aspherical | 1.529 | 25.700 | 0.000 | 0.000 | 1.000 | 0.000 | 0.000 |
| imaging lens 6 | | | | | | | | | |
| Exit surface of scanning | 9 | aspherical | 1.000 | 35.500 | 0.000 | 0.000 | 1.000 | 0.000 | 0.000 |
| imaging lens 6 | | | | | | | | | |
| Surface to be scanned 7 | 12 | 0.000 | 1.000 | 137.500 | 0.000 | 0.000 | 1.000 | 0.000 | 0.000 |

| | |
|---|---|
| Aperture width in sub- | 0.860 |
| scanning direction of sub- | |
| scanning stop 2 | |
| Aperture width in main | 2.040 |
| scanning direction of main | |
| scanning stop 4 | |

TABLE 10
Incident surface of anamorphic collimator lens 3

| r | k | C2 | C4 | C6 | C8 | C10 |
|---|---|---|---|---|---|---|
| 0.00E+00 | 0.00E+00 | 0.00E+00 | 0.00E+00 | 0.00E+00 | 0.00E+00 | 0.00E+00 |

Exit surface of anamorphic collimator lens 3

| Ru | Ku | B2u | B4u | B6u | B8u | B10u |
|---|---|---|---|---|---|---|
| 1.02E+01 | 0.00E+00 | 0.00E+00 | −4.35E−05 | 0.00E+00 | 0.00E+00 | 0.00E+00 |
| Rl | Kl | B2l | B4l | B6l | B8l | B10l |
| 1.02E+01 | 0.00E+00 | 0.00E+00 | −4.35E−05 | 0.00E+00 | 0.00E+00 | 0.00E+00 |

| ru | E2u | E4u | E6u | E8u | E10u |
|---|---|---|---|---|---|
| 6.25E+00 | 0.00E+00 | 0.00E+00 | 0.00E+00 | 0.00E+00 | 0.00E+00 |
| rl | E2l | E4l | E6l | E8l | E10l |
| 6.25E+00 | 0.00E+00 | 0.00E+00 | 0.00E+00 | 0.00E+00 | 0.00E+00 |

| E1 | E3 | E5 |
|---|---|---|
| 0.00E+00 | 0.00E+00 | 0.00E+00 |

TABLE 11
Incident surface of scanning imaging lens 6

| Ru | Ku | B2u | B4u | B6u | B8u | B10u |
|---|---|---|---|---|---|---|
| 6.33E+01 | 6.72E−01 | 0.00E+00 | −8.92E−06 | 3.78E−09 | −8.04E−13 | 0.00E+00 |
| Rl | Kl | B2l | B4l | B6l | B8l | B10l |
| 6.33E+01 | 6.72E−01 | 0.00E+00 | −8.92E−06 | 3.78E−09 | −8.04E−13 | 0.00E+00 |

| ru | E2u | E4u | E6u | E8u | E10u |
|---|---|---|---|---|---|
| −2.47E+01 | 9.96E−05 | −3.37E−08 | −7.99E−12 | 9.09E−16 | 0.00E+00 |
| rl | E2l | E4l | E6l | E8l | E10l |
| −2.47E+01 | 9.96E−05 | −3.37E−08 | −7.99E−12 | 9.09E−16 | 0.00E+00 |

| E1 | E3 | E5 |
|---|---|---|
| 0.00E+00 | 0.00E+00 | 0.00E+00 |

Exit surface of scanning imaging lens 6

| Ru | Ku | B2u | B4u | B6u | B8u | B10u |
|---|---|---|---|---|---|---|
| 2.08E+02 | −2.48E+00 | 0.00E+00 | −4.65E−06 | 2.86E−10 | 3.38E−13 | 0.00E+00 |
| Rl | Kl | B2l | B4l | B6l | B8l | B10l |
| 2.08E+02 | −2.48E+00 | 0.00E+00 | −4.65E−06 | 2.86E−10 | 3.38E−13 | 0.00E+00 |

| ru | E2u | E4u | E6u | E8u | E10u |
|---|---|---|---|---|---|
| −1.00E+01 | 7.86E−05 | −5.56E−08 | 5.95E−11 | −2.63E−14 | 0.00E+00 |
| rl | E2l | E4l | E6l | E8l | E10l |
| −1.00E+01 | 8.71E−05 | −7.50E−08 | 7.95E−11 | −3.32E−14 | 0.00E+00 |

| E1 | E3 | E5 |
|---|---|---|
| 0.00E+00 | 0.00E+00 | 0.00E+00 |

TABLE 12

| | Surface | | | | | | | | |
|---|---|---|---|---|---|---|---|---|---|
| | number | R | N | x | y | z | gx(x) | gx(y) | gx(z) |
| Light source 1 | 1 to 6 | Common | Common | Common | Common | Common | Common | Common | Common |
| to main | | | | | | | | | |
| scanning stop 4 | | | | | | | | | |
| Deflecting | 7 | 0.000 | 1.0000 | −4.642 | 2.808 | 0.000 | 0.169 | 0.986 | 0.000 |
| surface 51 of | | | | | | | | | |
| polygon mirror | | | | | | | | | |
| 5 | | | | | | | | | |
| Incident surface | 8 | 12.100 | 1.5287 | 9.617 | 29.168 | 0.000 | 0.334 | 0.943 | 0.000 |
| of | | | | | | | | | |
| synchronization | | | | | | | | | |
| detection | | | | | | | | | |
| imaging | | | | | | | | | |
| element 81 | | | | | | | | | |
| Exit surface of | 9 | 0.000 | 1.0000 | 10.285 | 31.053 | 0.000 | 0.334 | 0.943 | 0.000 |
| synchronization | | | | | | | | | |
| detection | | | | | | | | | |
| imaging | | | | | | | | | |
| element 81 | | | | | | | | | |
| Synchronization | 10 | 0.000 | 1.0000 | 16.994 | 50.000 | 0.000 | — | — | — |
| detection light | | | | | | | | | |
| receiving | | | | | | | | | |
| element 80 | | | | | | | | | |

TABLE 13

| | |
|---|---|
| Diameter φ [mm] of circumscribed circle in main scanning cross section of | 20 |
| polygon mirror 5 | |
| Number N of deflecting surface 51 of polygon mirror 5 | 4 |
| Width in main scanning cross section of deflecting surface 51 of polygon | 14.142 |
| mirror 5 [mm] | |
| Diameter φin [mm] of inscribed circle in main scanning cross section of | 14.142 |
| polygon mirror 5 | |
| Distance φin/2 between center of polygon mirror 5 and end in main scanning | 7.071 |
| direction of deflecting surface 51 | |
| Coordinate in X direction of rotation center of polygon mirror 5 | −5.839 |
| Coordinate in Y direction of rotation center of polygon mirror 5 | −4.161 |

As shown in FIG. 4B, in the light scanning apparatus 200 according to the present embodiment, Inequalities (1) and (1′) are satisfied.

Further, as shown in FIG. 4B, any light flux for scanning each image height on the surface to be scanned 7 has the light flux width of 90% or more of the width Wᵢ of the incident light flux Lᵢ in the light scanning apparatus 200 according to the present embodiment.

Furthermore, as shown in Table 8, angles of the light flux for scanning the image height 72 are +51.1° and −51.1°, respectively.

The light scanning apparatus according to the comparative example has the same structure as that of the light scanning apparatus 200 according to the present embodiment except that the light scanning apparatus according to the comparative example uses the polygon mirror 5 with four surfaces in which the number of deflecting surfaces 51 is smaller by one than that of the light scanning apparatus 200 according to the present embodiment. Therefore, the same members are denoted by the same reference numerals, and description thereof is omitted.

Next, the value of each Inequality in the light scanning apparatus 200 according to the present embodiment and the light scanning apparatus according to the comparative example is shown in the following Table 14.

TABLE 14

| | Second | Comparative |
|---|---|---|
| | embodiment | example |
| Inequalities | | |
| Inequality (2): 5.50 ≤ φ − K × N × (N − 1) ≤ 13.00 (K = 0.52) | 7.08 | 13.76 |
| Inequality (2): 5.50 ≤ φ − K × N × (N − 1) ≤ 13.00 (K = 0.54) | 6.68 | 13.52 |
| Inequality (2): 5.50 ≤ φ − K × N × (N − 1) ≤ 13.00 (K = 0.56) | 6.28 | 13.28 |
| Inequality (3): 6.00 < (φ + 15)/N < 7.40 | 6.50 | 8.75 |
| Inequality (3a): 6.20 < (φ + 15)/N < 7.20 | | |
| Inequality (4): 22.60 < Ymax+/(φ/N) < 37.00 | 30.61 | 21.40 |
| Inequality (4a): 27.00 < Ymax+/(φ/N) < 34.00 | | |
| Inequality (5): 1.78 < (θi + θmax+)/θBD < 2.33 | 2.00 | 2.00 |
| Inequality (6): 0.23 < (θBD − θmax+)/(360/N) < 0.35 | 0.27 | 0.22 |
| With respect to Inequality (1): WBD < Wmax− < Wmax+ | | |
| and Inequality (1′): Wmax+ = Wi | | |
| Width Wi of incident light flux Li | 1.93 | 1.93 |
| Width WBD of synchronization detection light flux | 1.38 | 1.93 |
| Width Wmax+ of light flux traveling to positive-side | 1.93 | 1.93 |
| outermost off-axis image height 71 | | |
| Width Wcenter of light flux traveling to on-axis image | 1.93 | 1.93 |
| height 70 | | |
| Width Wmax− of light flux traveling to negative-side | 1.84 | 1.93 |
| outermost off-axis image height 72 | | |
| Angle θBD [°] of scanning light flux LBD | 70.5 | 70.5 |
| Angle θBD − 360/N × 2 [°] of scanning light flux LBD2 | −73.5 | x |
| Angle θmax+ [°] of scanning light flux Lmax+ | 51.1 | 51.1 |
| Angle θmax− [°] of scanning light flux Lmax− | −51.1 | −51.1 |
| Angle θmax− + 360/N × 2 [°] of scanning light flux Lmax− | 92.9 | x |
| 2 | | |

As shown in Tables 8 and 13, the width in the main scanning cross section of the deflecting surface 51 of the polygon mirror 5 is considerably larger in the light scanning apparatus according to the comparative example than in the light scanning apparatus 200 according to the present embodiment.

Therefore, as shown in Table 14, the width W_{BD} of the synchronization detection light flux and the width Wₘₐₓ₋ of the scanning light flux Lₘₐₓ₋ traveling to the negative side outermost off-axis image height 72 are the same as the width Wᵢ of the incident light flux Lᵢ, namely are not reduced in the light scanning apparatus according to the comparative example.

On the other hand, a diameter of the circumscribed circle as an outer shape of the polygon mirror 5 is smaller in the light scanning apparatus 200 according to the present embodiment than in the light scanning apparatus according to the comparative example.

That is, downsizing of the polygon mirror 5 is achieved in the light scanning apparatus 200 according to the present embodiment, so that it is possible to downsize the light scanning apparatus 200 according to the present embodiment and the image forming apparatus in which the light scanning apparatus 200 is mounted.

Further, since the polygon mirror 5 can be reduced in size, the polygon motor for rotationally driving the polygon mirror 5 can also be reduced in size.

This is because a rotational moment of the polygon mirror 5 increases as the size in the main scanning cross section of the polygon mirror 5 increases.

Furthermore, it is also possible to reduce a power consumption of the polygon motor along with the downsizing of the polygon motor due to the downsizing of the polygon mirror 5.

In addition, when the diameter of the circumscribed circle of the polygon mirror 5 decreases, a wind noise generated from the polygon mirror 5 decreases, so that a structure for shielding the wind noise can be simplified and downsized.

As described above, the light scanning apparatus 200 according to the present embodiment can be reduced in size.

As shown in Table 14, both of Inequality (2) in the case where K is a constant of 0.52 or more and 0.56 or less and Inequality (2) in the case where K is a constant of 0.53 or more and 0.55 or less are satisfied in the light scanning apparatus 200 according to the present embodiment.

On the other hand, in the light scanning apparatus according to the comparative example, any of Inequality (2) in the case where K is a constant of 0.52 or more and 0.56 or less and Inequality (2) in the case where K is a constant of 0.53 or more and 0.55 or less is not satisfied.

Further, Inequalities (3), (3a), (4), (4a) and (6) are satisfied in the light scanning apparatus 200 according to the present embodiment, but are not satisfied in the light scanning apparatus according to the comparative example.

Inequality (5) is satisfied in the light scanning apparatus 200 according to the present embodiment.

Inequality (1) is satisfied in the light scanning apparatus 200 according to the present embodiment, but is not satisfied in the light scanning apparatus according to the comparative example.

Inequality (1′) is satisfied in the light scanning apparatus 200 according to the present embodiment.

As described above, the size of the light scanning apparatus 200 according to the present embodiment can be reduced by satisfying each Inequality.

Further, as shown in Table 14, any of the angle (θ_{BD}−360/N×2) of the scanning light flux L_{BD2} and the angle (θₘₐₓ₋+360/N×2) of the scanning light flux Lₘₐₓ₋₂ is not within a range between the angle θₘₐₓ₊ and the angle θₘₐₓ₋ in the light scanning apparatus 200 according to the present embodiment.

Therefore, in the light scanning apparatus 200 according to the present embodiment, both of the scanning light flux L_{BD2} and the scanning light flux Lₘₐₓ₋₂ can be shielded by a member such as a housing, a rib other than the optical surface of the scanning imaging lens 6, or the like.

Even if the scanning light flux L_{BD2} or the scanning light flux Lₘₐₓ₋₂ is incident on the scanning imaging lens 6, the scanning light flux L_{BD2} or the scanning light flux Lₘₐₓ₋₂ does not reach the printed area of the surface to be scanned 7, so that there is no problem in printing.

As described above, in the light scanning apparatus 200 according to the present embodiment, it is possible to reduce the size of the polygon mirror 5, to reduce the size of the polygon motor by reducing the weight of the polygon mirror 5, and to simplify a soundproof member, compared to the light scanning apparatus according to the comparative example and a light scanning apparatus of the related art.

Thereby, the size of the light scanning apparatus 200 according to the present embodiment can be reduced, so that it is possible to provide a compact light scanning apparatus suitable for high-quality image recording and an image forming apparatus equipped with the light scanning apparatus.

### Third Embodiment

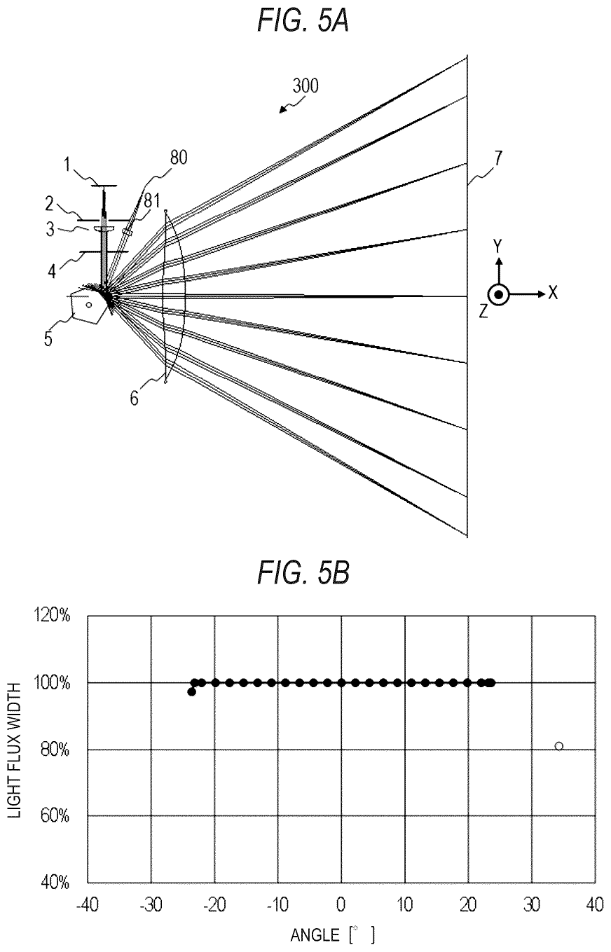

FIG. 5A shows a schematic main scanning cross sectional view of a light scanning apparatus 300 according to a third embodiment of the present invention. In FIG. 5A, the electrical mounting substrate 83 is not shown.

Further, FIG. 5B shows an angle dependence of a light flux width in the main scanning cross section of a light flux deflected by a polygon mirror 5 in the light scanning apparatus 300 according to the third embodiment (corresponding to FIG. 3).

Specifically, an angle on a horizontal axis of FIG. 5B is a rotation angle (θₘₐₓ₋/2 to θₘₐₓ₊/2) of a deflecting surface 51 of the polygon mirror 5.

The light scanning apparatus 300 according to the present embodiment has the same structure as the light scanning apparatus 100 according to the first embodiment except that each numerical value is different, so that the same members are denoted by the same reference numerals and the description thereof is omitted.

Main specification values of the light scanning apparatus 300 according to the present embodiment, and the arrangement of each optical element provided in the incident optical system 75 and the imaging optical system 85 are shown in the following Tables 15 and 16, respectively.

An aspherical shape of the anamorphic collimator lens 3 and an aspherical shape of the scanning imaging lens 6 provided in the light scanning apparatus 300 according to the present embodiment are shown in the following Tables 17 and 18, respectively.

An arrangement of each optical element provided in the synchronization detection optical system of the light scanning apparatus 300 according to the present embodiment is shown in the following Table 19.

Main specification values of the light scanning apparatus according to the comparative example is shown in the following Table 20.

TABLE 15

| | |
|---|---|
| Wavelength of light source 1 [nm] | 790 |
| Angle θi [°] between optical axis of imaging optical system 85 and optical | 90.0 |
| axis of incident optical system 75 | |
| Diameter φ [mm] of circumscribed circle in main scanning cross section of | 17.481 |
| polygon mirror 5 | |
| Number N of deflecting surface 51 of polygon mirror 5 | 5 |
| Width in main scanning cross section of deflecting surface 51 of polygon | 10.275 |
| mirror 5 [mm] | |
| Diameter φin [mm] of inscribed circle in main scanning cross section of | 14.142 |
| polygon mirror 5 | |
| Distance φin/2 between center of polygon mirror 5 and end in main scanning | 7.071 |
| direction of deflecting surface 51 | |
| Coordinate in X direction of rotation center of polygon mirror 5 | −5.706 |
| Coordinate in Y direction of rotation center of polygon mirror 5 | −4.294 |
| Fθ coefficient | 130.0 |
| Coordinate Ymax+ in Y direction of positive-side outermost off-axis image | 107.0 |
| height 71 | |
| Coordinate Ymax− in Y direction of negative-side outermost off-axis image | −107.0 |
| height 72 | |
| Printed width Ywidth = (Ymax+) − (Ymax−) on surface to be scanned 7 | 214.0 |
| Maximum angle of view θmax+ [°] corresponding to positive-side outermost | 47.2 |
| off-axis image height 71 | |
| Maximum angle of view θmax− [°] corresponding to negative-side outermost | −47.2 |
| off-axis image height 72 | |
| Angle of view θBD [°] of synchronization detection light flux | 68.6 |

TABLE 16

| | Surface | | | | | | | | |
|---|---|---|---|---|---|---|---|---|---|
| | number | R | N | x | y | z | gx(x) | gx(y) | gx(z) |
| Light emitting point of light | 1 | 0.000 | −1.511 | 0.000 | 50.000 | 0.000 | 0.000 | 1.000 | 0.000 |
| source 1 | | | | | | | | | |
| | 2 | 0.000 | −1.000 | 0.000 | 49.750 | 0.000 | 0.000 | 1.000 | 0.000 |
| Sub-scanning stop 2 | 3 | 0.000 | −1.000 | 0.000 | 34.000 | 0.000 | 0.000 | 1.000 | 0.000 |
| Incident surface of | 4 | aspherical | −1.529 | 0.000 | 31.000 | 0.000 | 0.000 | 1.000 | 0.000 |
| anamorphic collimator lens 3 | | | | | | | | | |
| Exit surface of anamorphic | 5 | aspherical | −1.000 | 0.000 | 29.000 | 0.000 | 0.000 | 1.000 | 0.000 |
| collimator lens 3 | | | | | | | | | |
| Main scanning stop 4 | 6 | 0.000 | 1.000 | 0.000 | 20.000 | 0.000 | 0.000 | 1.000 | 0.000 |
| Deflecting surface 51 of | 7 | 0.000 | 1.000 | 0.574 | −1.044 | 0.000 | 0.888 | 0.460 | 0.000 |
| polygon mirror 5 | | | | | | | | | |
| Incident surface of scanning | 8 | aspherical | 1.529 | 26.300 | 0.000 | 0.000 | 1.000 | 0.000 | 0.000 |
| imaging lens 6 | | | | | | | | | |
| Exit surface of scanning | 9 | aspherical | 1.000 | 36.500 | 0.000 | 0.000 | 1.000 | 0.000 | 0.000 |
| imaging lens 6 | | | | | | | | | |
| Surface to be scanned 7 | 12 | 0.000 | 1.000 | 163.500 | 0.000 | 0.000 | 1.000 | 0.000 | 0.000 |

| | |
|---|---|
| Aperture width in sub- | 1.080 |
| scanning direction of sub- | |
| scanning stop 2 | |
| Aperture width in main | 2.100 |
| scanning direction of main | |
| scanning stop 4 | |

TABLE 17
Incident surface of anamorphic collimator lens 3

| r | k | C2 | C4 | C6 | C8 | C10 |
|---|---|---|---|---|---|---|
| 0.00E+00 | 0.00E+00 | 0.00E+00 | 0.00E+00 | 0.00E+00 | 0.00E+00 | 0.00E+00 |

Exit surface of anamorphic collimator lens 3

| Ru | Ku | B2u | B4u | B6u | B8u | B10u |
|---|---|---|---|---|---|---|
| 1.08E+01 | 0.00E+00 | 0.00E+00 | −4.49E−05 | 0.00E+00 | 0.00E+00 | 0.00E+00 |
| Rl | Kl | B2l | B4l | B6l | B8l | B10l |
| 1.08E+01 | 0.00E+00 | 0.00E+00 | −4.49E−05 | 0.00E+00 | 0.00E+00 | 0.00E+00 |

| ru | E2u | E4u | E6u | E8u | E10u |
|---|---|---|---|---|---|
| 6.28E+00 | 0.00E+00 | 0.00E+00 | 0.00E+00 | 0.00E+00 | 0.00E+00 |
| rl | E2l | E4l | E6l | E8l | E10l |
| 6.28E+00 | 0.00E+00 | 0.00E+00 | 0.00E+00 | 0.00E+00 | 0.00E+00 |

| E1 | E3 | E5 |
|---|---|---|
| 0.00E+00 | 0.00E+00 | 0.00E+00 |

TABLE 18

Incident surface of scanning imaging lens 6

| Ru | Ku | B2u | B4u | B6u | B8u | B10u |
|---|---|---|---|---|---|---|
| 1.20E+02 | 6.13E+00 | 0.00E+00 | −5.36E−06 | 2.57E−09 | −6.31E−13 | 0.00E+00 |
| Rl | Kl | B2l | B4l | B6l | B8l | B10l |
| 1.20E+02 | 6.13E+00 | 0.00E+00 | −5.36E−06 | 2.57E−09 | −6.31E−13 | 0.00E+00 |

| ru | E2u | E4u | E6u | E8u | E10u |
|---|---|---|---|---|---|
| −2.86E+01 | 6.03E−05 | −4.37E−08 | −1.48E−11 | 2.74E−15 | 0.00E+00 |
| rl | E2l | E4l | E6l | E8l | E10l |
| −2.86E+01 | 6.03E−05 | −4.37E−08 | −1.48E−11 | 2.74E−15 | 0.00E+00 |

| E1 | E3 | E5 |
|---|---|---|
| 0.00E+00 | 0.00E+00 | 0.00E+00 |

Exit surface of scanning imaging lens 6

| Ru | Ku | B2u | B4u | B6u | B8u | B10u |
|---|---|---|---|---|---|---|
| −1.43E+02 | 6.90E−01 | 0.00E+00 | −2.05E−06 | −6.65E−10 | 5.89E−13 | 0.00E+00 |
| Rl | Kl | B2l | B4l | B6l | B8l | B10l |
| −1.43E+02 | 6.90E−01 | 0.00E+00 | −2.05E−06 | −6.65E−10 | 5.89E−13 | 0.00E+00 |

| ru | E2u | E4u | E6u | E8u | E10u |
|---|---|---|---|---|---|
| −1.09E+01 | 3.14E−05 | −2.36E−08 | 2.46E−11 | −3.41E−14 | 0.00E+00 |
| rl | E2l | E4l | E6l | E8l | E10l |
| −1.09E+01 | 3.88E−05 | −4.17E−08 | 4.63E−11 | −4.34E−14 | 0.00E+00 |

| E1 | E3 | E5 |
|---|---|---|
| 0.00E+00 | 0.00E+00 | 0.00E+00 |

TABLE 19

| | Surface | | | | | | | | |
|---|---|---|---|---|---|---|---|---|---|
| | number | R | N | x | y | z | gx(x) | gx(y) | gx(z) |
| Light source 1 | 1 to 6 | Common | Common | Common | Common | Common | Common | Common | Common |
| to main | | | | | | | | | |
| scanning stop 4 | | | | | | | | | |
| Deflecting | 7 | 0.000 | 1.0000 | −4.393 | 2.654 | 0.000 | 0.186 | 0.983 | 0.000 |
| surface 51 of | | | | | | | | | |
| polygon mirror | | | | | | | | | |
| 5 | | | | | | | | | |
| Incident surface | 8 | 12.100 | 1.5287 | 10.206 | 27.865 | 0.000 | 0.365 | 0.931 | 0.000 |
| of | | | | | | | | | |
| synchronization | | | | | | | | | |
| detection | | | | | | | | | |
| imaging | | | | | | | | | |
| element 81 | | | | | | | | | |
| Exit surface of | 9 | 0.000 | 1.0000 | 10.935 | 29.727 | 0.000 | 0.365 | 0.931 | 0.000 |
| synchronization | | | | | | | | | |
| detection | | | | | | | | | |
| imaging | | | | | | | | | |
| element 81 | | | | | | | | | |
| Synchronization | 10 | 0.000 | 1.0000 | 18.882 | 50.006 | 0.000 | — | — | — |
| detection light | | | | | | | | | |
| receiving | | | | | | | | | |
| element 80 | | | | | | | | | |

TABLE 20

| | |
|---|---|
| Diameter φ [mm] of circumscribed circle in main scanning cross section of | 20 |
| polygon mirror 5 | |
| Number N of deflecting surface 51 of polygon mirror 5 | 4 |
| Width in main scanning cross section of deflecting surface 51 of polygon | 14.142 |
| mirror 5 [mm] | |
| Diameter φin [mm] of inscribed circle in main scanning cross section of | 14.142 |
| polygon mirror 5 | |
| Distance φin/2 between center of polygon mirror 5 and end in main scanning | 7.071 |
| direction of deflecting surface 51 | |
| Coordinate in X direction of rotation center of polygon mirror 5 | −5.706 |
| Coordinate in Y direction of rotation center of polygon mirror 5 | −4.294 |

As shown in FIG. 5B, in the light scanning apparatus 300 according to the present embodiment, Inequalities (1) and (1′) are satisfied.

Further, as shown in FIG. 5B, any light flux for scanning each image height on the surface to be scanned 7 has the light flux width of 90% or more of the width Wᵢ of the incident light flux Lᵢ in the light scanning apparatus 300 according to the present embodiment.

Furthermore, as shown in Table 15, angles of the light flux for scanning the image height 72 are +47.2° and −47.2°, respectively.

The light scanning apparatus according to the comparative example has the same structure as that of the light scanning apparatus 300 according to the present embodiment except that the light scanning apparatus according to the comparative example uses the polygon mirror 5 with four surfaces in which the number of deflecting surfaces 51 is smaller by one than that of the light scanning apparatus 300 according to the present embodiment. Therefore, the same members are denoted by the same reference numerals, and description thereof is omitted.

Next, the value of each Inequality in the light scanning apparatus 300 according to the present embodiment and the light scanning apparatus according to the comparative example is shown in the following Table 21.

TABLE 21

| | Third | Comparative |
|---|---|---|
| | embodiment | example |
| Inequalities | | |
| Inequality (2): 5.50 ≤ φ − K × N × (N − 1) ≤ 13.00 (K = 0.52) | 7.08 | 13.76 |
| Inequality (2): 5.50 ≤ φ − K × N × (N − 1) ≤ 13.00 (K = 0.54) | 6.68 | 13.52 |
| Inequality (2): 5.50 ≤ φ − K × N × (N − 1) ≤ 13.00 (K = 0.56) | 6.28 | 13.28 |
| Inequality (3): 6.00 < (φ + 15)/N < 7.40 | 6.50 | 8.75 |
| Inequality (3a): 6.20 < (φ + 15)/N < 7.20 | | |
| Inequality (4): 22.60 < Ymax+/(φ/N) < 37.00 | 30.61 | 21.40 |
| Inequality (4a): 27.00 < Ymax+/(φ/N) < 34.00 | | |
| Inequality (5): 1.78 < (θi + θmax+)/θBD < 2.33 | 2.00 | 2.00 |
| Inequality (6): 0.23 < (θBD − θmax+)/(360/N) < 0.35 | 0.30 | 0.24 |
| With respect to Inequality (1): WBD < Wmax− < Wmax+ | | |
| and Inequality (1′): Wmax+ = Wi | | |
| Width Wi of incident light flux Li | 2.12 | 2.12 |
| Width WBD of synchronization detection light flux | 1.71 | 2.12 |
| Width Wmax+ of light flux traveling to positive-side | 2.12 | 2.12 |
| outermost off-axis image height 71 | | |
| Width Wcenter of light flux traveling to on-axis image | 2.12 | 2.12 |
| height 70 | | |
| Width Wmax− of light flux traveling to negative-side | 2.06 | 2.12 |
| outermost off-axis image height 72 | | |
| Angle θBD [°] of scanning light flux LBD | 68.6 | 68.6 |
| Angle θBD − 360/N × 2 [°] of scanning light flux LBD2 | −75.4 | x |
| Angle θmax+ [°] of scanning light flux Lmax+ | 47.2 | 47.2 |
| Angle θmax− [°] of scanning light flux Lmax− | −47.2 | −47.2 |
| Angle θmax− + 360/N × 2 [°] of scanning light flux Lmax− | 96.8 | x |
| 2 | | |

As shown in Tables 15 and 20, the width in the main scanning cross section of the deflecting surface 51 of the polygon mirror 5 is considerably larger in the light scanning apparatus according to the comparative example than in the light scanning apparatus 300 according to the present embodiment.

Therefore, as shown in Table 21, the width W_{BD} of the synchronization detection light flux and the width Wₘₐₓ₋ of the scanning light flux Lₘₐₓ₋ traveling to the negative side outermost off-axis image height 72 are the same as the width Wᵢ of the incident light flux Lᵢ, namely are not reduced in the light scanning apparatus according to the comparative example.

On the other hand, a diameter of the circumscribed circle as an outer shape of the polygon mirror 5 is smaller in the light scanning apparatus 300 according to the present embodiment than in the light scanning apparatus according to the comparative example.

That is, downsizing of the polygon mirror 5 is achieved in the light scanning apparatus 300 according to the present embodiment, so that it is possible to downsize the light scanning apparatus 300 according to the present embodiment and the image forming apparatus in which the light scanning apparatus 300 is mounted.

Further, since the polygon mirror 5 can be reduced in size, the polygon motor for rotationally driving the polygon mirror 5 can also be reduced in size.

This is because a rotational moment of the polygon mirror 5 increases as the size in the main scanning cross section of the polygon mirror 5 increases.

Furthermore, it is also possible to reduce a power consumption of the polygon motor along with the downsizing of the polygon motor due to the downsizing of the polygon mirror 5.

In addition, when the diameter of the circumscribed circle of the polygon mirror 5 decreases, a wind noise generated from the polygon mirror 5 decreases, so that a structure for shielding the wind noise can be simplified and downsized.

As described above, the light scanning apparatus 300 according to the present embodiment can be reduced in size.

As shown in Table 21, both of Inequality (2) in the case where K is a constant of 0.52 or more and 0.56 or less and Inequality (2) in the case where K is a constant of 0.53 or more and 0.55 or less are satisfied in the light scanning apparatus 300 according to the present embodiment.

On the other hand, in the light scanning apparatus according to the comparative example, any of Inequality (2) in the case where K is a constant of 0.52 or more and 0.56 or less and Inequality (2) in the case where K is a constant of 0.53 or more and 0.55 or less is not satisfied.

Further, Inequalities (3), (3a), (4) and (4a) are satisfied in the light scanning apparatus 300 according to the present embodiment, but are not satisfied in the light scanning apparatus according to the comparative example.

Inequalities (5) and (6) are satisfied in the light scanning apparatus 300 according to the present embodiment.

Inequality (1) is satisfied in the light scanning apparatus 300 according to the present embodiment, but is not satisfied in the light scanning apparatus according to the comparative example.

Inequality (1′) is satisfied in the light scanning apparatus 300 according to the present embodiment.

As described above, the size of the light scanning apparatus 300 according to the present embodiment can be reduced by satisfying each Inequality.

Further, as shown in Table 21, any of the angle (θ_{BD}−360/N×2) of the scanning light flux L_{BD2} and the angle (θₘₐₓ₋+360/N×2) of the scanning light flux Lₘₐₓ₋₂ is not within a range between the angle θₘₐₓ₊ and the angle θₘₐₓ₋ in the light scanning apparatus 300 according to the present embodiment.

Therefore, in the light scanning apparatus 300 according to the present embodiment, both of the scanning light flux L_{BD2} and the scanning light flux Lₘₐₓ₋₂ can be shielded by a member such as a housing, a rib other than the optical surface of the scanning imaging lens 6, or the like.

Even if the scanning light flux L_{BD2} or the scanning light flux Lₘₐₓ₋₂ is incident on the scanning imaging lens 6, the scanning light flux L_{BD2} or the scanning light flux Lₘₐₓ₋₂ does not reach the printed area of the surface to be scanned 7, so that there is no problem in printing.

As described above, in the light scanning apparatus 300 according to the present embodiment, it is possible to reduce the size of the polygon mirror 5, to reduce the size of the polygon motor by reducing the weight of the polygon mirror 5, and to simplify a soundproof member, compared to the light scanning apparatus according to the comparative example and a light scanning apparatus of the related art.

Thereby, the size of the light scanning apparatus 300 according to the present embodiment can be reduced, so that it is possible to provide a compact light scanning apparatus suitable for high-quality image recording and an image forming apparatus equipped with the light scanning apparatus.

### Fourth Embodiment

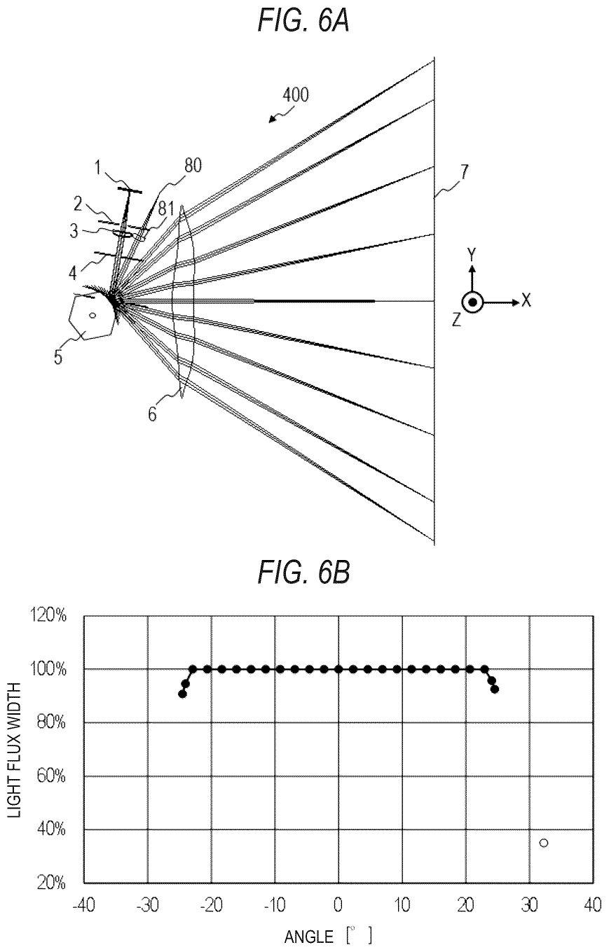

FIG. 6A shows a schematic main scanning cross sectional view of a light scanning apparatus 400 according to a fourth embodiment of the present invention. In FIG. 6A, the electrical mounting substrate 83 is not shown.

Further, FIG. 6B shows an angle dependence of a light flux width in the main scanning cross section of a light flux deflected by a polygon mirror 5 in the light scanning apparatus 400 according to the fourth embodiment (corresponding to FIG. 3).

Specifically, an angle on a horizontal axis of FIG. 6B is a rotation angle (θₘₐₓ₋/2 to θₘₐₓ₊/2) of a deflecting surface 51 of the polygon mirror 5.

The light scanning apparatus 400 according to the present embodiment has the same structure as the light scanning apparatus 100 according to the first embodiment except that each numerical value is different, so that the same members are denoted by the same reference numerals and the description thereof is omitted.

Main specification values of the light scanning apparatus 400 according to the present embodiment, and the arrangement of each optical element provided in the incident optical system 75 and the imaging optical system 85 are shown in the following Tables 22 and 23, respectively.

An aspherical shape of the anamorphic collimator lens 3 and an aspherical shape of the scanning imaging lens 6 provided in the light scanning apparatus 400 according to the present embodiment are shown in the following Tables 24 and 25, respectively.

An arrangement of each optical element provided in the synchronization detection optical system of the light scanning apparatus 400 according to the present embodiment is shown in the following Table 26.

Main specification values of the light scanning apparatus according to the comparative example is shown in the following Table 27.

TABLE 22

| | |
|---|---|
| Wavelength of light source 1 [nm] | 790 |
| Angle θi [°] between optical axis of imaging optical system 85 and optical | 80.0 |
| axis of incident optical system 75 | |
| Diameter φ [mm] of circumscribed circle in main scanning cross section of | 23.354 |
| polygon mirror 5 | |
| Number N of deflecting surface 51 of polygon mirror 5 | 6 |
| Width in main scanning cross section of deflecting surface 51 of polygon | 11.677 |
| mirror 5 [mm] | |
| Diameter φin [mm] of inscribed circle in main scanning cross section of | 20.225 |
| polygon mirror 5 | |
| Distance φin/2 between center of polygon mirror 5 and end in main scanning | 10.113 |
| direction of deflecting surface 51 | |
| Coordinate in X direction of rotation center of polygon mirror 5 | −8.549 |
| Coordinate in Y direction of rotation center of polygon mirror 5 | −5.544 |
| Fθ coefficient | 125.0 |
| Coordinate Ymax+ in Y direction of positive-side outermost off-axis image | 107.0 |
| height 71 | |
| Coordinate Ymax− in Y direction of negative-side outermost off-axis image | −107.0 |
| height 72 | |
| Printed width Ywidth = (Ymax+) − (Ymax−) on surface to be scanned 7 | 214.0 |
| Maximum angle of view θmax+ [°] corresponding to positive-side outermost | 49.0 |
| off-axis image height 71 | |
| Maximum angle of view θmax− [°] corresponding to negative-side outermost | −49.0 |
| off-axis image height 72 | |
| Angle of view θBD [°] of synchronization detection light flux | 64.5 |

TABLE 23

| | Surface | | | | | | | | |
|---|---|---|---|---|---|---|---|---|---|
| | number | R | N | x | y | z | gx(x) | gx(y) | gx(z) |
| Light emitting point of | 1 | 0.000 | −1.511 | 8.682 | 49.240 | 0.000 | 0.174 | 0.985 | 0.000 |
| light source 1 | | | | | | | | | |
| | 2 | 0.000 | −1.000 | 8.639 | 48.994 | 0.000 | 0.174 | 0.985 | 0.000 |
| Sub-scanning stop 2 | 3 | 0.000 | −1.000 | 5.904 | 33.483 | 0.000 | 0.174 | 0.985 | 0.000 |
| Incident surface of | 4 | aspherical | −1.529 | 5.383 | 30.529 | 0.000 | 0.174 | 0.985 | 0.000 |
| anamorphic collimator | | | | | | | | | |
| lens 3 | | | | | | | | | |
| Exit surface of anamorphic | 5 | aspherical | −1.000 | 5.036 | 28.559 | 0.000 | 0.174 | 0.985 | 0.000 |
| collimator lens 3 | | | | | | | | | |
| Main scanning stop 4 | 6 | 0.000 | 1.000 | 3.473 | 19.696 | 0.000 | 0.174 | 0.985 | 0.000 |
| Deflecting surface 51 of | 7 | 0.000 | 1.000 | 0.849 | −1.811 | 0.000 | 0.929 | 0.369 | 0.000 |
| polygon mirror 5 | | | | | | | | | |
| Incident surface of | 8 | aspherical | 1.529 | 27.500 | 0.000 | 0.000 | 1.000 | 0.000 | 0.000 |
| scanning imaging lens 6 | | | | | | | | | |
| Exit surface of scanning | 9 | aspherical | 1.000 | 37.100 | 0.000 | 0.000 | 1.000 | 0.000 | 0.000 |
| imaging lens 6 | | | | | | | | | |
| Surface to be scanned 7 | 12 | 0.000 | 1.000 | 144.700 | 0.000 | 0.000 | 1.000 | 0.000 | 0.000 |

| | |
|---|---|
| Aperture width in sub- | 0.860 |
| scanning direction of sub- | |
| scanning stop 2 | |
| Aperture width in main | 2.140 |
| scanning direction of main | |
| scanning stop 4 | |

TABLE 24
Incident surface of anamorphic collimator lens 3

| r | k | C2 | C4 | C6 | C8 | C10 |
|---|---|---|---|---|---|---|
| 0.00E+00 | 0.00E+00 | 0.00E+00 | 0.00E+00 | 0.00E+00 | 0.00E+00 | 0.00E+00 |

Exit surface of anamorphic collimator lens 3

| Ru | Ku | B2u | B4u | B6u | B8u | B10u |
|---|---|---|---|---|---|---|
| 1.02E+01 | 0.00E+00 | 0.00E+00 | −5.53E−05 | 0.00E+00 | 0.00E+00 | 0.00E+00 |
| Rl | Kl | B2l | B4l | B6l | B8l | B10l |
| 1.02E+01 | 0.00E+00 | 0.00E+00 | −5.53E−05 | 0.00E+00 | 0.00E+00 | 0.00E+00 |

| ru | E2u | E4u | E6u | E8u | E10u |
|---|---|---|---|---|---|
| 6.24E+00 | 0.00E+00 | 0.00E+00 | 0.00E+00 | 0.00E+00 | 0.00E+00 |
| rl | E2l | E4l | E6l | E8l | E10l |
| 6.24E+00 | 0.00E+00 | 0.00E+00 | 0.00E+00 | 0.00E+00 | 0.00E+00 |

| E1 | E3 | E5 |
|---|---|---|
| 0.00E+00 | 0.00E+00 | 0.00E+00 |

TABLE 25
Incident surface of scanning imaging lens 6

| Ru | Ku | B2u | B4u | B6u | B8u | B10u |
|---|---|---|---|---|---|---|
| 6.48E+01 | 8.41E−01 | 0.00E+00 | −8.86E−06 | 3.93E−09 | −8.67E−13 | 0.00E+00 |
| Rl | Kl | B2l | B4l | B6l | B8l | B10l |
| 6.48E+01 | 8.41E−01 | 0.00E+00 | −8.86E−06 | 3.93E−09 | −8.67E−13 | 0.00E+00 |

| ru | E2u | E4u | E6u | E8u | E10u |
|---|---|---|---|---|---|
| −2.68E+01 | 8.97E−05 | −4.37E−08 | 4.79E−12 | −1.88E−15 | 0.00E+00 |
| rl | E2l | E4l | E6l | E8l | E10l |
| −2.68E+01 | 8.97E−05 | −4.37E−08 | 4.79E−12 | −1.88E−15 | 0.00E+00 |

| E1 | E3 | E5 |
|---|---|---|
| 0.00E+00 | 0.00E+00 | 0.00E+00 |

Exit surface of scanning imaging lens 6

| Ru | Ku | B2u | B4u | B6u | B8u | B10u |
|---|---|---|---|---|---|---|
| 2.21E+02 | −8.62E−01 | 0.00E+00 | −4.86E−06 | 5.75E−10 | 3.18E−13 | 0.00E+00 |
| Rl | Kl | B2l | B4l | B6l | B8l | B10l |
| 2.21E+02 | −8.62E−01 | 0.00E+00 | −4.86E−06 | 5.75E−10 | 3.18E−13 | 0.00E+00 |

| ru | E2u | E4u | E6u | E8u | E10u |
|---|---|---|---|---|---|
| −1.05E+01 | 6.99E−05 | −4.88E−08 | 4.42E−11 | −1.86E−14 | 0.00E+00 |
| rl | E2l | E4l | E6l | E8l | E10l |
| −1.05E+01 | 7.85E−05 | −6.79E−08 | 6.41E−11 | −2.56E−14 | 0.00E+00 |

| E1 | E3 | E5 |
|---|---|---|
| 0.00E+00 | 0.00E+00 | 0.00E+00 |

TABLE 26

| | Surface | | | | | | | | |
|---|---|---|---|---|---|---|---|---|---|
| | number | R | N | x | y | z | gx(x) | gx(y) | gx(z) |
| Light source 1 | 1 to 6 | Common | Common | Common | Common | Common | Common | Common | Common |
| to main | | | | | | | | | |
| scanning stop 4 | | | | | | | | | |
| Deflecting | 7 | 0.000 | 1.0000 | −5.466 | 4.087 | 0.000 | 0.305 | 0.952 | 0.000 |
| surface 51 of | | | | | | | | | |
| polygon mirror | | | | | | | | | |
| 5 | | | | | | | | | |
| Incident surface | 8 | 12.100 | 1.5287 | 12.173 | 26.916 | 0.000 | 0.431 | 0.903 | 0.000 |
| of | | | | | | | | | |
| synchronization | | | | | | | | | |
| detection | | | | | | | | | |
| imaging | | | | | | | | | |
| element 81 | | | | | | | | | |
| Exit surface of | 9 | 0.000 | 1.0000 | 13.034 | 28.721 | 0.000 | 0.431 | 0.903 | 0.000 |
| synchronization | | | | | | | | | |
| detection | | | | | | | | | |
| imaging | | | | | | | | | |
| element 81 | | | | | | | | | |
| Synchronization | 10 | 0.000 | 1.0000 | 21.752 | 46.999 | 0.000 | — | — | — |
| detection light | | | | | | | | | |
| receiving | | | | | | | | | |
| element 80 | | | | | | | | | |

TABLE 27

| | |
|---|---|
| Diameter φ [mm] of circumscribed circle in main scanning cross section of | 25 |
| polygon mirror 5 | |
| Number N of deflecting surface 51 of polygon mirror 5 | 5 |
| Width in main scanning cross section of deflecting surface 51 of polygon | 14.695 |
| mirror 5 [mm] | |
| Diameter φin [mm] of inscribed circle in main scanning cross section of | 20.225 |
| polygon mirror 5 | |
| Distance φin/2 between center of polygon mirror 5 and end in main scanning | 10.113 |
| direction of deflecting surface 51 | |
| Coordinate in X direction of rotation center of polygon mirror 5 | −8.549 |
| Coordinate in Y direction of rotation center of polygon mirror 5 | −5.544 |

As shown in FIG. 6B, in the light scanning apparatus 400 according to the present embodiment, Inequality (1) is satisfied.

Further, as shown in FIG. 6B, any light flux for scanning each image height on the surface to be scanned 7 has the light flux width of 90% or more of the width Wᵢ of the incident light flux Lᵢ in the light scanning apparatus 400 according to the present embodiment.

Furthermore, as shown in Table 22, angles of the light flux for scanning the image height 72 are +49.0° and −49.0°, respectively.

The light scanning apparatus according to the comparative example has the same structure as that of the light scanning apparatus 400 according to the present embodiment except that the light scanning apparatus according to the comparative example uses the polygon mirror 5 with five surfaces in which the number of deflecting surfaces 51 is smaller by one than that of the light scanning apparatus 400 according to the present embodiment. Therefore, the same members are denoted by the same reference numerals, and description thereof is omitted.

Next, the value of each Inequality in the light scanning apparatus 400 according to the present embodiment and the light scanning apparatus according to the comparative example is shown in the following Table 28.

TABLE 28

| | Fourth | Comparative |
|---|---|---|
| | embodiment | example |
| Inequalities | | |
| Inequality (2): 5.50 ≤ φ − K × N × (N − 1) ≤ 13.00 (K = 0.52) | 7.75 | 14.6 |
| Inequality (2): 5.50 ≤ φ − K × N × (N − 1) ≤ 13.00 (K = 0.54) | 7.15 | 14.20 |
| Inequality (2): 5.50 ≤ φ − K × N × (N − 1) ≤ 13.00 (K = 0.56) | 6.55 | 13.8 |
| Inequality (3): 6.00 < (φ + 15)/N < 7.40 | 6.39 | 8.00 |
| Inequality (3a): 6.20 < (φ + 15)/N < 7.20 | | |
| Inequality (4): 22.60 < Ymax+/(φ/N) < 37.00 | 27.49 | 21.40 |
| Inequality (4a): 27.00 < Ymax+/(φ/N) < 34.00 | | |
| Inequality (5): 1.78 < (θi + θmax+)/θBD < 2.33 | 2.00 | 2.00 |
| Inequality (6): 0.23 < (θBD − θmax+)/(360/N) < 0.35 | 0.26 | 0.21 |
| With respect to Inequality (1): WBD < Wmax− < Wmax+ | | |
| and Inequality (1′): Wmax+ = Wi | | |
| Width Wi of incident light flux Li | 2.04 | 2.04 |
| Width WBD of synchronization detection light flux | 0.71 | 2.04 |
| Width Wmax+ of light flux traveling to positive-side | 1.89 | 2.04 |
| outermost off-axis image height 71 | | |
| Width Wcenter of light flux traveling to on-axis image | 2.04 | 2.04 |
| height 70 | | |
| Width Wmax− of light flux traveling to negative-side | 1.85 | 2.04 |
| outermost off-axis image height 72 | | |
| Angle θBD [°] of scanning light flux LBD | 64.5 | 64.5 |
| Angle θBD − 360/N × 2 [°] of scanning light flux LBD2 | −55.5 | x |
| Angle θmax+ [°] of scanning light flux Lmax+ | 49.0 | 49.0 |
| Angle θmax+ − 360/N × 2 of scanning light flux Lmax+ 2 | −71.0 | x |
| Angle θmax− [°] of scanning light flux Lmax− | −49.0 | −49.0 |
| Angle θmax− + 360/N × 2 [°] of scanning light flux Lmax− | 71.0 | x |
| 2 | | |

As shown in Tables 22 and 27, the width in the main scanning cross section of the deflecting surface 51 of the polygon mirror 5 is considerably larger in the light scanning apparatus according to the comparative example than in the light scanning apparatus 400 according to the present embodiment.

Therefore, as shown in Table 28, the width W_{BD} of the synchronization detection light flux is the same as the width Wᵢ of the incident light flux Lᵢ, namely is not reduced in the light scanning apparatus according to the comparative example.

Further, as shown in Table 28, the width Wₘₐₓ₊ of the scanning light flux Lₘₐₓ₊ traveling to the positive side outermost off-axis image height 71 and the width Wₘₐₓ₋ of the scanning light flux Lₘₐₓ₋ traveling to the negative side outermost off-axis image height 72 are the same as the width Wᵢ of the incident light flux Lᵢ in the light scanning apparatus according to the comparative example.

On the other hand, a diameter of the circumscribed circle as an outer shape of the polygon mirror 5 is smaller in the light scanning apparatus 400 according to the present embodiment than in the light scanning apparatus according to the comparative example.

That is, downsizing of the polygon mirror 5 is achieved in the light scanning apparatus 400 according to the present embodiment, so that it is possible to downsize the light scanning apparatus 400 according to the present embodiment and the image forming apparatus in which the light scanning apparatus 400 is mounted.

Further, since the polygon mirror 5 can be reduced in size, the polygon motor for rotationally driving the polygon mirror 5 can also be reduced in size.

This is because a rotational moment of the polygon mirror 5 increases as the size in the main scanning cross section of the polygon mirror 5 increases.

Furthermore, it is also possible to reduce a power consumption of the polygon motor along with the downsizing of the polygon motor due to the downsizing of the polygon mirror 5.

In addition, when the diameter of the circumscribed circle of the polygon mirror 5 decreases, a wind noise generated from the polygon mirror 5 decreases, so that a structure for shielding the wind noise can be simplified and downsized.

As described above, the light scanning apparatus 400 according to the present embodiment can be reduced in size.

As shown in Table 28, both of Inequality (2) in the case where K is a constant of 0.52 or more and 0.56 or less and Inequality (2) in the case where K is a constant of 0.53 or more and 0.55 or less are satisfied in the light scanning apparatus 400 according to the present embodiment.

On the other hand, in the light scanning apparatus according to the comparative example, any of Inequality (2) in the case where K is a constant of 0.52 or more and 0.56 or less and Inequality (2) in the case where K is a constant of 0.53 or more and 0.55 or less is not satisfied.

Further, Inequalities (3), (3a), (4), (4a) and (6) are satisfied in the light scanning apparatus 400 according to the present embodiment, but are not satisfied in the light scanning apparatus according to the comparative example.

Inequality (5) is satisfied in the light scanning apparatus 400 according to the present embodiment.

Inequality (1) is satisfied in the light scanning apparatus 400 according to the present embodiment, but is not satisfied in the light scanning apparatus according to the comparative example.

As described above, the size of the light scanning apparatus 400 according to the present embodiment can be reduced by satisfying each Inequality.

Further, as shown in Table 28, any of the angle (θ_{BD}−360/N×2) of the scanning light flux L_{BD2} and the angle (θₘₐₓ₋+360/N×2) of the scanning light flux Lₘₐₓ₋₂ is not within a range between the angle θₘₐₓ₊ and the angle θₘₐₓ₋ in the light scanning apparatus 400 according to the present embodiment.

Furthermore, as shown in Table 28, the angle (θₘₐₓ₊−360/N×2) of the scanning light flux Lₘₐₓ₊₂ is not within a range between the angle θₘₐₓ₊ and the angle θₘₐₓ₋ in the light scanning apparatus 400 according to the present embodiment.

The scanning light flux Lₘₐₓ₊₂ is a light flux generated by deflecting the rest of the incident light flux Lᵢ by a deflecting surface adjacent to a predetermined deflecting surface that deflects a part of the incident light flux Lᵢ as the scanning light flux Lₘₐₓ₊ when scanning the positive side outermost off-axis image height 71 on the surface to be scanned 7.

Therefore, in the light scanning apparatus 400 according to the present embodiment, any of the scanning light flux L_{BD2}, the scanning light flux Lₘₐₓ₊₂ and the scanning light flux Lₘₐₓ₋₂ can be shielded by a member such as a housing, a rib other than the optical surface of the scanning imaging lens 6, or the like.

Even if the scanning light flux L_{BD2}, the scanning light flux Lₘₐₓ₊₂ or the scanning light flux Lₘₐₓ₋₂ is incident on the scanning imaging lens 6, the scanning light flux L_{BD2}, the scanning light flux Lₘₐₓ₊₂ or the scanning light flux Lₘₐₓ₋₂ does not reach the printed area of the surface to be scanned 7, so that there is no problem in printing.

As described above, in the light scanning apparatus 400 according to the present embodiment, it is possible to reduce the size of the polygon mirror 5, to reduce the size of the polygon motor by reducing the weight of the polygon mirror 5, and to simplify a soundproof member, compared to the light scanning apparatus according to the comparative example and a light scanning apparatus of the related art.

Thereby, the size of the light scanning apparatus 400 according to the present embodiment can be reduced, so that it is possible to provide a compact light scanning apparatus suitable for high-quality image recording and an image forming apparatus equipped with the light scanning apparatus.

### Fifth Embodiment

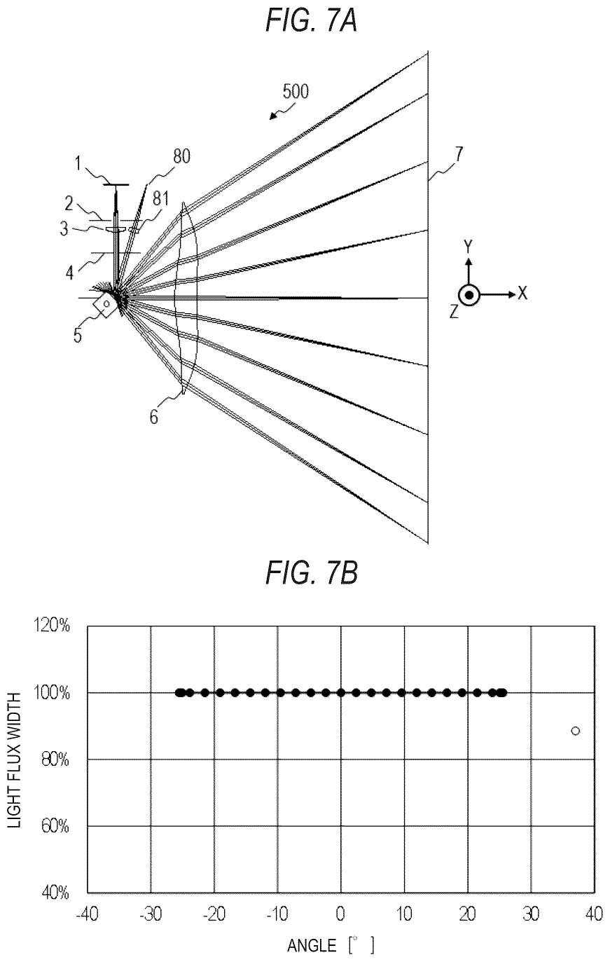

FIG. 7A shows a schematic main scanning cross sectional view of a light scanning apparatus 500 according to a fifth embodiment of the present invention. In FIG. 7A, the electrical mounting substrate 83 is not shown.

Further, FIG. 7B shows an angle dependence of a light flux width in the main scanning cross section of a light flux deflected by a polygon mirror 5 in the light scanning apparatus 500 according to the fifth embodiment (corresponding to FIG. 3).

Specifically, an angle on a horizontal axis of FIG. 7B is a rotation angle (θₘₐₓ₋/2 to θₘₐₓ₊/2) of a deflecting surface 51 of the polygon mirror 5.

The light scanning apparatus 500 according to the present embodiment has the same structure as the light scanning apparatus 100 according to the first embodiment except that each numerical value is different, so that the same members are denoted by the same reference numerals and the description thereof is omitted.

Main specification values of the light scanning apparatus 500 according to the present embodiment and the arrangement of each optical element provided in the incident optical system 75 and the imaging optical system 85 are shown in the following Tables 29 and 30, respectively.

An aspherical shape of the anamorphic collimator lens 3 and an aspherical shape of the scanning imaging lens 6 provided in the light scanning apparatus 500 according to the present embodiment are shown in the following Tables 31 and 32, respectively.

An arrangement of each optical element provided in the synchronization detection optical system of the light scanning apparatus 500 according to the present embodiment is shown in the following Table 33.

Main specification values of the light scanning apparatus according to the comparative example is shown in the following Table 34.

TABLE 29

| | |
|---|---|
| Wavelength of light source 1 [nm] | 790 |
| Angle θi [°] between optical axis of imaging optical system 85 and optical | 90.0 |
| axis of incident optical system 75 | |
| Diameter φ [mm] of circumscribed circle in main scanning cross section of | 12.869 |
| polygon mirror 5 | |
| Number N of deflecting surface 51 of polygon mirror 5 | 4 |
| Width in main scanning cross section of deflecting surface 51 of polygon | 9.100 |
| mirror 5 [mm] | |
| Diameter φin [mm] of inscribed circle in main scanning cross section of | 9.100 |
| polygon mirror 5 | |
| Distance φin/2 between center of polygon mirror 5 and end in main scanning | 4.550 |
| direction of deflecting surface 51 | |
| Coordinate in X direction of rotation center of polygon mirror 5 | −4.384 |
| Coordinate in Y direction of rotation center of polygon mirror 5 | −2.051 |
| Fθ coefficient | 120.0 |
| Coordinate Ymax+ in Y direction of positive-side outermost off-axis image | 107.0 |
| height 71 | |
| Coordinate Ymax− in Y direction of negative-side outermost off-axis image | −107.0 |
| height 72 | |
| Printed width Ywidth = (Ymax+) − (Ymax−) on surface to be scanned 7 | 214.0 |
| Maximum angle of view θmax+ [°] corresponding to positive-side outermost | 51.1 |
| off-axis image height 71 | |
| Maximum angle of view θmax− [°] corresponding to negative-side outermost | −51.1 |
| off-axis image height 72 | |
| Angle of view θBD [°] of synchronization detection light flux | 74.0 |

TABLE 30

| | Surface | | | | | | | | |
|---|---|---|---|---|---|---|---|---|---|
| | number | R | N | x | y | z | gx(x) | gx(y) | gx(z) |
| Light emitting point of light | 1 | 0.000 | −1.511 | 0.000 | 50.000 | 0.000 | 0.000 | 1.000 | 0.000 |
| source 1 | | | | | | | | | |
| | 2 | 0.000 | −1.000 | 0.000 | 49.750 | 0.000 | 0.000 | 1.000 | 0.000 |
| Sub-scanning stop 2 | 3 | 0.000 | −1.000 | 0.000 | 34.000 | 0.000 | 0.000 | 1.000 | 0.000 |
| Incident surface of | 4 | aspherical | −1.529 | 0.000 | 31.000 | 0.000 | 0.000 | 1.000 | 0.000 |
| anamorphic collimator lens 3 | | | | | | | | | |
| Exit surface of anamorphic | 5 | aspherical | −1.000 | 0.000 | 29.000 | 0.000 | 0.000 | 1.000 | 0.000 |
| collimator lens 3 | | | | | | | | | |
| Main scanning stop 4 | 6 | 0.000 | 1.000 | 0.000 | 20.000 | 0.000 | 0.000 | 1.000 | 0.000 |
| Deflecting surface 51 of | 7 | 0.000 | 1.000 | −0.291 | −0.064 | 0.000 | 0.900 | 0.437 | 0.000 |
| polygon mirror 5 | | | | | | | | | |
| Incident surface of scanning | 8 | aspherical | 1.529 | 26.000 | 0.000 | 0.000 | 1.000 | 0.000 | 0.000 |
| imaging lens 6 | | | | | | | | | |
| Exit surface of scanning | 9 | aspherical | 1.000 | 35.800 | 0.000 | 0.000 | 1.000 | 0.000 | 0.000 |
| imaging lens 6 | | | | | | | | | |
| Surface to be scanned 7 | 12 | 0.000 | 1.000 | 137.800 | 0.000 | 0.000 | 1.000 | 0.000 | 0.000 |

| | |
|---|---|
| Aperture width in sub- | 0.840 |
| scanning direction of sub- | |
| scanning stop 2 | |
| Aperture width in main | 2.060 |
| scanning direction of main | |
| scanning stop 4 | |

TABLE 31
Incident surface of anamorphic collimator lens 3

| r | k | C2 | C4 | C6 | C8 | C10 |
|---|---|---|---|---|---|---|
| 0.00E+00 | 0.00E+00 | 0.00E+00 | 0.00E+00 | 0.00E+00 | 0.00E+00 | 0.00E+00 |

Exit surface of anamorphic collimator lens 3

| Ru | Ku | B2u | B4u | B6u | B8u | B10u |
|---|---|---|---|---|---|---|
| 1.02E+01 | 0.00E+00 | 0.00E+00 | −4.35E−05 | 0.00E+00 | 0.00E+00 | 0.00E+00 |
| Rl | Kl | B2l | B4l | B6l | B8l | B10l |
| 1.02E+01 | 0.00E+00 | 0.00E+00 | −4.35E−05 | 0.00E+00 | 0.00E+00 | 0.00E+00 |

| ru | E2u | E4u | E6u | E8u | E10u |
|---|---|---|---|---|---|
| 6.25E+00 | 0.00E+00 | 0.00E+00 | 0.00E+00 | 0.00E+00 | 0.00E+00 |
| rl | E2l | E4l | E6l | E8l | E10l |
| 6.25E+00 | 0.00E+00 | 0.00E+00 | 0.00E+00 | 0.00E+00 | 0.00E+00 |

| E1 | E3 | E5 |
|---|---|---|
| 0.00E+00 | 0.00E+00 | 0.00E+00 |

TABLE 32
Incident surface of scanning imaging lens 6

| Ru | Ku | B2u | B4u | B6u | B8u | B10u |
|---|---|---|---|---|---|---|
| 6.36E+01 | 6.85E−01 | 0.00E+00 | −9.04E−06 | 3.86E−09 | −8.17E−13 | 0.00E+00 |
| Rl | Kl | B2l | B4l | B6l | B8l | B10l |
| 6.36E+01 | 6.85E−01 | 0.00E+00 | −9.04E−06 | 3.86E−09 | −8.17E−13 | 0.00E+00 |

| ru | E2u | E4u | E6u | E8u | E10u |
|---|---|---|---|---|---|
| −2.20E+01 | 1.01E−04 | −4.67E−08 | 9.34E−12 | −2.20E−15 | 0.00E+00 |
| rl | E2l | E4l | E6l | E8l | E10l |
| −2.20E+01 | 1.01E−04 | −4.67E−08 | 9.34E−12 | −2.20E−15 | 0.00E+00 |

| E1 | E3 | E5 |
|---|---|---|
| 0.00E+00 | 0.00E+00 | 0.00E+00 |

Exit surface of scanning imaging lens 6

| Ru | Ku | B2u | B4u | B6u | B8u | B10u |
|---|---|---|---|---|---|---|
| 2.10E+02 | −5.97E+00 | 0.00E+00 | −4.82E−06 | 3.66E−10 | 3.35E−13 | 0.00E+00 |
| Rl | Kl | B2l | B4l | B6l | B8l | B10l |
| 2.10E+02 | −5.97E+00 | 0.00E+00 | −4.82E−06 | 3.66E−10 | 3.35E−13 | 0.00E+00 |

| ru | E2u | E4u | E6u | E8u | E10u |
|---|---|---|---|---|---|
| −9.82E+00 | 7.49E−05 | −5.61E−08 | 5.25E−11 | −1.80E−14 | 0.00E+00 |
| rl | E2l | E4l | E6l | E8l | E10l |
| −9.82E+00 | 8.42E−05 | −7.57E−08 | 7.05E−11 | −2.37E−14 | 0.00E+00 |

| E1 | E3 | E5 |
|---|---|---|
| 0.00E+00 | 0.00E+00 | 0.00E+00 |

TABLE 33

| | Surface | | | | | | | | |
|---|---|---|---|---|---|---|---|---|---|
| | number | R | N | x | y | z | gx(x) | gx(y) | gx(z) |
| Light source 1 | 1 to 6 | Common | Common | Common | Common | Common | Common | Common | Common |
| to main | | | | | | | | | |
| scanning stop 4 | | | | | | | | | |
| Deflecting | 7 | 0.000 | 1.0000 | −3.750 | 2.455 | 0.000 | 0.139 | 0.990 | 0.000 |
| surface 51 of | | | | | | | | | |
| polygon mirror | | | | | | | | | |
| 5 | | | | | | | | | |
| Incident surface | 8 | 12.100 | 1.5287 | 7.690 | 28.747 | 0.000 | 0.276 | 0.961 | 0.000 |
| of | | | | | | | | | |
| synchronization | | | | | | | | | |
| detection | | | | | | | | | |
| imaging | | | | | | | | | |
| element 81 | | | | | | | | | |
| Exit surface of | 9 | 0.000 | 1.0000 | 8.242 | 30.669 | 0.000 | 0.276 | 0.961 | 0.000 |
| synchronization | | | | | | | | | |
| detection | | | | | | | | | |
| imaging | | | | | | | | | |
| element 81 | | | | | | | | | |
| Synchronization | 10 | 0.000 | 1.0000 | 13.790 | 50.019 | 0.000 | — | — | — |
| detection light | | | | | | | | | |
| receiving | | | | | | | | | |
| element 80 | | | | | | | | | |

TABLE 34

| | |
|---|---|
| Diameter φ [mm] of circumscribed circle in main scanning cross section of | 18.2 |
| polygon mirror 5 | |
| Number N of deflecting surface 51 of polygon mirror 5 | 3 |
| Width in main scanning cross section of deflecting surface 51 of polygon | 15.762 |
| mirror 5 [mm] | |
| Diameter φin [mm] of inscribed circle in main scanning cross section of | 9.100 |
| polygon mirror 5 | |
| Distance φin/2 between center of polygon mirror 5 and end in main scanning | 4.550 |
| direction of deflecting surface 51 | |
| Coordinate in X direction of rotation center of polygon mirror 5 | −4.384 |
| Coordinate in Y direction of rotation center of polygon mirror 5 | −2.051 |

As shown in Table 29, angles of the light flux for scanning the positive side outermost off-axis image height 71 and the negative side outermost off-axis image height 72 are +51.1° and −51.1°, respectively.

The light scanning apparatus according to the comparative example has the same structure as that of the light scanning apparatus 500 according to the present embodiment except that the light scanning apparatus according to the comparative example uses the polygon mirror 5 with three surfaces in which the number of deflecting surfaces 51 is smaller by one than that of the light scanning apparatus 500 according to the present embodiment. Therefore, the same members are denoted by the same reference numerals, and description thereof is omitted.

Next, the value of each Inequality in the light scanning apparatus 500 according to the present embodiment and the light scanning apparatus according to the comparative example is shown in the following Table 35.

TABLE 35

| | Fifth | Comparative |
|---|---|---|
| | embodiment | example |
| Inequalities | | |
| Inequality (2): 5.50 ≤ φ − K × N × (N − 1) ≤ 13.00 (K = 0.52) | 6.63 | 15.08 |
| Inequality (2): 5.50 ≤ φ − K × N × (N − 1) ≤ 13.00 (K = 0.54) | 6.39 | 14.96 |
| Inequality (2): 5.50 ≤ φ − K × N × (N − 1) ≤ 13.00 (K = 0.56) | 6.15 | 14.84 |
| Inequality (3): 6.00 < (φ + 15)/N < 7.40 | 6.97 | 11.07 |
| Inequality (3a): 6.20 < (φ + 15)/N < 7.20 | | |
| Inequality (4): 22.60 < Ymax+/(φ/N) < 37.00 | 33.26 | 17.64 |
| Inequality (4a): 27.00 < Ymax+/(φ/N) < 34.00 | | |
| Inequality (5): 1.78 < (θi + θmax+)/θBD < 2.33 | 1.91 | 1.91 |
| Inequality (6): 0.23 < (θBD − θmax+)/(360/N) < 0.35 | 0.25 | 0.19 |
| With respect to Inequality (1): WBD < Wmax− < Wmax+ | | |
| and Inequality (1′): Wmax+ = Wi | | |
| Width Wi of incident light flux Li | 1.95 | 1.95 |
| Width WBD of synchronization detection light flux | 1.73 | 1.95 |
| Width Wmax+ of light flux traveling to positive-side | 1.95 | 1.95 |
| outermost off-axis image height 71 | | |
| Width Wcenter of light flux traveling to on-axis image | 1.95 | 1.95 |
| height 70 | | |
| Width Wmax− of light flux traveling to negative-side | 1.95 | 1.95 |
| outermost off-axis image height 72 | | |
| Angle θBD [°] of scanning light flux LBD | 74.0 | 74.0 |
| Angle θBD − 360/N × 2 [°] of scanning light flux LBD2 | −90.0 | x |
| Angle θmax+ [°] of scanning light flux Lmax+ | 51.1 | 51.1 |
| Angle θmax− [°] of scanning light flux Lmax− | −51.1 | −51.1 |
| Angle θmax− + 360/N × 2 [°] of scanning light flux Lmax− | 128.9 | x |
| 2 | | |

As shown in Tables 29 and 34, the width in the main scanning cross section of the deflecting surface 51 of the polygon mirror 5 is considerably larger in the light scanning apparatus according to the comparative example than in the light scanning apparatus 500 according to the present embodiment.

Therefore, as shown in Table 35, the width W_{BD} of the synchronization detection light flux is the same as the width Wᵢ of the incident light flux Lᵢ, namely is not reduced in the light scanning apparatus according to the comparative example.

On the other hand, a diameter of the circumscribed circle as an outer shape of the polygon mirror 5 is smaller in the light scanning apparatus 500 according to the present embodiment than in the light scanning apparatus according to the comparative example.

That is, downsizing of the polygon mirror 5 is achieved in the light scanning apparatus 500 according to the present embodiment, so that it is possible to downsize the light scanning apparatus 500 according to the present embodiment and the image forming apparatus in which the light scanning apparatus 500 is mounted.

Further, since the polygon mirror 5 can be reduced in size, the polygon motor for rotationally driving the polygon mirror 5 can also be reduced in size.

This is because a rotational moment of the polygon mirror 5 increases as the size in the main scanning cross section of the polygon mirror 5 increases.

Furthermore, it is also possible to reduce a power consumption of the polygon motor along with the downsizing of the polygon motor due to the downsizing of the polygon mirror 5.

In addition, when the diameter of the circumscribed circle of the polygon mirror 5 decreases, a wind noise generated from the polygon mirror 5 decreases, so that a structure for shielding the wind noise can be simplified and downsized.

As described above, the light scanning apparatus 500 according to the present embodiment can be reduced in size.

As shown in Table 35, both of Inequality (2) in the case where K is a constant of 0.52 or more and 0.56 or less and Inequality (2) in the case where K is a constant of 0.53 or more and 0.55 or less are satisfied in the light scanning apparatus 500 according to the present embodiment.

On the other hand, in the light scanning apparatus according to the comparative example, any of Inequality (2) in the case where K is a constant of 0.52 or more and 0.56 or less and Inequality (2) in the case where K is a constant of 0.53 or more and 0.55 or less is not satisfied.

Further, Inequalities (3), (3a), (4), (4a) and (6) are satisfied in the light scanning apparatus 500 according to the present embodiment, but are not satisfied in the light scanning apparatus according to the comparative example.

Inequality (5) is satisfied in the light scanning apparatus 500 according to the present embodiment.

Inequality (1) is satisfied in the light scanning apparatus 500 according to the present embodiment, but is not satisfied in the light scanning apparatus according to the comparative example.

Inequality (1′) is satisfied in the light scanning apparatus 500 according to the present embodiment.

As described above, the size of the light scanning apparatus 500 according to the present embodiment can be reduced by satisfying each Inequality.

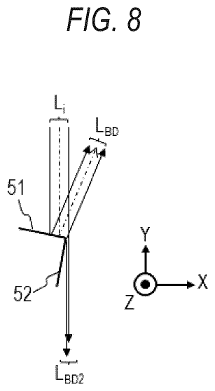

FIG. 8 shows a partially enlarged schematic main scanning cross sectional view in the vicinity of the polygon mirror 5 of the light scanning apparatus 500 according to the present embodiment.

As shown in Table 29, the polygon mirror 5 provided in the light scanning apparatus 500 according to the present embodiment has four deflecting surfaces 51, and the angle θᵢ formed by the optical axis of the incident optical system 75 with respect to the optical axis of the imaging optical system 85 is 90°.

As shown in FIG. 8, when the synchronization detection light receiving element 80 is scanned, a part of the incident light flux Lᵢ incident on the deflecting surface 51 of the polygon mirror 5 is deflected by the deflecting surface 51 so as to travel in a direction forming a predetermined angle with respect to the X axis as the scanning light flux L_{BD}.

On the other hand, the rest (another portion) of the incident light flux Lᵢ not deflected by the deflecting surface 51 when scanning the synchronization detection light receiving element 80 travels as a scanning light flux L_{BD2} without being deflected by any of the deflecting surfaces of the polygon mirror 5.

That is, the traveling direction of the scanning light flux L_{BD2} forms an angle of −90° with respect to the optical axis of the imaging optical system 85.

As shown in Table 35, any of the angle of −90° of the scanning light flux L_{BD2} and the angle (θₘₐₓ₋+360/N×2) of the scanning light flux Lₘₐₓ₋₂ is not within a range between the angle θₘₐₓ₊ and the angle θₘₐₓ₋ in the light scanning apparatus 500 according to the present embodiment.

Therefore, in the light scanning apparatus 500 according to the present embodiment, both of the scanning light flux L_{BD2} and the scanning light flux Lₘₐₓ₋₂ can be shielded by a member such as a housing, a rib other than the optical surface of the scanning imaging lens 6, or the like.

Even if the scanning light flux L_{BD2} or the scanning light flux Lₘₐₓ₋₂ is incident on the scanning imaging lens 6, the scanning light flux L_{BD2} or the scanning light flux Lₘₐₓ₋₂ does not reach the printed area of the surface to be scanned 7, so that there is no problem in printing.

As described above, in the light scanning apparatus 500 according to the present embodiment, it is possible to reduce the size of the polygon mirror 5, to reduce the size of the polygon motor by reducing the weight of the polygon mirror 5, and to simplify a soundproof member, compared to the light scanning apparatus according to the comparative example and a light scanning apparatus of the related art.

Thereby, the size of the light scanning apparatus 500 according to the present embodiment can be reduced, so that it is possible to provide a compact light scanning apparatus suitable for high-quality image recording and an image forming apparatus equipped with the light scanning apparatus.

### Sixth Embodiment

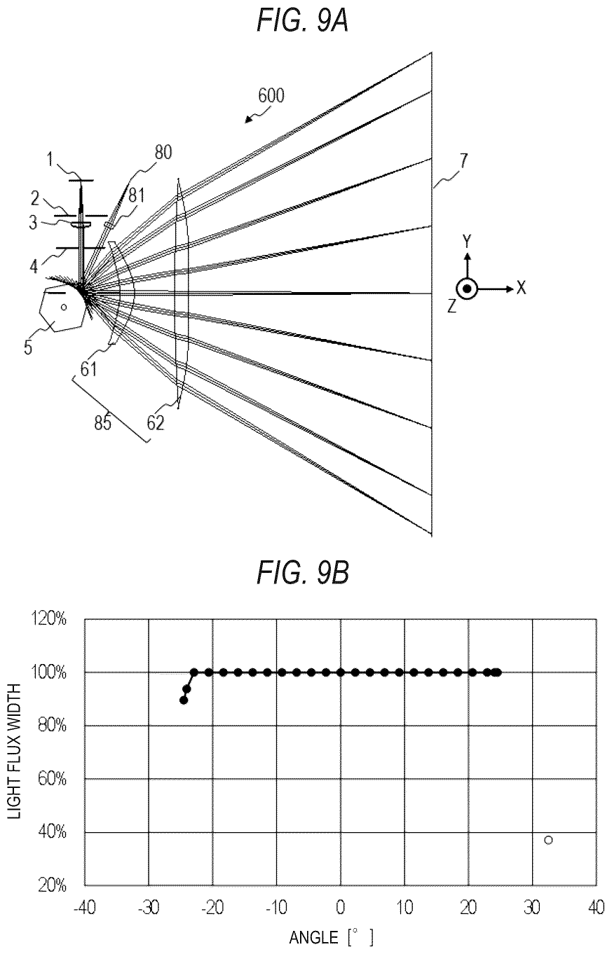

FIG. 9A shows a schematic main scanning cross sectional view of a light scanning apparatus 600 according to a sixth embodiment of the present invention. In FIG. 9A, the electrical mounting substrate 83 is not shown.

Further, FIG. 9B shows an angle dependence of a light flux width in the main scanning cross section of a light flux deflected by a polygon mirror 5 in the light scanning apparatus 600 according to the sixth embodiment (corresponding to FIG. 3).

Specifically, an angle on a horizontal axis of FIG. 9B is a rotation angle (θₘₐₓ₋/2 to θₘₐₓ₊/2) of a deflecting surface 51 of the polygon mirror 5.

The light scanning apparatus 600 according to the present embodiment has the same structure as the light scanning apparatus 100 according to the first embodiment except that each numerical value is different and the imaging optical system 85 is formed by two scanning imaging lenses 61 and 62, so that the same members are denoted by the same reference numerals and the description thereof is omitted.

Main specification values of the light scanning apparatus 600 according to the present embodiment and the arrangement of each optical element provided in the incident optical system 75 and the imaging optical system 85 are shown in the following Tables 36 and 37, respectively.

An aspherical shape of the anamorphic collimator lens 3, and aspherical shapes of the two scanning imaging lenses 61 and 62 provided in the light scanning apparatus 600 according to the present embodiment are shown in the following Tables 38 and 39, respectively.

An arrangement of each optical element provided in the synchronization detection optical system of the light scanning apparatus 600 according to the present embodiment is shown in the following Table 40.

Main specification values of the light scanning apparatus according to the comparative example is shown in the following Table 41.

TABLE 36

| | |
|---|---|
| Wavelength of light source 1 [nm] | 790 |
| Angle θi [°] between optical axis of imaging optical system 85 and optical | 90.0 |
| axis of incident optical system 75 | |
| Diameter φ [mm] of circumscribed circle in main scanning cross section of | 28.025 |
| polygon mirror 5 | |
| Number N of deflecting surface 51 of polygon mirror 5 | 6 |
| Width in main scanning cross section of deflecting surface 51 of polygon | 14.013 |
| mirror 5 [mm] | |
| Diameter φin [mm] of inscribed circle in main scanning cross section of | 24.271 |
| polygon mirror 5 | |
| Distance φin/2 between center of polygon mirror 5 and end in main scanning | 12.135 |
| direction of deflecting surface 51 | |
| Coordinate in X direction of rotation center of polygon mirror 5 | −9.732 |
| Coordinate in Y direction of rotation center of polygon mirror 5 | −7.430 |
| Fθ coefficient | 125.0 |
| Coordinate Ymax+ in Y direction of positive-side outermost off-axis image | 107.0 |
| height 71 | |
| Coordinate Ymax− in Y direction of negative-side outermost off-axis image | −107.0 |
| height 72 | |
| Printed width Ywidth = (Ymax+) − (Ymax−) on surface to be scanned 7 | 214.0 |
| Maximum angle of view θmax+ [°] corresponding to positive-side outermost | 49.0 |
| off-axis image height 71 | |
| Maximum angle of view θmax− [°] corresponding to negative-side outermost | −49.0 |
| off-axis image height 72 | |
| Angle of view θBD [°] of synchronization detection light flux | 65.0 |

TABLE 37

| | Surface | | | | | | | | |
|---|---|---|---|---|---|---|---|---|---|
| | number | R | N | x | y | z | gx(x) | gx(y) | gx(z) |
| Light emitting point of light | 1 | 0.000 | −1.511 | 0.000 | 50.000 | 0.000 | 0.000 | 1.000 | 0.000 |
| source 1 | | | | | | | | | |
| | 2 | 0.000 | −1.000 | 0.000 | 49.750 | 0.000 | 0.000 | 1.000 | 0.000 |
| Sub-scanning stop 2 | 3 | 0.000 | −1.000 | 0.000 | 34.000 | 0.000 | 0.000 | 1.000 | 0.000 |
| Incident surface of | 4 | aspherical | −1.529 | 0.000 | 31.000 | 0.000 | 0.000 | 1.000 | 0.000 |
| anamorphic collimator lens 3 | | | | | | | | | |
| Exit surface of anamorphic | 5 | aspherical | −1.000 | 0.000 | 29.000 | 0.000 | 0.000 | 1.000 | 0.000 |
| collimator lens 3 | | | | | | | | | |
| Main scanning stop 4 | 6 | 0.000 | 1.000 | 0.000 | 20.000 | 0.000 | 0.000 | 1.000 | 0.000 |
| Deflecting surface 51 of | 7 | 0.000 | 1.000 | 1.113 | −1.984 | 0.000 | 0.894 | 0.449 | 0.000 |
| polygon mirror 5 | | | | | | | | | |
| Incident surface of scanning | 8 | aspherical | 1.529 | 17.500 | 0.000 | 0.000 | 1.000 | 0.000 | 0.000 |
| imaging lens 61 | | | | | | | | | |
| Exit surface of scanning | 9 | aspherical | 1.000 | 24.000 | 0.000 | 0.000 | 1.000 | 0.000 | 0.000 |
| imaging lens 61 | | | | | | | | | |
| Incident surface of scanning | 10 | aspherical | 1.529 | 42.000 | 0.000 | 0.000 | 1.000 | 0.000 | 0.000 |
| imaging lens 62 | | | | | | | | | |
| Exit surface of scanning | 11 | aspherical | 1.000 | 48.000 | 0.000 | 0.000 | 1.000 | 0.000 | 0.000 |
| imaging lens 62 | | | | | | | | | |
| Surface to be scanned 7 | 12 | 0.000 | 1.000 | 157.000 | 0.000 | 0.000 | 1.000 | 0.000 | 0.000 |

| | |
|---|---|
| Aperture width in sub- | 1.040 |
| scanning direction of sub- | |
| scanning stop 2 | |
| Aperture width in main | 2.040 |
| scanning direction of main | |
| scanning stop 4 | |

TABLE 38
Incident surface of anamorphic collimator lens 3

| r | k | C2 | C4 | C6 | C8 | C10 |
|---|---|---|---|---|---|---|
| 0.00E+00 | 0.00E+00 | 0.00E+00 | 0.00E+00 | 0.00E+00 | 0.00E+00 | 0.00E+00 |

Exit surface of anamorphic collimator lens 3

| Ru | Ku | B2u | B4u | B6u | B8u | B10u |
|---|---|---|---|---|---|---|
| 1.07E+01 | 0.00E+00 | 0.00E+00 | −3.05E−04 | 0.00E+00 | 0.00E+00 | 0.00E+00 |
| Rl | Kl | B2l | B4l | B6l | B8l | B10l |
| 1.07E+01 | 0.00E+00 | 0.00E+00 | −3.05E−04 | 0.00E+00 | 0.00E+00 | 0.00E+00 |

| ru | E2u | E4u | E6u | E8u | E10u |
|---|---|---|---|---|---|
| 0.00E+00 | 0.00E+00 | 0.00E+00 | 0.00E+00 | 0.00E+00 | 0.00E+00 |
| rl | E2l | E4l | E6l | E8l | E10l |
| 0.00E+00 | 0.00E+00 | 0.00E+00 | 0.00E+00 | 0.00E+00 | 0.00E+00 |

| E1 | E3 | E5 |
|---|---|---|
| 0.00E+00 | 0.00E+00 | 0.00E+00 |

TABLE 39
Incident surface of scanning imaging lens 61

| Ru | Ku | B2u | B4u | B6u | B8u | B10u |
|---|---|---|---|---|---|---|
| −3.25E+01 | −5.99E+00 | 0.00E+00 | −2.63E−06 | 5.80E−08 | −1.51E−10 | 1.01E−13 |
| Rl | Kl | B2l | B4l | B6l | B8l | B10l |
| −3.25E+01 | −5.99E+00 | 0.00E+00 | −2.63E−06 | 5.80E−08 | −1.51E−10 | 1.01E−13 |

| ru | E2u | E4u | E6u | E8u | E10u |
|---|---|---|---|---|---|
| 1.20E+02 | 0.00E+00 | 0.00E+00 | 0.00E+00 | 0.00E+00 | 0.00E+00 |
| rl | E2l | E4l | E6l | E8l | E10l |
| 1.20E+02 | 0.00E+00 | 0.00E+00 | 0.00E+00 | 0.00E+00 | 0.00E+00 |

| E1 | E3 | E5 |
|---|---|---|
| 0.00E+00 | 0.00E+00 | 0.00E+00 |

Exit surface of scanning imaging lens 61

| Ru | Ku | B2u | B4u | B6u | B8u | B10u |
|---|---|---|---|---|---|---|
| −2.21E+01 | −4.49E+00 | 0.00E+00 | −2.88E−05 | 1.09E−07 | −1.54E−10 | 5.51E−14 |
| Rl | Kl | B2l | B4l | B6l | B8l | B10l |
| −2.21E+01 | −4.49E+00 | 0.00E+00 | −2.88E−05 | 1.09E−07 | −1.54E−10 | 5.51E−14 |

| ru | E2u | E4u | E6u | E8u | E10u |
|---|---|---|---|---|---|
| −2.17E+01 | 0.00E+00 | 0.00E+00 | 0.00E+00 | 0.00E+00 | 0.00E+00 |
| rl | E2l | E4l | E6l | E8l | E10l |
| −2.17E+01 | 0.00E+00 | 0.00E+00 | 0.00E+00 | 0.00E+00 | 0.00E+00 |

| E1 | E3 | E5 |
|---|---|---|
| 0.00E+00 | 0.00E+00 | 0.00E+00 |

Incident surface of scanning imaging lens 62

| Ru | Ku | B2u | B4u | B6u | B8u | B10u |
|---|---|---|---|---|---|---|
| 7.86E+02 | 0.00E+00 | 0.00E+00 | 0.00E+00 | 0.00E+00 | 0.00E+00 | 0.00E+00 |
| Rl | Kl | B2l | B4l | B6l | B8l | B10l |
| 7.86E+02 | 0.00E+00 | 0.00E+00 | 0.00E+00 | 0.00E+00 | 0.00E+00 | 0.00E+00 |

| ru | E2u | E4u | E6u | E8u | E10u |
|---|---|---|---|---|---|
| −5.20E+01 | 3.59E−03 | 1.91E−06 | 1.16E−08 | 0.00E+00 | 0.00E+00 |
| rl | E2l | E4l | E6l | E8l | E10l |
| −5.20E+01 | 3.16E−03 | 7.34E−06 | 4.58E−09 | 0.00E+00 | 0.00E+00 |

| E1 | E3 | E5 |
|---|---|---|
| 0.00E+00 | 0.00E+00 | 0.00E+00 |

Exit surface of scanning imaging lens 62

| Ru | Ku | B2u | B4u | B6u | B8u | B10u |
|---|---|---|---|---|---|---|
| 2.60E+02 | −6.65E+02 | 0.00E+00 | −2.45E−06 | 1.05E−09 | −2.45E−13 | 2.66E−17 |
| Rl | Kl | B2l | B4l | B6l | B8l | B10l |
| 2.60E+02 | −6.65E+02 | 0.00E+00 | −2.45E−06 | 1.05E−09 | −2.45E−13 | 2.66E−17 |

| ru | E2u | E4u | E6u | E8u | E10u |
|---|---|---|---|---|---|
| −1.75E+01 | 7.82E−04 | −4.67E−07 | 1.76E−10 | −2.89E−14 | 0.00E+00 |
| rl | E2l | E4l | E6l | E8l | E10l |
| −1.75E+01 | 1.03E−03 | −6.92E−07 | 2.80E−10 | −3.96E−14 | 0.00E+00 |

| E1 | E3 | E5 |
|---|---|---|
| 0.00E+00 | 0.00E+00 | 0.00E+00 |

TABLE 40

| | Surface | | | | | | | | |
|---|---|---|---|---|---|---|---|---|---|
| | number | R | N | x | y | z | gx(x) | gx(y) | gx(z) |
| Light source 1 | 1 to 6 | Common | Common | Common | Common | Common | Common | Common | Common |
| to main | | | | | | | | | |
| scanning stop 4 | | | | | | | | | |
| Deflecting | 7 | 0.000 | 1.0000 | −7.105 | 4.417 | 0.000 | 0.216 | 0.976 | 0.000 |
| surface 51 of | | | | | | | | | |
| polygon mirror | | | | | | | | | |
| 5 | | | | | | | | | |
| Incident surface | 8 | 0.000 | 1.5287 | 12.015 | 28.609 | 0.000 | 0.423 | 0.906 | 0.000 |
| of | | | | | | | | | |
| synchronization | | | | | | | | | |
| detection | | | | | | | | | |
| imaging | | | | | | | | | |
| element 81 | | | | | | | | | |
| Exit surface of | 9 | 0.000 | 1.0000 | 12.860 | 30.421 | 0.000 | 0.423 | 0.906 | 0.000 |
| synchronization | | | | | | | | | |
| detection | | | | | | | | | |
| imaging | | | | | | | | | |
| element 81 | | | | | | | | | |
| Synchronization | 10 | 0.000 | 1.0000 | 21.989 | 49.997 | 0.000 | — | — | — |
| detection light | | | | | | | | | |
| receiving | | | | | | | | | |
| element 80 | | | | | | | | | |

TABLE 41

| | |
|---|---|
| Diameter φ [mm] of circumscribed circle in main scanning cross section of | 30 |
| polygon mirror 5 | |
| Number N of deflecting surface 51 of polygon mirror 5 | 5 |
| Width in main scanning cross section of deflecting surface 51 of polygon | 17.634 |
| mirror 5 [mm] | |
| Diameter φin [mm] of inscribed circle in main scanning cross section of | 24.271 |
| polygon mirror 5 | |
| Distance φin/2 between center of polygon mirror 5 and end in main scanning | 12.135 |
| direction of deflecting surface 51 | |
| Coordinate in X direction of rotation center of polygon mirror 5 | −9.732 |
| Coordinate in Y direction of rotation center of polygon mirror 5 | −7.430 |

As shown in FIG. 9B, in the light scanning apparatus 600 according to the present embodiment. Inequalities (1) and (1′) are satisfied.

Further, as shown in FIG. 9B, any light flux for scanning each image height on the surface to be scanned 7 has the light flux width of 90% or more of the width Wᵢ of the incident light flux Lᵢ in the light scanning apparatus 600 according to the present embodiment.

Furthermore, as shown in Table 36, angles of the light flux for scanning the positive side outermost off-axis image height 71 and the negative side outermost off-axis image height 72 are +49.0° and −49.0°, respectively.

The light scanning apparatus according to the comparative example has the same structure as that of the light scanning apparatus 600 according to the present embodiment except that the light scanning apparatus according to the comparative example uses the polygon mirror 5 with five surfaces in which the number of deflecting surfaces 51 is smaller by one than that of the light scanning apparatus 600 according to the present embodiment. Therefore, the same members are denoted by the same reference numerals, and description thereof is omitted.

Next, the value of each Inequality in the light scanning apparatus 600 according to the present embodiment and the light scanning apparatus according to the comparative example is shown in the following Table 42.

TABLE 42

| | Sixth | Comparative |
|---|---|---|
| | embodiment | example |
| Inequalities | | |
| Inequality (2): 5.50 ≤ φ − K × N × (N − 1) ≤ 13.00 (K = 0.52) | 12.43 | 19.6 |
| Inequality (2): 5.50 ≤ φ − K × N × (N − 1) ≤ 13.00 (K = 0.54) | 11.83 | 19.20 |
| Inequality (2): 5.50 ≤ φ − K × N × (N − 1) ≤ 13.00 (K = 0.56) | 11.23 | 18.8 |
| Inequality (3): 6.00 < (φ + 15)/N < 7.40 | 7.17 | 9.00 |
| Inequality (3a): 6.20 < (φ + 15)/N < 7.20 | | |
| Inequality (4): 22.60 < Ymax+/(φ/N) < 37.00 | 22.91 | 17.83 |
| Inequality (4a): 27.00 < Ymax+/(φ/N) < 34.00 | | |
| Inequality (5): 1.78 < (θi + θmax+)/θBD < 2.33 | 2.14 | 2.14 |
| Inequality (7): 360/N − 45 < θBD − θmax+ < (360/N)/2 | | |
| Sixth embodiment: 15 < θBD − θmax+ < 30 | 15.95 | |
| Comparative example: 27 < θBD − θmax+ < 36 | | 15.95 |
| With respect to Inequality (1): WBD < Wmax− < Wmax+ | | |
| and Inequality (1′): Wmax+ = Wi | | |
| Width Wi of incident light flux Li | 2.06 | 2.06 |
| Width WBD of synchronization detection light flux | 0.77 | 2.06 |
| Width Wmax+ of light flux traveling to positive-side | 2.06 | 2.06 |
| outermost off-axis image height 71 | | |
| Width Wcenter of light flux traveling to on-axis image | 2.06 | 2.06 |
| height 70 | | |
| Width Wmax− of light flux traveling to negative-side | 1.85 | 2.06 |
| outermost off-axis image height 72 | | |
| Angle θBD [°] of scanning light flux LBD | 65.0 | 65.0 |
| Angle θBD − 360/N × 2 [°] of scanning light flux LBD2 | −55.0 | x |
| Angle θmax+ [°] of scanning light flux Lmax+ | 49.0 | 49.0 |
| Angle θmax− [°] of scanning light flux Lmax− | −49.0 | −49.0 |
| Angle θmax− + 360/N × 2 [°] of scanning light | 71.0 | x |
| flux Lmax− 2 | | |

As shown in Tables 36 and 41, the width in the main scanning cross section of the deflecting surface 51 of the polygon mirror 5 is considerably larger in the light scanning apparatus according to the comparative example than in the light scanning apparatus 600 according to the present embodiment.

Therefore, as shown in Table 42, the width W_{BD} of the synchronization detection light flux and the width Wₘₐₓ₋ of the scanning light flux Lₘₐₓ₋ traveling to the negative side outermost off-axis image height 72 are the same as the width Wᵢ of the incident light flux Lᵢ, namely are not reduced in the light scanning apparatus according to the comparative example.

On the other hand, a diameter of the circumscribed circle as an outer shape of the polygon mirror 5 is smaller in the light scanning apparatus 600 according to the present embodiment than in the light scanning apparatus according to the comparative example.

That is, downsizing of the polygon mirror 5 is achieved in the light scanning apparatus 600 according to the present embodiment, so that it is possible to downsize the light scanning apparatus 600 according to the present embodiment and the image forming apparatus in which the light scanning apparatus 600 is mounted.

Further, since the polygon mirror 5 can be reduced in size, the polygon motor for rotationally driving the polygon mirror 5 can also be reduced in size.

This is because a rotational moment of the polygon mirror 5 increases as the size in the main scanning cross section of the polygon mirror 5 increases.

Furthermore, it is also possible to reduce a power consumption of the polygon motor along with the downsizing of the polygon motor due to the downsizing of the polygon mirror 5.

In addition, when the diameter of the circumscribed circle of the polygon mirror 5 decreases, a wind noise generated from the polygon mirror 5 decreases, so that a structure for shielding the wind noise can be simplified and downsized.

As described above, the light scanning apparatus 600 according to the present embodiment can be reduced in size.

As shown in Table 42, both of Inequality (2) in the case where K is a constant of 0.52 or more and 0.56 or less and Inequality (2) in the case where K is a constant of 0.53 or more and 0.55 or less are satisfied in the light scanning apparatus 600 according to the present embodiment.

On the other hand, in the light scanning apparatus according to the comparative example, any of Inequality (2) in the case where K is a constant of 0.52 or more and 0.56 or less and Inequality (2) in the case where K is a constant of 0.53 or more and 0.55 or less is not satisfied.

Further, Inequalities (3), (3a), (4), (4a) and (7) are satisfied in the light scanning apparatus 600 according to the present embodiment, but are not satisfied in the light scanning apparatus according to the comparative example.

Inequality (5) is satisfied in the light scanning apparatus 600 according to the present embodiment.

Inequality (1) is satisfied in the light scanning apparatus 600 according to the present embodiment, but is not satisfied in the light scanning apparatus according to the comparative example.

Inequality (1′) is satisfied in the light scanning apparatus 600 according to the present embodiment.

As described above, the size of the light scanning apparatus 600 according to the present embodiment can be reduced by satisfying each Inequality.

Further, as shown in Table 42, any of the angle (θ_{BD}−360/N×2) of the scanning light flux L_{BD2} and the angle (θₘₐₓ₋+360/N×2) of the scanning light flux Lₘₐₓ₋₂ is not within a range between the angle θₘₐₓ₊ and the angle θₘₐₓ₋ in the light scanning apparatus 600 according to the present embodiment.

Therefore, in the light scanning apparatus 600 according to the present embodiment, both of the scanning light flux L_{BD2} and the scanning light flux Lₘₐₓ₋₂ can be shielded by a member such as a housing, ribs other than the optical surface of the two scanning imaging lenses 61 and 62, or the like.

Even if the scanning light flux L_{BD2} or the scanning light flux Lₘₐₓ₋₂ is incident on the two scanning imaging lenses 61 and 62, the scanning light flux L_{BD2} or the scanning light flux Lₘₐₓ₋₂ does not reach the printed area of the surface to be scanned 7, so that there is no problem in printing.

As described above, in the light scanning apparatus 600 according to the present embodiment, it is possible to reduce the size of the polygon mirror 5, to reduce the size of the polygon motor by reducing the weight of the polygon mirror 5, and to simplify a soundproof member, compared to the light scanning apparatus according to the comparative example and a light scanning apparatus of the related art.

Thereby, the size of the light scanning apparatus 600 according to the present embodiment can be reduced, so that it is possible to provide a compact light scanning apparatus suitable for high-quality image recording and an image forming apparatus equipped with the light scanning apparatus.

### Seventh Embodiment

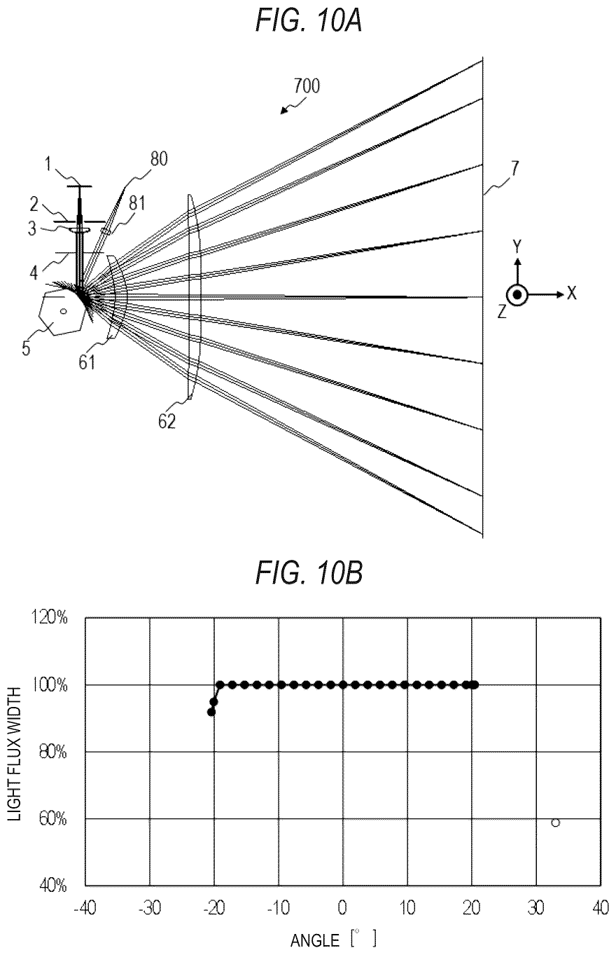

FIG. 10A shows a schematic main scanning cross sectional view of a light scanning apparatus 700 according to a seventh embodiment of the present invention. In FIG. 10A, the electrical mounting substrate 83 is not shown.

Further, FIG. 10B shows an angle dependence of a light flux width in the main scanning cross section of a light flux deflected by a polygon mirror 5 in the light scanning apparatus 700 according to the seventh embodiment (corresponding to FIG. 3).

Specifically, an angle on a horizontal axis of FIG. 10B is a rotation angle (θₘₐₓ₋/2 to θₘₐₓ₊/2) of a deflecting surface 51 of the polygon mirror 5.

The light scanning apparatus 700 according to the present embodiment has the same structure as the light scanning apparatus 600 according to the sixth embodiment except that each numerical value is different, so that the same members are denoted by the same reference numerals and the description thereof is omitted.

Main specification values of the light scanning apparatus 700 according to the present embodiment and the arrangement of each optical element provided in the incident optical system 75 and the imaging optical system 85 are shown in the following Tables 43 and 44, respectively.

An aspherical shape of the anamorphic collimator lens 3, and aspherical shapes of the two scanning imaging lenses 61 and 62 provided in the light scanning apparatus 700 according to the present embodiment are shown in the following Tables 45 and 46, respectively.

An arrangement of each optical element provided in the synchronization detection optical system of the light scanning apparatus 700 according to the present embodiment is shown in the following Table 47.

Main specification values of the light scanning apparatus according to the comparative example is shown in the following Table 48.

TABLE 43

| | |
|---|---|
| Wavelength of light source 1 [nm] | 790 |
| Angle θi [°] between optical axis of imaging optical system 85 and optical | 90.0 |
| axis of incident optical system 75 | |
| Diameter φ [mm] of circumscribed circle in main scanning cross section of | 28.025 |
| polygon mirror 5 | |
| Number N of deflecting surface 51 of polygon mirror 5 | 6 |
| Width in main scanning cross section of deflecting surface 51 of polygon | 14.013 |
| mirror 5 [mm] | |
| Diameter φin [mm] of inscribed circle in main scanning cross section of | 24.271 |
| polygon mirror 5 | |
| Distance φin/2 between center of polygon mirror 5 and end in main scanning | 12.135 |
| direction of deflecting surface 51 | |
| Coordinate in X direction of rotation center of polygon mirror 5 | −9.157 |
| Coordinate in Y direction of rotation center of polygon mirror 5 | −8.005 |
| Fθ coefficient | 150.0 |
| Coordinate Ymax+ in Y direction of positive-side outermost off-axis image | 107.0 |
| height 71 | |
| Coordinate Ymax− in Y direction of negative-side outermost off-axis image | −107.0 |
| height 72 | |
| Printed width Ywidth = (Ymax+) − (Ymax−) on surface to be scanned 7 | 214.0 |
| Maximum angle of view θmax+ [°] corresponding to positive-side outermost | 40.9 |
| off-axis image height 71 | |
| Maximum angle of view θmax− [°] corresponding to negative-side outermost | −40.9 |
| off-axis image height 72 | |
| Angle of view θBD [°] of synchronization detection light flux | 66.0 |

TABLE 44

| | Surface | | | | | | | | |
|---|---|---|---|---|---|---|---|---|---|
| | number | R | N | x | y | z | gx(x) | gx(y) | gx(z) |
| Light emitting point of | 1 | 1 | 0.000 | −1.511 | 50.000 | 0.000 | 0.000 | 1.000 | 0.000 |
| light source 1 | | | | | | | | | |
| | 2 | 2 | 0.000 | −1.000 | 49.750 | 0.000 | 0.000 | 1.000 | 0.000 |
| Sub-scanning stop 2 | 3 | 3 | 0.000 | −1.000 | 34.000 | 0.000 | 0.000 | 1.000 | 0.000 |
| Incident surface of | 4 | 4 | aspherical | −1.529 | 31.000 | 0.000 | 0.000 | 1.000 | 0.000 |
| anamorphic collimator | | | | | | | | | |
| lens 3 | | | | | | | | | |
| Exit surface of | 5 | 5 | aspherical | −1.000 | 29.000 | 0.000 | 0.000 | 1.000 | 0.000 |
| anamorphic collimator | | | | | | | | | |
| lens 3 | | | | | | | | | |
| Main scanning stop 4 | 6 | 0.000 | 1.000 | 0.000 | 20.000 | 0.000 | 0.000 | 1.000 | 0.000 |
| Deflecting surface 51 of | 7 | 0.000 | 1.000 | 1.382 | −1.988 | 0.000 | 0.868 | 0.496 | 0.000 |
| polygon mirror 5 | | | | | | | | | |
| Incident surface of | 8 | aspherical | 1.529 | 16.000 | 0.000 | 0.000 | 1.000 | 0.000 | 0.000 |
| scanning imaging lens 61 | | | | | | | | | |
| Exit surface of scanning | 9 | aspherical | 1.000 | 21.500 | 0.000 | 0.000 | 1.000 | 0.000 | 0.000 |
| imaging lens 61 | | | | | | | | | |
| Incident surface of | 10 | aspherical | 1.529 | 49.500 | 0.000 | 0.000 | 1.000 | 0.000 | 0.000 |
| scanning imaging lens 62 | | | | | | | | | |
| Exit surface of scanning | 11 | aspherical | 1.000 | 55.000 | 0.000 | 0.000 | 1.000 | 0.000 | 0.000 |
| imaging lens 62 | | | | | | | | | |
| Surface to be scanned 7 | 12 | 0.000 | 1.000 | 183.000 | 0.000 | 0.000 | 1.000 | 0.000 | 0.000 |

| | |
|---|---|
| Aperture width in sub- | 1.220 |
| scanning direction of | |
| sub-scanning stop 2 | |
| Aperture width in main | 2.440 |
| scanning direction of | |
| main scanning stop 4 | |

TABLE 45
Incident surface of anamorphic collimator lens 3

| r | k | C2 | C4 | C6 | C8 | C10 |
|---|---|---|---|---|---|---|
| 0.00E+00 | 0.00E+00 | 0.00E+00 | 0.00E+00 | 0.00E+00 | 0.00E+00 | 0.00E+00 |

Exit surface of anamorphic collimator lens 3

| Ru | Ku | B2u | B4u | B6u | B8u | B10u |
|---|---|---|---|---|---|---|
| 1.07E+01 | 0.00E+00 | 0.00E+00 | −3.05E−04 | 0.00E+00 | 0.00E+00 | 0.00E+00 |
| Rl | Kl | B2l | B4l | B6l | B8l | B10l |
| 1.07E+01 | 0.00E+00 | 0.00E+00 | −3.05E−04 | 0.00E+00 | 0.00E+00 | 0.00E+00 |

| ru | E2u | E4u | E6u | E8u | E10u |
|---|---|---|---|---|---|
| 6.27E+00 | 0.00E+00 | 0.00E+00 | 0.00E+00 | 0.00E+00 | 0.00E+00 |
| rl | E2l | E4l | E6l | E8l | E10l |
| 6.27E+00 | 0.00E+00 | 0.00E+00 | 0.00E+00 | 0.00E+00 | 0.00E+00 |

| E1 | E3 | E5 |
|---|---|---|
| 0.00E+00 | 0.00E+00 | 0.00E+00 |

TABLE 46

Incident surface of scanning imaging lens 61

| Ru | Ku | B2u | B4u | B6u | B8u | B10u |
|---|---|---|---|---|---|---|
| −3.14E+01 | −2.41E+00 | 0.00E+00 | 1.80E−05 | 1.91E−08 | −1.74E−10 | 1.58E−13 |
| Rl | Kl | B2l | B4l | B6l | B8l | B10l |
| −3.14E+01 | −2.41E+00 | 0.00E+00 | 1.80E−05 | 1.91E−08 | −1.74E−10 | 1.58E−13 |

| ru | E2u | E4u | E6u | E8u | E10u |
|---|---|---|---|---|---|
| −7.33E+01 | 0.00E+00 | 0.00E+00 | 0.00E+00 | 0.00E+00 | 0.00E+00 |
| rl | E2l | E4l | E6l | E8l | E10l |
| −7.33E+01 | 0.00E+00 | 0.00E+00 | 0.00E+00 | 0.00E+00 | 0.00E+00 |

| E1 | E3 | E5 |
|---|---|---|
| 0.00E+00 | 0.00E+00 | 0.00E+00 |

Exit surface of scanning imaging lens 61

| Ru | Ku | B2u | B4u | B6u | B8u | B10u |
|---|---|---|---|---|---|---|
| −2.34E+01 | −2.88E+00 | 0.00E+00 | −6.60E−06 | 6.54E−08 | −1.22E−10 | 7.55E−15 |
| R | K1l | B2l | B4l | B6l | B8l | B10l |
| −2.34E+01 | −2.88E+00 | 0.00E+00 | −6.60E−06 | 6.54E−08 | −1.22E−10 | 7.55E−15 |

| ru | E2u | E4u | E6u | E8u | E10u |
|---|---|---|---|---|---|
| −1.34E+01 | 0.00E+00 | 0.00E+00 | 0.00E+00 | 0.00E+00 | 0.00E+00 |
| rl | E2l | E4l | E6l | E8l | E10l |
| −1.34E+01 | 0.00E+00 | 0.00E+00 | 0.00E+00 | 0.00E+00 | 0.00E+00 |

| E1 | E3 | E5 |
|---|---|---|
| 0.00E+00 | 0.00E+00 | 0.00E+00 |

Incident surface of scanning imaging lens 62

| Ru | Ku | B2u | B4u | B6u | B8u | B10u |
|---|---|---|---|---|---|---|
| −3.40E+03 | 0.00E+00 | 0.00E+00 | 0.00E+00 | 0.00E+00 | 0.00E+00 | 0.00E+00 |
| Rl | Kl | B2l | B4l | B6l | B8l | B10l |
| −3.40E+03 | 0.00E+00 | 0.00E+00 | 0.00E+00 | 0.00E+00 | 0.00E+00 | 0.00E+00 |

| ru | E2u | E4u | E6u | E8u | E10u |
|---|---|---|---|---|---|
| −4.80E+01 | 4.75E−03 | 5.41E−06 | 1.94E−08 | 0.00E+00 | 0.00E+00 |

| rl | E2l | E4l | E6l | E8l | E10l |
|---|---|---|---|---|---|
| −4.80E+01 | 2.07E−03 | 1.85E−06 | −1.92E−09 | 0.00E+00 | 0.00E+00 |

| E1 | E3 | E5 |
|---|---|---|
| 0.00E+00 | 0.00E+00 | 0.00E+00 |

Exit surface of scanning imaging lens 62

| Ru | Ku | B2u | B4u | B6u | B8u | B10u |
|---|---|---|---|---|---|---|
| 1.02E+03 | −2.30E+12 | 0.00E+00 | −2.15E−06 | 9.69E−10 | −3.07E−13 | 4.82E−17 |
| Rl | Kl | B2l | B4l | B6l | B8l | B10l |
| 1.02E+03 | −2.30E+12 | 0.00E+00 | −2.15E−06 | 9.69E−10 | −3.07E−13 | 4.82E−17 |

| ru | E2u | E4u | E6u | E8u | E10u |
|---|---|---|---|---|---|
| −1.90E+01 | 1.32E−03 | −1.29E−06 | 6.48E−10 | −1.23E−13 | 0.00E+00 |
| rl | E2l | E4l | E6l | E8l | E10l |
| −1.90E+01 | 7.12E−04 | −4.97E−07 | 2.54E−10 | −8.70E−14 | 0.00E+00 |

| E1 | E3 | E5 |
|---|---|---|
| 0.00E+00 | 0.00E+00 | 0.00E+00 |

TABLE 47

| | Surface | | | | | | | | |
|---|---|---|---|---|---|---|---|---|---|
| | number | R | N | x | y | z | gx(x) | gx(y) | gx(z) |
| Light source 1 | 1 to 6 | Common | Common | Common | Common | Common | Common | Common | Common |
| to main | | | | | | | | | |
| scanning stop 4 | | | | | | | | | |
| Deflecting | 7 | 0.000 | 1.0000 | −6.634 | 3.865 | 0.000 | 0.208 | 0.978 | 0.000 |
| surface 51 of | | | | | | | | | |
| polygon mirror 5 | | | | | | | | | |
| Incident surface | 8 | 0.000 | 1.5287 | 11.572 | 28.446 | 0.000 | 0.407 | 0.914 | 0.000 |
| of synchronization | | | | | | | | | |
| detection imaging | | | | | | | | | |
| element 81 | | | | | | | | | |
| Exit surface of | 9 | 0.000 | 1.0000 | 12.385 | 30.273 | 0.000 | 0.407 | 0.914 | 0.000 |
| synchronization | | | | | | | | | |
| detection imaging | | | | | | | | | |
| element 81 | | | | | | | | | |
| Synchronization | 10 | 0.000 | 1.0000 | 21.171 | 50.005 | 0.000 | — | — | — |
| detection light | | | | | | | | | |
| receiving | | | | | | | | | |
| element 80 | | | | | | | | | |

TABLE 48

| | |
|---|---|
| Diameter φ [mm] of circumscribed circle in main scanning cross section of | 30 |
| polygon mirror 5 | |
| Number N of deflecting surface 51 of polygon mirror 5 | 5 |
| Width in main scanning cross section of deflecting surface 51 of polygon | 17.634 |
| mirror 5 [mm] | |
| Diameter φin [mm] of inscribed circle in main scanning cross section of | 24.271 |
| polygon mirror 5 | |
| Distance φin/2 between center of polygon mirror 5 and end in main scanning | 12.135 |
| direction of deflecting surface 51 | |
| Coordinate in X direction of rotation center of polygon mirror 5 | −9.157 |
| Coordinate in Y direction of rotation center of polygon mirror 5 | −8.005 |

As shown in FIG. 10B, in the light scanning apparatus 700 according to the present embodiment, Inequalities (1) and (1′) are satisfied.

Further, as shown in FIG. 10B, any light flux for scanning each image height on the surface to be scanned 7 has the light flux width of 90% or more of the width Wᵢ of the incident light flux Lᵢ in the light scanning apparatus 700 according to the present embodiment.

The light scanning apparatus according to the comparative example has the same structure as that of the light scanning apparatus 700 according to the present embodiment except that the light scanning apparatus according to the comparative example uses the polygon mirror 5 with five surfaces in which the number of deflecting surfaces 51 is smaller by one than that of the light scanning apparatus 700 according to the present embodiment. Therefore, the same members are denoted by the same reference numerals, and description thereof is omitted.

Next, the value of each Inequality in the light scanning apparatus 700 according to the present embodiment and the light scanning apparatus according to the comparative example is shown in the following Table 49.

TABLE 49

| | Seventh | Comparative |
|---|---|---|
| | embodiment | example |
| Inequalities | | |
| Inequality (2): 5.50 ≤ φ − K × N × (N − 1) ≤ 13.00 (K = 0.52) | 12.43 | 19.6 |
| Inequality (2): 5.50 ≤ φ − K × N × (N − 1) ≤ 13.00 (K = 0.54) | 11.83 | 19.20 |
| Inequality (2): 5.50 ≤ φ − K × N × (N − 1) ≤ 13.00 (K = 0.56) | 11.23 | 18.8 |
| Inequality (3): 6.00 < (φ + 15)/N < 7.40 | 7.17 | 9.00 |
| Inequality (3a): 6.20 < (φ + 15)/N < 7.20 | | |
| Inequality (4): 22.60 < Ymax+/(φ/N) < 37.00 | 22.91 | 17.83 |
| Inequality (4a): 27.00 < Ymax+/(φ/N) < 34.00 | | |
| Inequality (5): 1.78 < (θi + θmax+)/θBD < 2.33 | 1.98 | 1.98 |
| Inequality (7): 360/N − 45 < θBD − θmax+ < (360/N)/2 | | |
| Seventh embodiment: 15 < θBD − θmax+ < 30 | 25.13 | |
| Comparative example: 27 < θBD − θmax+ < 36 | | 25.13 |
| With respect to Inequality (1): WBD < Wmax− < Wmax+ | | |
| and Inequality (1′): Wmax+ = Wi | | |
| Width Wi of incident light flux Li | 2.48 | 2.48 |
| Width WBD of synchronization detection light flux | 1.46 | 2.48 |
| Width Wmax+ of light flux traveling to positive-side | 2.48 | 2.48 |
| outermost off-axis image height 71 | | |
| Width Wcenter of light flux traveling to on-axis image | 2.48 | 2.48 |
| height 70 | | |
| Width Wmax− of light flux traveling to negative-side | 2.27 | 2.48 |
| outermost off-axis image height 72 | | |
| Angle θBD [°] of scanning light flux LBD | 66.0 | 66.0 |
| Angle θBD − 360/N × 2 [°] of scanning light flux LBD2 | −54.0 | x |
| Angle θmax+ [°] of scanning light flux Lmax+ | 40.9 | 40.9 |
| Angle θmax− [°] of scanning light flux Lmax− | −40.9 | −40.9 |
| Angle θmax− + 360/N × 2 [°] of scanning light | 79.1 | x |
| flux Lmax− 2 | | |

As shown in Tables 43 and 48, the width in the main scanning cross section of the deflecting surface 51 of the polygon mirror 5 is considerably larger in the light scanning apparatus according to the comparative example than in the light scanning apparatus 700 according to the present embodiment.

Therefore, as shown in Table 49, the width W_{BD} of the synchronization detection light flux and the width Wₘₐₓ₋ of the scanning light flux Lₘₐₓ₋ traveling to the negative side outermost off-axis image height 72 are the same as the width Wᵢ of the incident light flux Lᵢ, namely are not reduced in the light scanning apparatus according to the comparative example.

On the other hand, a diameter of the circumscribed circle as an outer shape of the polygon mirror 5 is smaller in the light scanning apparatus 700 according to the present embodiment than in the light scanning apparatus according to the comparative example.

That is, downsizing of the polygon mirror 5 is achieved in the light scanning apparatus 700 according to the present embodiment, so that it is possible to downsize the light scanning apparatus 700 according to the present embodiment and the image forming apparatus in which the light scanning apparatus 700 is mounted.

Further, since the polygon mirror 5 can be reduced in size, the polygon motor for rotationally driving the polygon mirror 5 can also be reduced in size.

This is because a rotational moment of the polygon mirror 5 increases as the size in the main scanning cross section of the polygon mirror 5 increases.

Furthermore, it is also possible to reduce a power consumption of the polygon motor along with the downsizing of the polygon motor due to the downsizing of the polygon mirror 5.

In addition, when the diameter of the circumscribed circle of the polygon mirror 5 decreases, a wind noise generated from the polygon mirror 5 decreases, so that a structure for shielding the wind noise can be simplified and downsized.

As described above, the light scanning apparatus 700 according to the present embodiment can be reduced in size.

As shown in Table 49, both of Inequality (2) in the case where K is a constant of 0.52 or more and 0.56 or less and Inequality (2) in the case where K is a constant of 0.53 or more and 0.55 or less are satisfied in the light scanning apparatus 700 according to the present embodiment.

On the other hand, in the light scanning apparatus according to the comparative example, any of Inequality (2) in the case where K is a constant of 0.52 or more and 0.56 or less and Inequality (2) in the case where K is a constant of 0.53 or more and 0.55 or less is not satisfied.

Further, Inequalities (3), (3a), (4), (4a) and (7) are satisfied in the light scanning apparatus 700 according to the present embodiment, but are not satisfied in the light scanning apparatus according to the comparative example.

Inequality (5) is satisfied in the light scanning apparatus 700 according to the present embodiment.

Inequality (1) is satisfied in the light scanning apparatus 700 according to the present embodiment, but is not satisfied in the light scanning apparatus according to the comparative example.

Inequality (1′) is satisfied in the light scanning apparatus 700 according to the present embodiment.

As described above, the size of the light scanning apparatus 700 according to the present embodiment can be reduced by satisfying each Inequality.

Further, as shown in Table 49, any of the angle (θ_{BD}−360/N×2) of the scanning light flux L_{BD2} and the angle (θₘₐₓ₋+360/N×2) of the scanning light flux Lₘₐₓ₋₂ is not within a range between the angle θₘₐₓ₊ and the angle θₘₐₓ₋ in the light scanning apparatus 700 according to the present embodiment.

Therefore, in the light scanning apparatus 700 according to the present embodiment, both of the scanning light flux L_{BD2} and the scanning light flux Lₘₐₓ₋₂ can be shielded by a member such as a housing, ribs other than the optical surface of the two scanning imaging lenses 61 and 62, or the like.

Even if the scanning light flux L_{BD2} or the scanning light flux Lₘₐₓ₋₂ is incident on the two scanning imaging lenses 61 and 62, the scanning light flux L_{BD2} or the scanning light flux Lₘₐₓ₋₂ does not reach the printed area of the surface to be scanned 7, so that there is no problem in printing.

As described above, in the light scanning apparatus 700 according to the present embodiment, it is possible to reduce the size of the polygon mirror 5, to reduce the size of the polygon motor by reducing the weight of the polygon mirror 5, and to simplify a soundproof member, compared to the light scanning apparatus according to the comparative example and a light scanning apparatus of the related art.

Thereby, the size of the light scanning apparatus 700 according to the present embodiment can be reduced, so that it is possible to provide a compact light scanning apparatus suitable for high-quality image recording and an image forming apparatus equipped with the light scanning apparatus.

### Eighth Embodiment

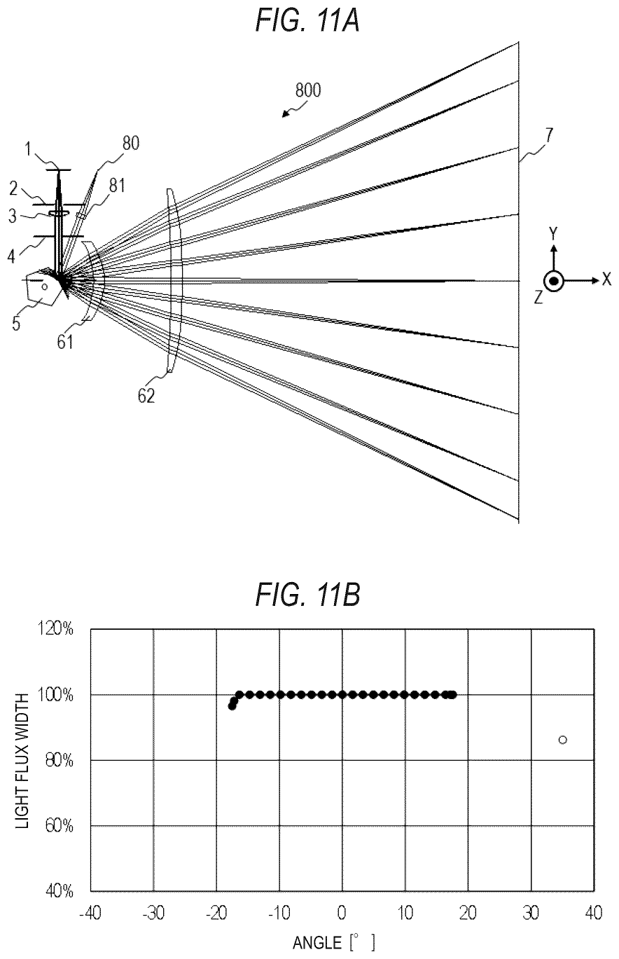

FIG. 11A shows a schematic main scanning cross sectional view of a light scanning apparatus 800 according to an eighth embodiment of the present invention. In FIG. 11A, the electrical mounting substrate 83 is not shown.

Further, FIG. 11B shows an angle dependence of a light flux width in the main scanning cross section of a light flux deflected by a polygon mirror 5 in the light scanning apparatus 800 according to the eighth embodiment (corresponding to FIG. 3).

Specifically, an angle on a horizontal axis of FIG. 11B is a rotation angle (θₘₐₓ₋/2 to θₘₐₓ₊/2) of a deflecting surface 51 of the polygon mirror 5.

The light scanning apparatus 800 according to the present embodiment has the same structure as the light scanning apparatus 600 according to the sixth embodiment except that each numerical value is different, so that the same members are denoted by the same reference numerals and the description thereof is omitted.

Main specification values of the light scanning apparatus 800 according to the present embodiment, and the arrangement of each optical element provided in the incident optical system 75 and the imaging optical system 85 are shown in the following Tables 50 and 51, respectively.

An aspherical shape of the anamorphic collimator lens 3, and aspherical shapes of the two scanning imaging lenses 61 and 62 provided in the light scanning apparatus 800 according to the present embodiment are shown in the following Tables 52 and 53, respectively.

An arrangement of each optical element provided in the synchronization detection optical system of the light scanning apparatus 800 according to the present embodiment is shown in the following Table 54.

Main specification values of the light scanning apparatus according to the comparative example is shown in the following Table 55.

TABLE 50

| | |
|---|---|
| Wavelength of light source 1 [nm] | 790 |
| Angle θi [°] between optical axis of imaging optical system 85 and optical | 90.0 |
| axis of incident optical system 75 | |
| Diameter φ [mm] of circumscribed circle in main scanning cross section of | 17.481 |
| polygon mirror 5 | |
| Number N of deflecting surface 51 of polygon mirror 5 | 5 |
| Width in main scanning cross section of deflecting surface 51 of polygon | 10.275 |
| mirror 5 [mm] | |
| Diameter φin [mm] of inscribed circle in main scanning cross section of | 14.142 |
| polygon mirror 5 | |
| Distance φin/2 between center of polygon mirror 5 and end in main scanning | 7.071 |
| direction of deflecting surface 51 | |
| Coordinate in X direction of rotation center of polygon mirror 5 | −5.243 |
| Coordinate in Y direction of rotation center of polygon mirror 5 | −4.757 |
| Fθ coefficient | 175.0 |
| Coordinate Ymax+ in Y direction of positive-side outermost off-axis image | 107.0 |
| height 71 | |
| Coordinate Ymax− in Y direction of negative-side outermost off-axis image | −107.0 |
| height 72 | |
| Printed width Ywidth = (Ymax+) − (Ymax−) on surface to be scanned 7 | 214.0 |
| Maximum angle of view θmax+ [°] corresponding to positive-side outermost | 35.0 |
| off-axis image height 71 | |
| Maximum angle of view θmax− [°] corresponding to negative-side outermost | −35.0 |
| off-axis image height 72 | |
| Angle of view θBD [°] of synchronization detection light flux | 70.0 |

TABLE 51

| | Surface | | | | | | | | |
|---|---|---|---|---|---|---|---|---|---|
| | number | R | N | x | y | z | gx(x) | gx(y) | gx(z) |
| Light emitting point | 1 | 0.000 | −1.511 | 0.000 | 50.000 | 0.000 | 0.000 | 1.000 | 0.000 |
| of light source 1 | | | | | | | | | |
| | 2 | 0.000 | −1.000 | 0.000 | 49.750 | 0.000 | 0.000 | 1.000 | 0.000 |
| Sub-scanning stop 2 | 3 | 0.000 | −1.000 | 0.000 | 34.000 | 0.000 | 0.000 | 1.000 | 0.000 |
| Incident surface of | 4 | aspherical | −1.529 | 0.000 | 31.000 | 0.000 | 0.000 | 1.000 | 0.000 |
| anamorphic collimator lens 3 | | | | | | | | | |
| Exit surface of anamorphic | 5 | aspherical | −1.000 | 0.000 | 29.000 | 0.000 | 0.000 | 1.000 | 0.000 |
| collimator lens 3 | | | | | | | | | |
| Main scanning stop 4 | 6 | 0.000 | 1.000 | 0.000 | 20.000 | 0.000 | 0.000 | 1.000 | 0.000 |
| Deflecting surface 51 of | 7 | 0.000 | 1.000 | 0.760 | −1.020 | 0.000 | 0.849 | 0.528 | 0.000 |
| polygon mirror 5 | | | | | | | | | |
| Incident surface of scanning | 8 | aspherical | 1.529 | 16.000 | 0.000 | 0.000 | 1.000 | 0.000 | 0.000 |
| imaging lens 61 | | | | | | | | | |
| Exit surface of scanning | 9 | aspherical | 1.000 | 21.000 | 0.000 | 0.000 | 1.000 | 0.000 | 0.000 |
| imaging lens 61 | | | | | | | | | |
| Incident surface of scanning | 10 | aspherical | 1.529 | 51.000 | 0.000 | 0.000 | 1.000 | 0.000 | 0.000 |
| imaging lens 62 | | | | | | | | | |
| Exit surface of scanning | 11 | aspherical | 1.000 | 56.000 | 0.000 | 0.000 | 1.000 | 0.000 | 0.000 |
| imaging lens 62 | | | | | | | | | |
| Surface to be scanned 7 | 12 | 0.000 | 1.000 | 208.000 | 0.000 | 0.000 | 1.000 | 0.000 | 0.000 |
| Aperture width in sub- | 1.560 | | | | | | | | |
| scanning direction of sub- | | | | | | | | | |
| scanning stop 2 | | | | | | | | | |
| Aperture width in main | 2.880 | | | | | | | | |
| scanning direction of main | | | | | | | | | |
| scanning stop 4 | | | | | | | | | |

TABLE 52
Incident surface of anamorphic collimator lens 3

| r | k | C2 | C4 | C6 | C8 | C10 |
|---|---|---|---|---|---|---|
| 0.00E+00 | 0.00E+00 | 0.00E+00 | 0.00E+00 | 0.00E+00 | 0.00E+00 | 0.00E+00 |

Exit surface of anamorphic collimator lens 3

| Ru | Ku | B2u | B4u | B6u | B8u | B10u |
|---|---|---|---|---|---|---|
| 1.07E+01 | 0.00E+00 | 0.00E+00 | −6.19E−05 | 0.00E+00 | 0.00E+00 | 0.00E+00 |
| Rl | Kl | B2l | B4l | B6l | B8l | B10l |
| 1.07E+01 | 0.00E+00 | 0.00E+00 | −6.19E−05 | 0.00E+00 | 0.00E+00 | 0.00E+00 |

| ru | E2u | E4u | E6u | E8u | E10u |
|---|---|---|---|---|---|
| 0.00E+00 | 0.00E+00 | 0.00E+00 | 0.00E+00 | 0.00E+00 | 0.00E+00 |
| rl | E2l | E4l | E6l | E8l | E10l |
| 0.00E+00 | 0.00E+00 | 0.00E+00 | 0.00E+00 | 0.00E+00 | 0.00E+00 |

| E1 | E3 | E5 |
|---|---|---|
| 0.00E+00 | 0.00E+00 | 0.00E+00 |

TABLE 53
Incident surface of scanning imaging lens 61

| Ru | Ku | B2u | B4u | B6u | B8u | B10u |
|---|---|---|---|---|---|---|
| −2.63E+01 | 1.39E−02 | 0.00E+00 | 3.85E−05 | 3.05E−08 | −4.37E−10 | 3.30E−13 |
| Rl | Kl | B2l | B4l | B6l | B8l | B10l |
| −2.63E+01 | 1.39E−02 | 0.00E+00 | 3.85E−05 | 3.05E−08 | −4.37E−10 | 3.30E−13 |

| ru | E2u | E4u | E6u | E8u | E10u |
|---|---|---|---|---|---|
| 1.07E+02 | 0.00E+00 | 0.00E+00 | 0.00E+00 | 0.00E+00 | 0.00E+00 |
| rl | E2l | E4l | E6l | E8l | E10l |
| 1.07E+02 | 0.00E+00 | 0.00E+00 | 0.00E+00 | 0.00E+00 | 0.00E+00 |

| E1 | E3 | E5 |
|---|---|---|
| 0.00E+00 | 0.00E+00 | 0.00E+00 |

Exit surface of scanning imaging lens 61

| Ru | Ku | B2u | B4u | B6u | B8u | B10u |
|---|---|---|---|---|---|---|
| −2.16E+01 | −2.46E+00 | 0.00E+00 | −1.12E−06 | 7.58E−08 | −2.00E−10 | −1.52E−13 |
| Rl | Kl | B2l | B4l | B6l | B8l | B10l |
| −2.16E+01 | −2.46E+00 | 0.00E+00 | −1.12E−06 | 7.58E−08 | −2.00E−10 | −1.52E−13 |

| ru | E2u | E4u | E6u | E8u | E10u |
|---|---|---|---|---|---|
| −1.65E+01 | 0.00E+00 | 0.00E+00 | 0.00E+00 | 0.00E+00 | 0.00E+00 |
| rl | E2l | E4l | E6l | E8l | E10l |
| −1.65E+01 | 0.00E+00 | 0.00E+00 | 0.00E+00 | 0.00E+00 | 0.00E+00 |

| E1 | E3 | E5 |
|---|---|---|
| 0.00E+00 | 0.00E+00 | 0.00E+00 |

Incident surface of scanning imaging lens 62

| Ru | Ku | B2u | B4u | B6u | B8u | B10u |
|---|---|---|---|---|---|---|
| −4.71E+02 | 0.00E+00 | 0.00E+00 | 0.00E+00 | 0.00E+00 | 0.00E+00 | 0.00E+00 |
| Rl | Kl | B2l | B4l | B6l | B8l | B10l |
| −4.71E+02 | 0.00E+00 | 0.00E+00 | 0.00E+00 | 0.00E+00 | 0.00E+00 | 0.00E+00 |

| ru | E2u | E4u | E6u | E8u | E10u |
|---|---|---|---|---|---|
| −5.14E+03 | 2.33E−02 | 3.77E−03 | −4.28E−05 | 0.00E+00 | 0.00E+00 |

| rl | E2l | E4l | E6l | E8l | E10l |
|---|---|---|---|---|---|
| −5.14E+03 | 3.04E−04 | −3.31E−06 | 2.08E−09 | 0.00E+00 | 0.00E+00 |

| E1 | E3 | E5 |
|---|---|---|
| 0.00E+00 | 0.00E+00 | 0.00E+00 |

Exit surface of scanning imaging lens 62

| Ru | Ku | B2u | B4u | B6u | B8u | B10u |
|---|---|---|---|---|---|---|
| −6.78E+02 | 1.03E+01 | 0.00E+00 | −2.38E−06 | 1.24E−09 | −5.09E−13 | 1.12E−16 |
| Rl | Kl | B2l | B4l | B6l | B8l | B10l |
| −6.78E+02 | 1.03E+01 | 0.00E+00 | −2.38E−06 | 1.24E−09 | −5.09E−13 | 1.12E−16 |

| ru | E2u | E4u | E6u | E8u | E10u |
|---|---|---|---|---|---|
| −3.11E+01 | 5.24E−05 | −4.29E−08 | 1.29E−10 | −6.46E−14 | 0.00E+00 |
| rl | E2l | E4l | E6l | E8l | E10l |
| −3.11E+01 | 7.63E−05 | −4.25E−08 | 2.02E−10 | −1.93E−13 | 0.00E+00 |

| E1 | E3 | E5 |
|---|---|---|
| 0.00E+00 | 0.00E+00 | 0.00E+00 |

TABLE 54

| | Surface | | | | | | | | |
|---|---|---|---|---|---|---|---|---|---|
| | number | R | N | X | y | Z | gx(x) | gx(y) | gx(z) |
| Light source 1 | 1 to 6 | Common | Common | Common | Common | Common | Common | Common | Common |
| to main | | | | | | | | | |
| scanning stop 4 | | | | | | | | | |
| Deflecting | 7 | 0.000 | 1.0000 | −4.015 | 2.207 | 0.000 | 0.174 | 0.985 | 0.000 |
| surface 51 of | | | | | | | | | |
| polygon mirror 5 | | | | | | | | | |
| Incident surface | 8 | 12.100 | 1.5287 | 9.594 | 27.857 | 0.000 | 0.342 | 0.940 | 0.000 |
| of synchronization | | | | | | | | | |
| detection imaging | | | | | | | | | |
| element 81 | | | | | | | | | |
| Exit surface of | 9 | 0.000 | 1.0000 | 10.278 | 29.737 | 0.000 | 0.342 | 0.940 | 0.000 |
| synchronization | | | | | | | | | |
| detection imaging | | | | | | | | | |
| element 81 | | | | | | | | | |
| Synchronization | 10 | 0.000 | 1.0000 | 17.655 | 50.006 | 0.000 | — | — | — |
| detection light | | | | | | | | | |
| receiving | | | | | | | | | |
| element 80 | | | | | | | | | |

TABLE 55

| | |
|---|---|
| Diameter φ [mm] of circumscribed circle in main scanning cross section of | 20 |
| polygon mirror 5 | |
| Number N of deflecting surface 51 of polygon mirror 5 | 4 |
| Width in main scanning cross section of deflecting surface 51 of polygon | 14.142 |
| mirror 5 [mm] | |
| Diameter φin [mm] of inscribed circle in main scanning cross section of | 14.142 |
| polygon mirror 5 | |
| Distance φin/2 between center of polygon mirror 5 and end in main scanning | 7.071 |
| direction of deflecting surface 51 | |
| Coordinate in X direction of rotation center of polygon mirror 5 | −5.243 |
| Coordinate in Y direction of rotation center of polygon mirror 5 | −4.757 |

As shown in FIG. 11B, in the light scanning apparatus 800 according to the present embodiment, Inequalities (1) and (1′) are satisfied.

Further, as shown in FIG. 11B, any light flux for scanning each image height on the surface to be scanned 7 has the light flux width of 90% or more of the width Wᵢ of the incident light flux Lᵢ in the light scanning apparatus 800 according to the present embodiment.

The light scanning apparatus according to the comparative example has the same structure as that of the light scanning apparatus 800 according to the present embodiment except that the light scanning apparatus according to the comparative example uses the polygon mirror 5 with four surfaces in which the number of deflecting surfaces 51 is smaller by one than that of the light scanning apparatus 800 according to the present embodiment. Therefore, the same members are denoted by the same reference numerals, and description thereof is omitted.

Next, the value of each Inequality in the light scanning apparatus 800 according to the present embodiment and the light scanning apparatus according to the comparative example is shown in the following Table 56.

TABLE 56

| | Eighth | Comparative |
|---|---|---|
| | embodiment | example |
| Inequalities | | |
| Inequality (2): 5.50 ≤ φ − K × N × (N − 1) ≤ 13.00 (K = 0.52) | 7.08 | 13.76 |
| Inequality (2): 5.50 ≤ φ − K × N × (N − 1) ≤ 13.00 (K = 0.54) | 6.68 | 13.52 |
| Inequality (2): 5.50 ≤ φ − K × N × (N − 1) ≤ 13.00 (K = 0.56) | 6.28 | 13.28 |
| Inequality (3): 6.00 < (φ + 15)/N < 7.40 | 6.50 | 8.75 |
| Inequality (3a): 6.20 < (φ + 15)/N < 7.20 | | |
| Inequality (4): 22.60 < Ymax+/(φ/N) < 37.00 | 30.61 | 21.40 |
| Inequality (4a): 27.00 < Ymax+/(φ/N) < 34.00 | | |
| Inequality (5): 1.78 < (θi + θmax+)/θBD < 2.33 | 1.79 | 1.79 |
| Inequality (7): 360/N − 45 < θBD − θmax+ < (360/N)/2 | | |
| Eighth embodiment: 27 < θBD − θmax+ < 36 | 34.97 | |
| Comparative example: 45 < θBD − θmax+ < 45 | | 34.97 |
| With respect to Inequality (1): WBD < Wmax− < Wmax+ | | |
| and Inequality (1′): Wmax+ = Wi | | |
| Width Wi of incident light flux Li | 2.88 | 2.88 |
| Width WBD of synchronization detection light flux | 2.48 | 2.88 |
| Width Wmax+ of light flux traveling to positive-side | 2.88 | 2.88 |
| outermost off-axis image height 71 | | |
| Width Wcenter of light flux traveling to on-axis image | 2.88 | 2.88 |
| height 70 | | |
| Width Wmax− of light flux traveling to negative-side | 2.78 | 2.88 |
| outermost off-axis image height 72 | | |
| Angle θBD [°] of scanning light flux LBD | 70.0 | 70.0 |
| Angle θBD − 360/N × 2 [°] of scanning light flux LBD2 | −74.0 | x |
| Angle θmax+ [°] of scanning light flux Lmax+ | 35.0 | 35.0 |
| Angle θmax− [°] of scanning light flux Lmax− | −35.0 | −35.0 |
| Angle θmax− + 360/N × 2 [°] of scanning light | 109.0 | x |
| flux Lmax− 2 | | |

As shown in Tables 50 and 55, the width in the main scanning cross section of the deflecting surface 51 of the polygon mirror 5 is considerably larger in the light scanning apparatus according to the comparative example than in the light scanning apparatus 800 according to the present embodiment.

Therefore, as shown in Table 56, the width W_{BD} of the synchronization detection light flux and the width Wₘₐₓ₋ of the scanning light flux Lₘₐₓ₋ traveling to the negative side outermost off-axis image height 72 are the same as the width Wᵢ of the incident light flux Lᵢ, namely are not reduced in the light scanning apparatus according to the comparative example.

On the other hand, a diameter of the circumscribed circle as an outer shape of the polygon mirror 5 is smaller in the light scanning apparatus 800 according to the present embodiment than in the light scanning apparatus according to the comparative example.

That is, downsizing of the polygon mirror 5 is achieved in the light scanning apparatus 800 according to the present embodiment, so that it is possible to downsize the light scanning apparatus 800 according to the present embodiment and the image forming apparatus in which the light scanning apparatus 800 is mounted.

Further, since the polygon mirror 5 can be reduced in size, the polygon motor for rotationally driving the polygon mirror 5 can also be reduced in size.

This is because a rotational moment of the polygon mirror 5 increases as the size in the main scanning cross section of the polygon mirror 5 increases.

Furthermore, it is also possible to reduce a power consumption of the polygon motor along with the downsizing of the polygon motor due to the downsizing of the polygon mirror 5.

In addition, when the diameter of the circumscribed circle of the polygon mirror 5 decreases, a wind noise generated from the polygon mirror 5 decreases, so that a structure for shielding the wind noise can be simplified and downsized.

As described above, the light scanning apparatus 800 according to the present embodiment can be reduced in size.

As shown in Table 56, both of Inequality (2) in the case where K is a constant of 0.52 or more and 0.56 or less and Inequality (2) in the case where K is a constant of 0.53 or more and 0.55 or less are satisfied in the light scanning apparatus 800 according to the present embodiment.

On the other hand, in the light scanning apparatus according to the comparative example, any of Inequality (2) in the case where K is a constant of 0.52 or more and 0.56 or less and Inequality (2) in the case where K is a constant of 0.53 or more and 0.55 or less is not satisfied.

Further, Inequalities (3), (3a), (4), (4a) and (7) are satisfied in the light scanning apparatus 800 according to the present embodiment, but are not satisfied in the light scanning apparatus according to the comparative example.

Inequality (5) is satisfied in the light scanning apparatus 800 according to the present embodiment.

Inequality (1) is satisfied in the light scanning apparatus 800 according to the present embodiment, but is not satisfied in the light scanning apparatus according to the comparative example.

Inequality (1′) is satisfied in the light scanning apparatus 800 according to the present embodiment.

As described above, the size of the light scanning apparatus 800 according to the present embodiment can be reduced by satisfying each Inequality.

Further, as shown in Table 56, any of the angle (θ_{BD}−360/N×2) of the scanning light flux L_{BD2} and the angle (θₘₐₓ₋+360/N×2) of the scanning light flux Lₘₐₓ₋₂ is not within a range between the angle θₘₐₓ₊ and the angle θₘₐₓ₋ in the light scanning apparatus 800 according to the present embodiment.

Therefore, in the light scanning apparatus 800 according to the present embodiment, both of the scanning light flux L_{BD2} and the scanning light flux Lₘₐₓ₋₂ can be shielded by a member such as a housing, ribs other than the optical surface of the two scanning imaging lenses 61 and 62, or the like.

Even if the scanning light flux L_{BD2} or the scanning light flux Lₘₐₓ₋₂ is incident on the two scanning imaging lenses 61 and 62, the scanning light flux L_{BD2} or the scanning light flux Lₘₐₓ₋₂ does not reach the printed area of the surface to be scanned 7, so that there is no problem in printing.

As described above, in the light scanning apparatus 800 according to the present embodiment, it is possible to reduce the size of the polygon mirror 5, to reduce the size of the polygon motor by reducing the weight of the polygon mirror 5, and to simplify a soundproof member, compared to the light scanning apparatus according to the comparative example and a light scanning apparatus of the related art.

Thereby, the size of the light scanning apparatus 800 according to the present embodiment can be reduced, so that it is possible to provide a compact light scanning apparatus suitable for high-quality image recording and an image forming apparatus equipped with the light scanning apparatus.

### Ninth Embodiment

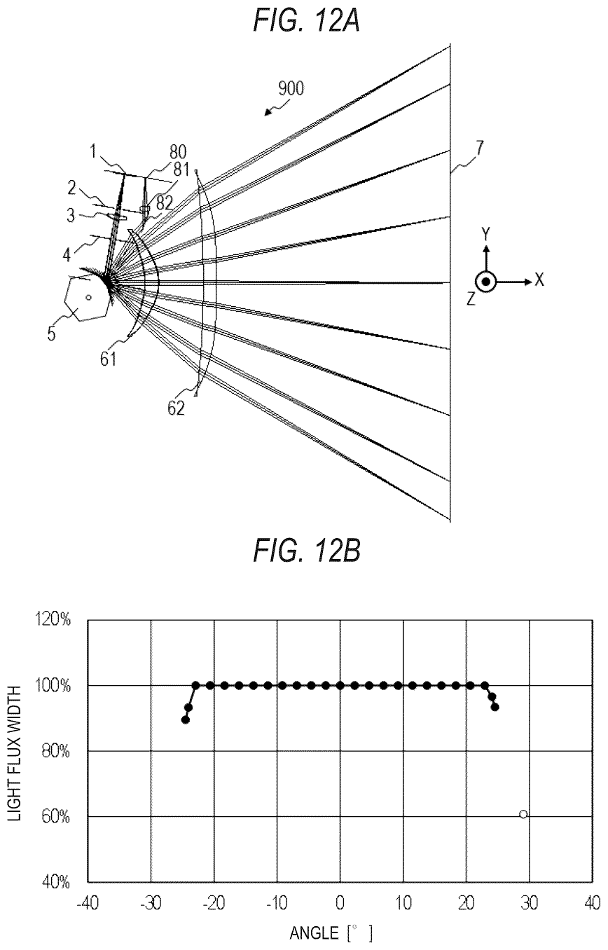

FIG. 12A shows a schematic main scanning cross sectional view of a light scanning apparatus 900 according to a ninth embodiment of the present invention. In FIG. 12A, the electrical mounting substrate 83 is not shown.

Further, FIG. 12B shows an angle dependence of a light flux width in the main scanning cross section of a light flux deflected by a polygon mirror 5 in the light scanning apparatus 900 according to the ninth embodiment (corresponding to FIG. 3).

Specifically, an angle on a horizontal axis of FIG. 12B is a rotation angle (θₘₐₓ₋/2 to θₘₐₓ₊/2) of a deflecting surface 51 of the polygon mirror 5.

The light scanning apparatus 900 according to the present embodiment has the same structure as the light scanning apparatus 600 according to the sixth embodiment except that each numerical value is different and a synchronization detection reflecting element 82 (reflecting element) is newly provided, so that the same members are denoted by the same reference numerals and the description thereof is omitted.

Main specification values of the light scanning apparatus 900 according to the present embodiment, and the arrangement of each optical element provided in the incident optical system 75 and the imaging optical system 85 are shown in the following Tables 57 and 58, respectively.

An aspherical shape of the anamorphic collimator lens 3, and aspherical shapes of the two scanning imaging lenses 61 and 62 provided in the light scanning apparatus 900 according to the present embodiment are shown in the following Tables 59 and 60, respectively.

An arrangement of each optical element provided in the synchronization detection optical system of the light scanning apparatus 900 according to the present embodiment is shown in the following Table 61.

Main specification values of the light scanning apparatus according to the comparative example is shown in the following Table 62.

TABLE 57

| | |
|---|---|
| Wavelength of light source 1 [nm] | 790 |
| Angle θi [°] between optical axis of imaging optical system 85 and optical | 80.0 |
| axis of incident optical system 75 | |
| Diameter φ [mm] of circumscribed circle in main scanning cross section of | 23.354 |
| polygon mirror 5 | |
| Number N of deflecting surface 51 of polygon mirror 5 | 6 |
| Width in main scanning cross section of deflecting surface 51 of polygon | 11.677 |
| mirror 5 [mm] | |
| Diameter φin [mm] of inscribed circle in main scanning cross section of | 20.225 |
| polygon mirror 5 | |
| Distance φin/2 between center of polygon mirror 5 and end in main scanning | 10.113 |
| direction of deflecting surface 51 | |
| Coordinate in X direction of rotation center of polygon mirror 5 | −8.528 |
| Coordinate in Y direction of rotation center of polygon mirror 5 | −5.570 |
| Fθ coefficient | 125.0 |
| Coordinate Ymax+ in Y direction of positive-side outermost off-axis image | 107.0 |
| height 71 | |
| Coordinate Ymax− in Y direction of negative-side outermost off-axis image | −107.0 |
| height 72 | |
| Printed width Ywidth = (Ymax+) − (Ymax−) on surface to be scanned 7 | 214.0 |
| Maximum angle of view θmax+ [°] corresponding to positive-side outermost | 49.0 |
| off-axis image height 71 | |
| Maximum angle of view θmax− [°] corresponding to negative-side outermost | −49.0 |
| off-axis image height 72 | |
| Angle of view θBD [°] of synchronization detection light flux | 58.1 |

TABLE 58

| | Surface | | | | | | | | |
|---|---|---|---|---|---|---|---|---|---|
| | number | R | N | x | y | z | gx(x) | gx(y) | gx(z) |
| Light emitting point of light | 1 | 0.000 | −1.511 | 8.682 | 49.240 | 0.000 | 0.174 | 0.985 | 0.000 |
| source 1 | | | | | | | | | |
| | 2 | 0.000 | −1.000 | 8.639 | 48.994 | 0.000 | 0.174 | 0.985 | 0.000 |
| Sub-scanning stop 2 | 3 | 0.000 | −1.000 | 5.904 | 33.483 | 0.000 | 0.174 | 0.985 | 0.000 |
| Incident surface of | 4 | aspherical | −1.529 | 5.383 | 30.529 | 0.000 | 0.174 | 0.985 | 0.000 |
| anamorphic collimator lens 3 | | | | | | | | | |
| Exit surface of anamorphic | 5 | aspherical | −1.000 | 5.036 | 28.559 | 0.000 | 0.174 | 0.985 | 0.000 |
| collimator lens 3 | | | | | | | | | |
| Main scanning stop 4 | 6 | 0.000 | 1.000 | 3.473 | 19.696 | 0.000 | 0.174 | 0.985 | 0.000 |
| Deflecting surface 51 of | 7 | 0.000 | 1.000 | 0.871 | −1.836 | 0.000 | 0.929 | 0.369 | 0.000 |
| polygon mirror 5 | | | | | | | | | |
| Incident surface of scanning | 8 | aspherical | 1.529 | 18.000 | 0.000 | 0.000 | 1.000 | 0.000 | 0.000 |
| imaging lens 61 | | | | | | | | | |
| Exit surface of scanning | 9 | aspherical | 1.000 | 24.200 | 0.000 | 0.000 | 1.000 | 0.000 | 0.000 |
| imaging lens 61 | | | | | | | | | |
| Incident surface of scanning | 10 | aspherical | 1.529 | 44.700 | 0.000 | 0.000 | 1.000 | 0.000 | 0.000 |
| imaging lens 62 | | | | | | | | | |
| Exit surface of scanning | 11 | aspherical | 1.000 | 50.500 | 0.000 | 0.000 | 1.000 | 0.000 | 0.000 |
| imaging lens 62 | | | | | | | | | |
| Surface to be scanned 7 | 12 | 0.000 | 1.000 | 157.000 | 0.000 | 0.000 | 1.000 | 0.000 | 0.000 |
| Aperture width in sub- | 1.060 | | | | | | | | |
| scanning direction of sub- | | | | | | | | | |
| scanning stop 2 | | | | | | | | | |
| Aperture width in main | 2.040 | | | | | | | | |
| scanning direction of main | | | | | | | | | |
| scanning stop 4 | | | | | | | | | |

TABLE 59
Incident surface of anamorphic collimator lens 3

| r | k | C2 | C4 | C6 | C8 | C10 |
|---|---|---|---|---|---|---|
| 0.00E+00 | 0.00E+00 | 0.00E+00 | 0.00E+00 | 0.00E+00 | 0.00E+00 | 0.00E+00 |

Exit surface of anamorphic collimator lens 3

| Ru | Ku | B2u | B4u | B6u | B8u | B10u |
|---|---|---|---|---|---|---|
| 1.07E+01 | 0.00E+00 | 0.00E+00 | −3.05E−04 | 0.00E+00 | 0.00E+00 | 0.00E+00 |
| Rl | Kl | B2l | B4l | B6l | B8l | B10l |
| 1.07E+01 | 0.00E+00 | 0.00E+00 | −3.05E−04 | 0.00E+00 | 0.00E+00 | 0.00E+00 |

| ru | E2u | E4u | E6u | E8u | E10u |
|---|---|---|---|---|---|
| 0.00E+00 | 0.00E+00 | 0.00E+00 | 0.00E+00 | 0.00E+00 | 0.00E+00 |
| rl | E2l | E4l | E6l | E8l | E10l |
| 0.00E+00 | 0.00E+00 | 0.00E+00 | 0.00E+00 | 0.00E+00 | 0.00E+00 |

| E1 | E3 | E5 |
|---|---|---|
| 0.00E+00 | 0.00E+00 | 0.00E+00 |

TABLE 60
Incident surface of scanning imaging lens 61

| Ru | Ku | B2u | B4u | B6u | B8u | B10u |
|---|---|---|---|---|---|---|
| −3.08E+01 | −4.36E+00 | 0.00E+00 | −7.78E−06 | 7.22E−08 | −1.88E−10 | 1.35E−13 |
| Rl | Kl | B2l | B4l | B6l | B8l | B10l |
| −3.08E+01 | −4.36E+00 | 0.00E+00 | −7.78E−06 | 7.22E−08 | −1.88E−10 | 1.35E−13 |

| ru | E2u | E4u | E6u | E8u | E10u |
|---|---|---|---|---|---|
| 4.14E+02 | 0.00E+00 | 0.00E+00 | 0.00E+00 | 0.00E+00 | 0.00E+00 |
| rl | E2l | E4l | E6l | E8l | E10l |
| 4.14E+02 | 0.00E+00 | 0.00E+00 | 0.00E+00 | 0.00E+00 | 0.00E+00 |

| E1 | E3 | E5 |
|---|---|---|
| 0.00E+00 | 0.00E+00 | 0.00E+00 |

Exit surface of scanning imaging lens 61

| Ru | Ku | B2u | B4u | B6u | B8u | B10u |
|---|---|---|---|---|---|---|
| −2.11E+01 | −3.97E+00 | 0.00E+00 | −3.64E−05 | 1.20E−07 | −1.67E−10 | 5.06E−14 |
| Rl | Kl | B2l | B4l | B6l | B8l | B10l |
| −2.11E+01 | −3.97E+00 | 0.00E+00 | −3.64E−05 | 1.20E−07 | −1.67E−10 | 5.06E−14 |

| ru | E2u | E4u | E6u | E8u | E10u |
|---|---|---|---|---|---|
| −1.60E+01 | 0.00E+00 | 0.00E+00 | 0.00E+00 | 0.00E+00 | 0.00E+00 |
| rl | E2l | E4l | E6l | E8l | E10l |
| −1.60E+01 | 0.00E+00 | 0.00E+00 | 0.00E+00 | 0.00E+00 | 0.00E+00 |

| E1 | E3 | E5 |
|---|---|---|
| 0.00E+00 | 0.00E+00 | 0.00E+00 |

Incident surface of scanning imaging lens 62

| Ru | Ku | B2u | B4u | B6u | B8u | B10u |
|---|---|---|---|---|---|---|
| −4.36E+02 | 0.00E+00 | 0.00E+00 | 0.00E+00 | 0.00E+00 | 0.00E+00 | 0.00E+00 |
| Rl | Kl | B2l | B4l | B6l | B8l | B10l |
| −4.36E+02 | 0.00E+00 | 0.00E+00 | 0.00E+00 | 0.00E+00 | 0.00E+00 | 0.00E+00 |

| ru | E2u | E4u | E6u | E8u | E10u |
|---|---|---|---|---|---|
| −5.06E+01 | 3.46E−03 | 1.76E−06 | 1.14E−08 | 0.00E+00 | 0.00E+00 |
| rl | E2l | E4l | E6l | E8l | E10l |
| −5.06E+01 | 2.85E−03 | 5.99E−06 | 2.44E−09 | 0.00E+00 | 0.00E+00 |

| E1 | E3 | E5 |
|---|---|---|
| 0.00E+00 | 0.00E+00 | 0.00E+00 |

Exit surface of scanning imaging lens 62

| Ru | Ku | B2u | B4u | B6u | B8u | B10u |
|---|---|---|---|---|---|---|
| 1.34E+03 | −4.38E+04 | 0.00E+00 | −3.22E−06 | 1.23E−09 | −3.04E−13 | 3.35E−17 |
| Rl | Kl | B2l | B4l | B6l | B8l | B10l |
| 1.34E+03 | −4.38E+04 | 0.00E+00 | −3.22E−06 | 1.23E−09 | −3.04E−13 | 3.35E−17 |

| ru | E2u | E4u | E6u | E8u | E10u |
|---|---|---|---|---|---|
| −1.98E+01 | 7.12E−04 | −4.99E−07 | 1.98E−10 | −3.47E−14 | 0.00E+00 |
| rl | E2l | E4l | E6l | E8l | E10l |
| −1.98E+01 | 9.02E−04 | −6.92E−07 | 3.15E−10 | −5.62E−14 | 0.00E+00 |

| E1 | E3 | E5 |
|---|---|---|
| 0.00E+00 | 0.00E+00 | 0.00E+00 |

TABLE 61

| | Surface | | | | | | | | |
|---|---|---|---|---|---|---|---|---|---|
| | number | R | N | x | y | z | gx(x) | gx(y) | gx(z) |
| Light source 1 | 1 to 6, 8 | Common | Common | Common | Common | Common | Common | Common | Common |
| to main | to 9 | | | | | | | | |
| scanning stop 4 | | | | | | | | | |
| Deflecting | 7 | 0.000 | 1.0000 | −4.912 | 3.875 | 0.000 | 0.358 | 0.934 | 0.000 |
| surface 51 of | | | | | | | | | |
| polygon mirror 5 | | | | | | | | | |
| Synchronization | 10 | 0.000 | −1.0000 | 18.000 | 27.387 | 0.000 | 0.934 | −0.358 | 0.000 |
| detection | | | | | | | | | |
| reflecting | | | | | | | | | |
| element 82 | | | | | | | | | |
| Incident surface | 11 | −8.500 | −1.5287 | 18.000 | 32.387 | 0.000 | 0.000 | −1.000 | 0.000 |
| of synchronization | | | | | | | | | |
| detection imaging | | | | | | | | | |
| element 81 | | | | | | | | | |
| Exit surface of | 12 | 0.000 | −1.0000 | 18.000 | 34.387 | 0.000 | 0.000 | −1.000 | 0.000 |
| synchronization | | | | | | | | | |
| detection imaging | | | | | | | | | |
| element 81 | | | | | | | | | |
| Synchronization | 13 | 0.000 | −1.0000 | 18.000 | 47.587 | 0.000 | — | — | — |
| detection light | | | | | | | | | |
| receiving | | | | | | | | | |
| element 80 | | | | | | | | | |

TABLE 62

| | |
|---|---|
| Diameter φ [mm] of circumscribed circle in main scanning cross section of | 25 |
| polygon mirror 5 | |
| Number N of deflecting surface 51 of polygon mirror 5 | 5 |
| Width in main scanning cross section of deflecting surface 51 of polygon | 14.695 |
| mirror 5 [mm] | |
| Diameter φin [mm] of inscribed circle in main scanning cross section of | 20.225 |
| polygon mirror 5 | |
| Distance φin/2 between center of polygon mirror 5 and end in main scanning | 10.113 |
| direction of deflecting surface 51 | |
| Coordinate in X direction of rotation center of polygon mirror 5 | −8.528 |
| Coordinate in Y direction of rotation center of polygon mirror 5 | −5.570 |

As shown in FIG. 12B, in the light scanning apparatus 900 according to the present embodiment. Inequality (1) is satisfied.

Further, as shown in FIG. 12B, any light flux for scanning each image height on the surface to be scanned 7 has the light flux width of 90% or more of the width Wᵢ of the incident light flux Lᵢ in the light scanning apparatus 900 according to the present embodiment.

The light scanning apparatus according to the comparative example has the same structure as that of the light scanning apparatus 900 according to the present embodiment except that the light scanning apparatus according to the comparative example uses the polygon mirror 5 with five surfaces in which the number of deflecting surfaces 51 is smaller by one than that of the light scanning apparatus 900 according to the present embodiment. Therefore, the same members are denoted by the same reference numerals, and description thereof is omitted.

Next, the value of each Inequality in the light scanning apparatus 900 according to the present embodiment and the light scanning apparatus according to the comparative example is shown in the following Table 63.

TABLE 63

| | Ninth | Comparative |
|---|---|---|
| | embodiment | example |
| Inequalities | | |
| Inequality (2): 5.50 ≤ φ − K × N × (N − 1) ≤ 13.00 (K = 0.52) | 7.75 | 14.6 |
| Inequality (2): 5.50 ≤ φ − K × N × (N − 1) ≤ 13.00 (K = 0.54) | 7.15 | 14.20 |
| Inequality (2): 5.50 ≤ φ − K × N × (N − 1) ≤ 13.00 (K = 0.56) | 6.55 | 13.8 |
| Inequality (3): 6.00 < (φ + 15)/N < 7.40 | 6.39 | 8.00 |
| Inequality (3a): 6.20 < (φ + 15)/N < 7.20 | | |
| Inequality (4): 22.60 < Ymax+/(φ/N) < 37.00 | 27.49 | 21.40 |
| Inequality (4a): 27.00 < Ymax+/(φ/N) < 34.00 | | |
| Inequality (5): 1.78 < (θi + θmax+)/θBD < 2.33 | 2.22 | 2.22 |
| Inequality (8): 0.145 < (θBD − θmax+)/(360/N) < 0.182 | 0.151 | 0.126 |
| Inequality (8a): 0.148 < (θBD − θmax+)/(360/N) < 0.173 | | |
| With respect to Inequality (1): WBD < Wmax− < Wmax+ | | |
| and Inequality (1′): Wmax+ = Wi | | |
| Width Wi of incident light flux Li | 2.06 | 2.06 |
| Width WBD of synchronization detection light flux | 1.25 | 2.06 |
| Width Wmax+ of light flux traveling to positive-side | 1.93 | 2.06 |
| outermost off-axis image height 71 | | |
| Width Wcenter of light flux traveling to on-axis image | 2.06 | 2.06 |
| height 70 | | |
| Width Wmax− of light flux traveling to negative-side | 1.85 | 2.06 |
| outermost off-axis image height 72 | | |
| Angle θBD [°] of scanning light flux LBD | 58.1 | 58.1 |
| Angle θBD − 360/N × 2 [°] of scanning light flux LBD2 | −61.9 | x |
| Angle θmax+ [°] of scanning light flux Lmax+ | 49.0 | 49.0 |
| Angle θmax+ − 360/N × 2 of scanning light flux Lmax+ 2 | −71.0 | x |
| Angle θmax− [°] of scanning light flux Lmax− | −49.0 | −49.0 |
| Angle θmax− + 360/N × 2 [°] of scanning light | 71.0 | x |
| flux Lmax− 2 | | |
| Inequality (12): θBD < θi ≤ θBDm | | |
| θBD | 58.1 | |
| θi | 80.0 | |
| θBDm | 90.0 | |

As shown in FIG. 12A, in the light scanning apparatus 900 according to the present embodiment, the scanning light flux L_{BD} deflected by the deflecting surface 51 of the polygon mirror 5 when scanning the synchronization detection light receiving element 80 passes through the scanning imaging lens 61, and is then reflected by the synchronization detection reflecting element 82.

A traveling direction of the scanning light flux L_{BDm} reflected by the synchronization detection reflecting element 82 is parallel to the Y direction, namely forms an angle of 90° with respect to the optical axis of the imaging optical system 85.

Therefore, as shown in Table 63, Inequality (12) is satisfied in the light scanning apparatus 900 according to the present embodiment.

As shown in Tables 57 and 62, the width in the main scanning cross section of the deflecting surface 51 of the polygon mirror 5 is considerably larger in the light scanning apparatus according to the comparative example than in the light scanning apparatus 900 according to the present embodiment.

Therefore, as shown in Table 63, the width W_{BD} of the synchronization detection light flux is the same as the width Wᵢ of the incident light flux Lᵢ, namely is not reduced in the light scanning apparatus according to the comparative example.

Further, as shown in Table 63, the width Wₘₐₓ₊ of the scanning light flux Lₘₐₓ₊ traveling to the positive-side outermost off-axis image height 71 and the width Wₘₐₓ₋ of the scanning light flux Lₘₐₓ₋ traveling to the negative-side outermost off-axis image height 72 are the same as the width Wᵢ of the incident light flux Lᵢ in the light scanning apparatus according to the comparative example.

On the other hand, a diameter of the circumscribed circle as an outer shape of the polygon mirror 5 is smaller in the light scanning apparatus 900 according to the present embodiment than in the light scanning apparatus according to the comparative example.

That is, downsizing of the polygon mirror 5 is achieved in the light scanning apparatus 900 according to the present embodiment, so that it is possible to downsize the light scanning apparatus 900 according to the present embodiment and the image forming apparatus in which the light scanning apparatus 900 is mounted.

Further, since the polygon mirror 5 can be reduced in size, the polygon motor for rotationally driving the polygon mirror 5 can also be reduced in size.

This is because a rotational moment of the polygon mirror 5 increases as the size in the main scanning cross section of the polygon mirror 5 increases.

Furthermore, it is also possible to reduce a power consumption of the polygon motor along with the downsizing of the polygon motor due to the downsizing of the polygon mirror 5.

In addition, when the diameter of the circumscribed circle of the polygon mirror 5 decreases, a wind noise generated from the polygon mirror 5 decreases, so that a structure for shielding the wind noise can be simplified and downsized.

As described above, the light scanning apparatus 900 according to the present embodiment can be reduced in size.

As shown in Table 63, both of Inequality (2) in the case where K is a constant of 0.52 or more and 0.56 or less and Inequality (2) in the case where K is a constant of 0.53 or more and 0.55 or less are satisfied in the light scanning apparatus 900 according to the present embodiment.

On the other hand, in the light scanning apparatus according to the comparative example, any of Inequality (2) in the case where K is a constant of 0.52 or more and 0.56 or less and Inequality (2) in the case where K is a constant of 0.53 or more and 0.55 or less is not satisfied.

Further, Inequalities (3), (3a), (4), (4a), (8) and (8a) are satisfied in the light scanning apparatus 900 according to the present embodiment, but are not satisfied in the light scanning apparatus according to the comparative example.

Inequality (5) is satisfied in the light scanning apparatus 900 according to the present embodiment.

Inequality (1) is satisfied in the light scanning apparatus 900 according to the present embodiment, but is not satisfied in the light scanning apparatus according to the comparative example.

As described above, the size of the light scanning apparatus 900 according to the present embodiment can be reduced by satisfying each Inequality.

Further, as shown in Table 63, any of the angle (θ_{BD}−360/N×2) of the scanning light flux L_{BD2} and the angle (θₘₐₓ₋+360/N×2) of the scanning light flux Lₘₐₓ₋₂ is not within a range between the angle θₘₐₓ₊ and the angle θₘₐₓ₋ in the light scanning apparatus 900 according to the present embodiment.

Further, as shown in Table 63, the angle (θₘₐₓ₊−360/N×2) of the scanning light flux Lₘₐₓ₊₂ is not within a range between the angle θₘₐₓ₊ and the angle θₘₐₓ₋ in the light scanning apparatus 900 according to the present embodiment.

Therefore, in the light scanning apparatus 900 according to the present embodiment, any of the scanning light flux L_{BD2}, the scanning light flux Lₘₐₓ₊₂ and the scanning light flux Lₘₐₓ₋₂ can be shielded by a member such as a housing, ribs other than the optical surface of the two scanning imaging lenses 61 and 62, or the like.

Even if the scanning light flux L_{BD2}, the scanning light flux Lₘₐₓ₊₂ or the scanning light flux Lₘₐₓ₋₂ is incident on the two scanning imaging lenses 61 and 62, the scanning light flux L_{BD2}, the scanning light flux Lₘₐₓ₊₂ or the scanning light flux Lₘₐₓ₋₂ does not reach the printed area of the surface to be scanned 7, so that there is no problem in printing.

As described above, in the light scanning apparatus 900 according to the present embodiment, it is possible to reduce the size of the polygon mirror 5, to reduce the size of the polygon motor by reducing the weight of the polygon mirror 5, and to simplify a soundproof member, compared to the light scanning apparatus according to the comparative example and a light scanning apparatus of the related art.

Thereby, the size of the light scanning apparatus 900 according to the present embodiment can be reduced, so that it is possible to provide a compact light scanning apparatus suitable for high-quality image recording and an image forming apparatus equipped with the light scanning apparatus.

### Tenth Embodiment

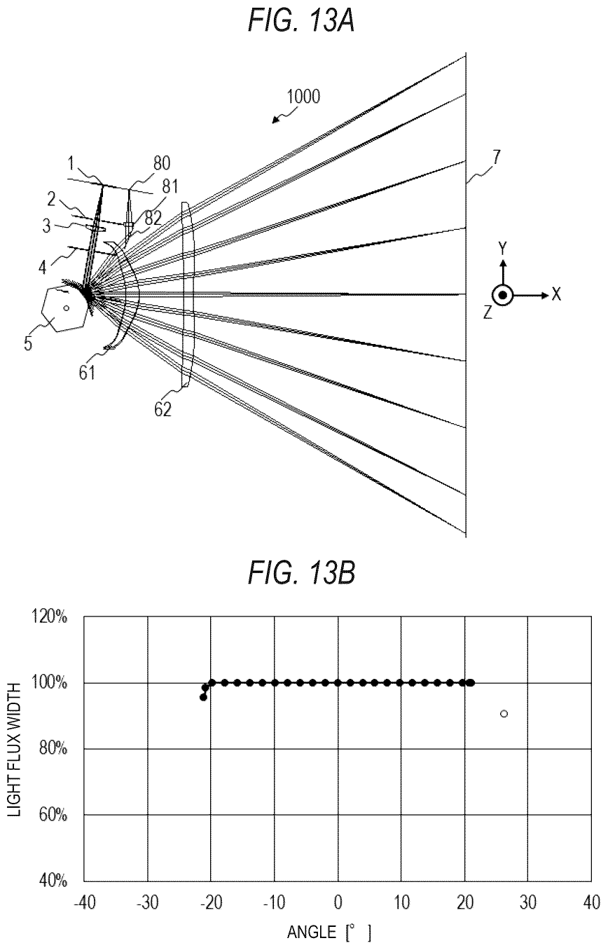

FIG. 13A shows a schematic main scanning cross sectional view of a light scanning apparatus 1000 according to a tenth embodiment of the present invention. In FIG. 13A, the electrical mounting substrate 83 is not shown.

Further, FIG. 13B shows an angle dependence of a light flux width in the main scanning cross section of a light flux deflected by a polygon mirror 5 in the light scanning apparatus 1000 according to the tenth embodiment (corresponding to FIG. 3).

Specifically, an angle on a horizontal axis of FIG. 13B is a rotation angle (θₘₐₓ₋/2 to θₘₐₓ₊/2) of a deflecting surface 51 of the polygon mirror 5.

The light scanning apparatus 1000 according to the present embodiment has the same structure as the light scanning apparatus 900 according to the ninth embodiment except that each numerical value is different, so that the same members are denoted by the same reference numerals and the description thereof is omitted.

Main specification values of the light scanning apparatus 1000 according to the present embodiment, and the arrangement of each optical element provided in the incident optical system 75 and the imaging optical system 85 are shown in the following Tables 64 and 65, respectively.

An aspherical shape of the anamorphic collimator lens 3, and aspherical shapes of the two scanning imaging lenses 61 and 62 provided in the light scanning apparatus 1000 according to the present embodiment are shown in the following Tables 66 and 67, respectively.

An arrangement of each optical element provided in the synchronization detection optical system of the light scanning apparatus 1000 according to the present embodiment is shown in the following Table 68.

Main specification values of the light scanning apparatus according to the comparative example is shown in the following Table 69.

TABLE 64

| | |
|---|---|
| Wavelength of light source 1 [nm] | 790 |
| Angle θi [°] between optical axis of imaging optical system 85 and optical | 80.0 |
| axis of incident optical system 75 | |
| Diameter φ [mm] of circumscribed circle in main scanning cross section of | 23.354 |
| polygon mirror 5 | |
| Number N of deflecting surface 51 of polygon mirror 5 | 6 |
| Width in main scanning cross section of deflecting surface 51 of polygon | 11.677 |
| mirror 5 [mm] | |
| Diameter φin [mm] of inscribed circle in main scanning cross section of | 20.225 |
| polygon mirror 5 | |
| Distance φin/2 between center of polygon mirror 5 and end in main scanning | 10.113 |
| direction of deflecting surface 51 | |
| Coordinate in X direction of rotation center of polygon mirror 5 | −8.258 |
| Coordinate in Y direction of rotation center of polygon mirror 5 | −5.891 |
| Fθ coefficient | 145.0 |
| Coordinate Ymax+ in Y direction of positive-side outermost off-axis image | 107.0 |
| height 71 | |
| Coordinate Ymax− in Y direction of negative-side outermost off-axis image | −107.0 |
| height 72 | |
| Printed width Ywidth = (Ymax+) − (Ymax−) on surface to be scanned 7 | 214.0 |
| Maximum angle of view θmax+ [°] corresponding to positive-side outermost | 42.3 |
| off-axis image height 71 | |
| Maximum angle of view θmax− [°] corresponding to negative-side outermost | −42.3 |
| off-axis image height 72 | |
| Angle of view OBD [°] of synchronization detection light flux | 52.6 |

TABLE 65

| | Surface | | | | | | | | |
|---|---|---|---|---|---|---|---|---|---|
| | number | R | N | x | y | z | gx(x) | gx(y) | gx(z) |
| Light emitting point of light | 1 | 0.000 | −1.511 | 8.682 | 49.240 | 0.000 | 0.174 | 0.985 | 0.000 |
| source 1 | | | | | | | | | |
| | 2 | 0.000 | −1.000 | 8.639 | 48.994 | 0.000 | 0.174 | 0.985 | 0.000 |
| Sub-scanning stop 2 | 3 | 0.000 | −1.000 | 5.904 | 33.483 | 0.000 | 0.174 | 0.985 | 0.000 |
| Incident surface of | 4 | aspherical | −1.529 | 5.383 | 30.529 | 0.000 | 0.174 | 0.985 | 0.000 |
| anamorphic collimator lens 3 | | | | | | | | | |
| Exit surface of anamorphic | 5 | aspherical | −1.000 | 5.036 | 28.559 | 0.000 | 0.174 | 0.985 | 0.000 |
| collimator lens 3 | | | | | | | | | |
| Main scanning stop 4 | 6 | 0.000 | 1.000 | 3.473 | 19.696 | 0.000 | 0.174 | 0.985 | 0.000 |
| Deflecting surface 51 of | 7 | 0.000 | 1.000 | 0.966 | −1.746 | 0.000 | 0.912 | 0.410 | 0.000 |
| polygon mirror 5 | | | | | | | | | |
| Incident surface of scanning | 8 | aspherical | 1.529 | 19.000 | 0.000 | 0.000 | 1.000 | 0.000 | 0.000 |
| imaging lens 61 | | | | | | | | | |
| Exit surface of scanning | 9 | aspherical | 1.000 | 25.000 | 0.000 | 0.000 | 1.000 | 0.000 | 0.000 |
| imaging lens 61 | | | | | | | | | |
| Incident surface of scanning | 10 | aspherical | 1.529 | 45.000 | 0.000 | 0.000 | 1.000 | 0.000 | 0.000 |
| imaging lens 62 | | | | | | | | | |
| Exit surface of scanning | 11 | aspherical | 1.000 | 49.500 | 0.000 | 0.000 | 1.000 | 0.000 | 0.000 |
| imaging lens 62 | | | | | | | | | |
| Surface to be scanned 7 | 12 | 0.000 | 1.000 | 172.500 | 0.000 | 0.000 | 1.000 | 0.000 | 0.000 |
| Aperture width in sub- | 1.220 | | | | | | | | |
| scanning direction of sub- | | | | | | | | | |
| scanning stop 2 | | | | | | | | | |
| Aperture width in main | 2.360 | | | | | | | | |
| scanning direction of main | | | | | | | | | |
| scanning stop 4 | | | | | | | | | |

TABLE 66
Incident surface of anamorphic collimator lens 3

| r | k | C2 | C4 | C6 | C8 | C10 |
|---|---|---|---|---|---|---|
| 0.00E+00 | 0.00E+00 | 0.00E+00 | 0.00E+00 | 0.00E+00 | 0.00E+00 | 0.00E+00 |

Exit surface of anamorphic collimator lens 3

| Ru | Ku | B2u | B4u | B6u | B8u | B10u |
|---|---|---|---|---|---|---|
| 1.07E+01 | 0.00E+00 | 0.00E+00 | −2.97E−05 | 0.00E+00 | 0.00E+00 | 0.00E+00 |
| Rl | Kl | B2l | B4l | B6l | B8l | B10l |
| 1.07E+01 | 0.00E+00 | 0.00E+00 | −2.97E−05 | 0.00E+00 | 0.00E+00 | 0.00E+00 |

| ru | E2u | E4u | E6u | E8u | E10u |
|---|---|---|---|---|---|
| 0.00E+00 | 0.00E+00 | 0.00E+00 | 0.00E+00 | 0.00E+00 | 0.00E+00 |
| rl | E2l | E4l | E6l | E8l | E10l |
| 0.00E+00 | 0.00E+00 | 0.00E+00 | 0.00E+00 | 0.00E+00 | 0.00E+00 |

| E1 | E3 | E5 |
|---|---|---|
| 0.00E+00 | 0.00E+00 | 0.00E+00 |

TABLE 67

Incident surface of scanning imaging lens 61

| Ru | Ku | B2u | B4u | B6u | B8u | B10u |
|---|---|---|---|---|---|---|
| −2.71E+01 | −3.79E+00 | 0.00E+00 | −1.89E−06 | 8.26E−08 | −1.69E−10 | 4.40E−16 |
| Rl | Kl | B2l | B4l | B6l | B8l | B10l |
| −2.71E+01 | −3.79E+00 | 0.00E+00 | −1.89E−06 | 8.26E−08 | −1.69E−10 | 4.40E−16 |

| ru | E2u | E4u | E6u | E8u | E10u |
|---|---|---|---|---|---|
| 1.83E+02 | 0.00E+00 | 0.00E+00 | 0.00E+00 | 0.00E+00 | 0.00E+00 |
| rl | E2l | E4l | E6l | E8l | E10l |
| 1.83E+02 | 0.00E+00 | 0.00E+00 | 0.00E+00 | 0.00E+00 | 0.00E+00 |

| E1 | E3 | E5 |
|---|---|---|
| 0.00E+00 | 0.00E+00 | 0.00E+00 |

Exit surface of scanning imaging lens 61

| Ru | Ku | B2u | B4u | B6u | B8u | B10u |
|---|---|---|---|---|---|---|
| −1.93E+01 | −3.29E+00 | 0.00E+00 | −2.86E−05 | 1.15E−07 | −8.48E−11 | −1.13E−13 |
| Rl | Kl | B2l | B4l | B6l | B8l | B10l |
| −1.93E+01 | −3.29E+00 | 0.00E+00 | −2.86E−05 | 1.15E−07 | −8.48E−11 | −1.13E−13 |

| ru | E2u | E4u | E6u | E8u | E10u |
|---|---|---|---|---|---|
| −1.83E+01 | 0.00E+00 | 0.00E+00 | 0.00E+00 | 0.00E+00 | 0.00E+00 |
| rl | E2l | E4l | E6l | E8l | E10l |
| −1.83E+01 | 0.00E+00 | 0.00E+00 | 0.00E+00 | 0.00E+00 | 0.00E+00 |

| E1 | E3 | E5 |
|---|---|---|
| 0.00E+00 | 0.00E+00 | 0.00E+00 |

Incident surface of scanning imaging lens 62

| Ru | Ku | B2u | B4u | B6u | B8u | B10u |
|---|---|---|---|---|---|---|
| −8.78E+02 | 0.00E+00 | 0.00E+00 | 0.00E+00 | 0.00E+00 | 0.00E+00 | 0.00E+00 |
| Rl | Kl | B2l | B4l | B6l | B8l | B10l |
| −8.78E+02 | 0.00E+00 | 0.00E+00 | 0.00E+00 | 0.00E+00 | 0.00E+00 | 0.00E+00 |

| ru | E2u | E4u | E6u | E8u | E10u |
|---|---|---|---|---|---|
| −6.10E+01 | 5.06E−03 | 4.75E−06 | 4.03E−08 | 0.00E+00 | 0.00E+00 |
| rl | E2l | E4l | E6l | E8l | E10l |
| −6.10E+01 | 4.45E−03 | 9.13E−06 | 3.09E−08 | 0.00E+00 | 0.00E+00 |

| E1 | E3 | E5 |
|---|---|---|
| 0.00E+00 | 0.00E+00 | 0.00E+00 |

Exit surface of scanning imaging lens 62

| Ru | Ku | B2u | B4u | B6u | B8u | B10u |
|---|---|---|---|---|---|---|
| 1.78E+02 | −2.32E+02 | 0.00E+00 | −3.25E−06 | 1.58E−09 | −5.21E−13 | 8.83E−17 |
| Rl | Kl | B2l | B4l | B6l | B8l | B10l |
| 1.78E+02 | −2.32E+02 | 0.00E+00 | −3.25E−06 | 1.58E−09 | −5.21E−13 | 8.83E−17 |

| ru | E2u | E4u | E6u | E8u | E10u |
|---|---|---|---|---|---|
| −2.08E+01 | 1.15E−03 | −1.35E−06 | 8.28E−10 | −1.84E−13 | 0.00E+00 |
| rl | E2l | E4l | E6l | E8l | E10l |
| −2.08E+01 | 1.28E−03 | −1.33E−06 | 6.74E−10 | −8.85E−14 | 0.00E+00 |

| E1 | E3 | E5 |
|---|---|---|
| 0.00E+00 | 0.00E+00 | 0.00E+00 |

TABLE 68

| | Surface | | | | | | | | |
|---|---|---|---|---|---|---|---|---|---|
| | number | R | N | x | y | z | gx(x) | gx(y) | gx(z) |
| Light source 1 | 1 to 6, 8 | Common | Common | Common | Common | Common | Common | Common | Common |
| to main | to 9 | | | | | | | | |
| scanning stop 4 | | | | | | | | | |
| Deflecting | 7 | 0.000 | 1.0000 | −4.193 | 3.369 | 0.000 | 0.402 | 0.916 | 0.000 |
| surface 51 of | | | | | | | | | |
| polygon mirror 5 | | | | | | | | | |
| Synchronization | 10 | 0.000 | −1.0000 | 20.306 | 25.580 | 0.000 | 0.920 | −0.392 | 0.000 |
| detection | | | | | | | | | |
| reflecting | | | | | | | | | |
| element 82 | | | | | | | | | |
| Incident surface | 11 | −8.000 | −1.5287 | 20.306 | 30.580 | 0.000 | 0.000 | −1.000 | 0.000 |
| of synchronization | | | | | | | | | |
| detection imaging | | | | | | | | | |
| element 81 | | | | | | | | | |
| Exit surface of | 12 | 0.000 | −1.0000 | 20.306 | 32.580 | 0.000 | 0.000 | −1.000 | 0.000 |
| synchronization | | | | | | | | | |
| detection imaging | | | | | | | | | |
| element 81 | | | | | | | | | |
| Synchronization | 13 | 0.000 | −1.0000 | 20.306 | 45.780 | 0.000 | — | — | — |
| detection light | | | | | | | | | |
| receiving | | | | | | | | | |
| element 80 | | | | | | | | | |

TABLE 69

| | |
|---|---|
| Diameter φ [mm] of circumscribed circle in main scanning cross section of | 25 |
| polygon mirror 5 | |
| Number N of deflecting surface 51 of polygon mirror 5 | 5 |
| Width in main scanning cross section of deflecting surface 51 of polygon | 14.695 |
| mirror 5 [mm] | |
| Diameter φin [mm] of inscribed circle in main scanning cross section of | 20.225 |
| polygon mirror 5 | |
| Distance φin/2 between center of polygon mirror 5 and end in main scanning | 10.113 |
| direction of deflecting surface 51 | |
| Coordinate in X direction of rotation center of polygon mirror 5 | −8.258 |
| Coordinate in Y direction of rotation center of polygon mirror 5 | −5.891 |

As shown in FIG. 13B, in the light scanning apparatus 1000 according to the present embodiment, Inequalities (1) and (1′) are satisfied.

Further, as shown in FIG. 13B, any light flux for scanning each image height on the surface to be scanned 7 has the light flux width of 90% or more of the width Wᵢ of the incident light flux Lᵢ in the light scanning apparatus 1000 according to the present embodiment.

The light scanning apparatus according to the comparative example has the same structure as that of the light scanning apparatus 1000 according to the present embodiment except that the light scanning apparatus according to the comparative example uses the polygon mirror 5 with five surfaces in which the number of deflecting surfaces 51 is smaller by one than that of the light scanning apparatus 1000 according to the present embodiment. Therefore, the same members are denoted by the same reference numerals, and description thereof is omitted.

Next, the value of each Inequality in the light scanning apparatus 1000 according to the present embodiment and the light scanning apparatus according to the comparative example is shown in the following Table 70.

TABLE 70

| | Tenth | Comparative |
|---|---|---|
| | embodiment | example |
| Inequalities | | |
| Inequality (2): 5.50 ≤ φ − K × N × (N − 1) ≤ 13.00 (K = 0.52) | 7.75 | 14.6 |
| Inequality (2): 5.50 ≤ φ − K × N × (N − 1) ≤ 13.00 (K = 0.54) | 7.15 | 14.20 |
| Inequality (2): 5.50 ≤ φ − K × N × (N − 1) ≤ 13.00 (K = 0.56) | 6.55 | 13.8 |
| Inequality (3): 6.00 < (φ + 15)/N < 7.40 | 6.39 | 8.00 |
| Inequality (3a): 6.20 < (φ + 15)/N < 7.20 | | |
| Inequality (4): 22.60 < Ymax+/(φ/N) < 37.00 | 27.49 | 21.40 |
| Inequality (4a): 27.00 < Ymax+/(φ/N) < 34.00 | | |
| Inequality (5): 1.78 < (θi + θmax+)/θBD < 2.33 | 2.32 | 2.32 |
| Inequality (8): 0.145 < (θBD − θmax+)/(360/N) < 0.182 | 0.172 | 0.143 |
| Inequality (8a): 0.148 < (θBD − θmax+)/(360/N) < 0.173 | | |
| With respect to Inequality (1): WBD < Wmax− < Wmax+ | | |
| and Inequality (1′): Wmax+ = Wi | | |
| Width Wi of incident light flux Li | 2.36 | 2.36 |
| Width WBD of synchronization detection light flux | 2.14 | 2.36 |
| Width Wmax+ of light flux traveling to positive-side | 2.36 | 2.36 |
| outermost off-axis image height 71 | | |
| Width Wcenter of light flux traveling to on-axis image | 2.36 | 2.36 |
| height 70 | | |
| Width Wmax− of light flux traveling to negative-side | 2.25 | 2.36 |
| outermost off-axis image height 72 | | |
| Angle θBD [°] of scanning light flux LBD | 52.6 | 52.6 |
| Angle θBD − 360/N × 2 [°] of scanning light flux LBD2 | −67.4 | x |
| Angle θmax+ [°] of scanning light flux Lmax+ | 42.3 | 42.3 |
| Angle θmax− [°] of scanning light flux Lmax− | −42.3 | −42.3 |
| Angle θmax− + 360/N × 2 [°] of scanning light | 77.7 | x |
| flux Lmax− 2 | | |
| Inequality (12): θBD < θi ≤ θBDm | | |
| θBD | 52.6 | |
| θi | 80.0 | |
| θBDm | 90.0 | |

As shown in FIG. 13A, in the light scanning apparatus 1000 according to the present embodiment, the scanning light flux L_{BD} deflected by the deflecting surface 51 of the polygon mirror 5 when scanning the synchronization detection light receiving element 80 passes through the scanning imaging lens 61, and is then reflected by the synchronization detection reflecting element 82.

A traveling direction of the scanning light flux L_{BDm} reflected by the synchronization detection reflecting element 82 is parallel to the Y direction, namely forms an angle of 90° with respect to the optical axis of the imaging optical system 85.

Therefore, as shown in Table 70, Inequality (12) is satisfied in the light scanning apparatus 1000 according to the present embodiment.

As shown in Tables 64 and 69, the width in the main scanning cross section of the deflecting surface 51 of the polygon mirror 5 is considerably larger in the light scanning apparatus according to the comparative example than in the light scanning apparatus 1000 according to the present embodiment.

Therefore, as shown in Table 70, the width W_{BD} of the synchronization detection light flux and the width Wₘₐₓ₋ of the scanning light flux Lₘₐₓ₋ traveling to the negative-side outermost off-axis image height 72 are the same as the width Wᵢ of the incident light flux Lᵢ, namely are not reduced in the light scanning apparatus according to the comparative example.

On the other hand, a diameter of the circumscribed circle as an outer shape of the polygon mirror 5 is smaller in the light scanning apparatus 1000 according to the present embodiment than in the light scanning apparatus according to the comparative example.

That is, downsizing of the polygon mirror 5 is achieved in the light scanning apparatus 1000 according to the present embodiment, so that it is possible to downsize the light scanning apparatus 1000 according to the present embodiment and the image forming apparatus in which the light scanning apparatus 1000 is mounted.

Further, since the polygon mirror 5 can be reduced in size, the polygon motor for rotationally driving the polygon mirror 5 can also be reduced in size.

This is because a rotational moment of the polygon mirror 5 increases as the size in the main scanning cross section of the polygon mirror 5 increases.

Furthermore, it is also possible to reduce a power consumption of the polygon motor along with the downsizing of the polygon motor due to the downsizing of the polygon mirror 5.

In addition, when the diameter of the circumscribed circle of the polygon mirror 5 decreases, a wind noise generated from the polygon mirror 5 decreases, so that a structure for shielding the wind noise can be simplified and downsized.

As described above, the light scanning apparatus 1000 according to the present embodiment can be reduced in size.

As shown in Table 70, both of Inequality (2) in the case where K is a constant of 0.52 or more and 0.56 or less and Inequality (2) in the case where K is a constant of 0.53 or more and 0.55 or less are satisfied in the light scanning apparatus 1000 according to the present embodiment.

On the other hand, in the light scanning apparatus according to the comparative example, any of Inequality (2) in the case where K is a constant of 0.52 or more and 0.56 or less and Inequality (2) in the case where K is a constant of 0.53 or more and 0.55 or less is not satisfied.

Further, Inequalities (3), (3a), (4), (4a), (8) and (8a) are satisfied in the light scanning apparatus 1000 according to the present embodiment, but are not satisfied in the light scanning apparatus according to the comparative example.

Inequality (5) is satisfied in the light scanning apparatus 1000 according to the present embodiment.

Inequality (1) is satisfied in the light scanning apparatus 1000 according to the present embodiment, but is not satisfied in the light scanning apparatus according to the comparative example.

Inequality (1′) is satisfied in the light scanning apparatus 1000 according to the present embodiment.

As described above, the size of the light scanning apparatus 1000 according to the present embodiment can be reduced by satisfying each Inequality.

Further, as shown in Table 70, any of the angle (θ_{BD}−360/N×2) of the scanning light flux L_{BD2} and the angle (θₘₐₓ₋+360/N×2) of the scanning light flux Lₘₐₓ₋₂ is not within a range between the angle θₘₐₓ₊ and the angle θₘₐₓ₋ in the light scanning apparatus 1000 according to the present embodiment.

Therefore, in the light scanning apparatus 1000 according to the present embodiment, both of the scanning light flux L_{BD2} and the scanning light flux Lₘₐₓ₋₂ can be shielded by a member such as a housing, ribs other than the optical surface of the two scanning imaging lenses 61 and 62, or the like.

Even if the scanning light flux L_{BD2} or the scanning light flux Lₘₐₓ₋₂ is incident on the two scanning imaging lenses 61 and 62, the scanning light flux L_{BD2} or the scanning light flux Lₘₐₓ₋₂ does not reach the printed area of the surface to be scanned 7, so that there is no problem in printing.

As described above, in the light scanning apparatus 1000 according to the present embodiment, it is possible to reduce the size of the polygon mirror 5, to reduce the size of the polygon motor by reducing the weight of the polygon mirror 5, and to simplify a soundproof member, compared to the light scanning apparatus according to the comparative example and a light scanning apparatus of the related art.

Thereby, the size of the light scanning apparatus 1000 according to the present embodiment can be reduced, so that it is possible to provide a compact light scanning apparatus suitable for high-quality image recording and an image forming apparatus equipped with the light scanning apparatus.

Values of Inequalities in each of the light scanning apparatuses according to the first to tenth embodiments are shown in the following Table 71.

TABLE 71

| | First | Second | Third | Fourth | Fifth |
|---|---|---|---|---|---|
| Inequality (2): 5.50 ≤ φ − K × N × (N − 1) ≤ 13.00 (K = 0.52) | 7.08 | 7.08 | 7.08 | 7.75 | 6.63 |
| Inequality (2): 5.50 ≤ φ − K × N × (N − 1) ≤ 13.00 (K = 0.54) | 6.68 | 6.68 | 6.68 | 7.15 | 6.39 |
| Inequality (2): 5.50 ≤ φ − K × N × (N − 1) ≤ 13.00 (K = 0.56) | 6.28 | 6.28 | 6.28 | 6.55 | 6.15 |
| Inequality (3): 6.00 < (φ + 15)/N < 7.40 | 6.50 | 6.50 | 6.50 | 6.39 | 6.97 |
| Inequality (3a): 6.20 < (φ + 15)/N < 7.20 | | | | | |
| Inequality (4): 22.60 < Ymax+/(φ/N) < 37.00 | 30.61 | 30.61 | 30.61 | 27.49 | 33.26 |
| Inequality (4a): 27.00 < Ymax+/(φ/N) < 34.00 | | | | | |
| Inequality (5): 1.78 < (θi + θmax+)/θBD < 2.33 | 2.00 | 2.00 | 2.00 | 2.00 | 1.91 |
| Inequality (6): 0.23 < (θBD − θmax+)/(360/N) < 0.35 | 0.24 | 0.27 | 0.30 | 0.26 | 0.25 |

| | Sixth | Seventh | Eighth | Ninth | Tenth |
|---|---|---|---|---|---|
| Inequality (2): 5.50 ≤ φ − K × N × (N − 1) ≤ 13.00 (K = 0.52) | 12.43 | 12.43 | 7.08 | 7.75 | 7.75 |
| Inequality (2): 5.50 ≤ φ − K × N × (N − 1) ≤ 13.00 (K = 0.54) | 11.83 | 11.83 | 6.68 | 7.15 | 7.15 |
| Inequality (2): 5.50 ≤ φ − K × N × (N − 1) ≤ 13.00 (K = 0.56) | 11.23 | 11.23 | 6.28 | 6.55 | 6.55 |
| Inequality (3): 6.00 < (φ + 15)/N < 7.40 | 7.17 | 7.17 | 6.50 | 6.39 | 6.39 |
| Inequality (3a): 6.20 < (φ + 15)/N < 7.20 | | | | | |
| Inequality (4): 22.60 < Ymax+/(φ + /N) < 37.00 | 22.91 | 22.91 | 30.61 | 27.49 | 27.49 |
| Inequality (4a): 27.00 < Ymax+/(φ + /N) < 34.00 | | | | | |
| Inequality (5): 1.78 < (θi + θmax+)/θBD < 2.33 | 2.14 | 1.98 | 1.79 | 2.22 | 2.32 |
| Inequality (8): 0.145 < (θBD − θmax+)/(360/N) < 0.182 | | | | 0.151 | 0.172 |
| Inequality (8a): 0.148 < (θBD − θmax+)/(360/N) < 0.173 | | | | | |

According to the present disclosure, a compact light scanning apparatus adopting the UFS type can be provided.

### [Image Forming Apparatus]

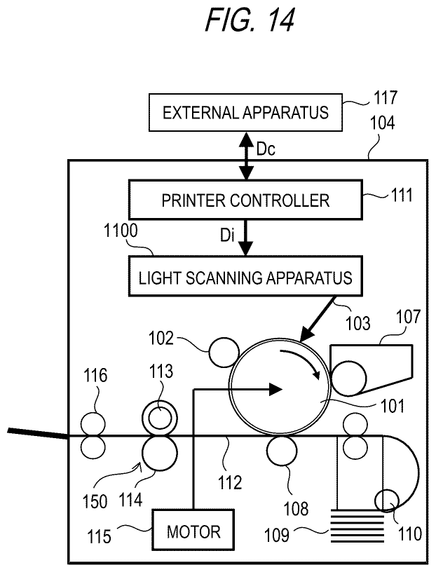

FIG. 14 shows a sub-scanning cross-sectional view of a main part of an image forming apparatus 104 including the light scanning apparatus 1100 according to any one of the first to tenth embodiments of the present invention.

As shown in FIG. 14, code data De output from an external apparatus 117 such as a personal computer is input to the image forming apparatus 104.

The input code data De is converted into image data (dot data) Dᵢ by a printer controller 111 provided in the image forming apparatus 104.

Next, the converted image data Di is input to the light scanning apparatus 1100, light beam 103 modulated in accordance with the image data Di is emitted from the light scanning apparatus 1100, and a photosensitive surface (surface to be scanned) of the photosensitive drum 101 is scanned in the main scanning direction by the light beam 103.

The photosensitive drum 101 as an electrostatic latent image bearing body (photosensitive body) is rotated clockwise as shown in FIG. 14 by a motor 115.

With this rotation, the photosensitive surface of the photosensitive drum 101 moves in the sub-scanning direction orthogonal to the main scanning direction.

A charging roller 102 for uniformly charging the surface of the photosensitive drum 101 is provided above the photosensitive drum 101 so as to be in contact with the surface.

The surface of the photosensitive drum 101 charged by the charging roller 102 is irradiated with the light beam 103 scanned by the light scanning apparatus 1100.

As described above, the light beam 103 is modulated based on the image data Di, and an electrostatic latent image is formed on the surface of the photosensitive drum 101 by irradiation with the light beam 103.

Then, the formed electrostatic latent image is developed as a toner image by a developing unit 107 arranged so as to abut on the photosensitive drum 101 further on the downstream side in the rotation direction from the irradiation position of the light beam 103 on the photosensitive drum 101.

Next, the toner image developed by the developing unit 107 is transferred onto a sheet 112 serving as a transferred material by a transferring roller 108 (transferring unit) arranged below the photosensitive drum 101 so as to face the photosensitive drum 101.

Note that the sheet 112 is stored in a sheet cassette 109 in front of the photosensitive drum 101 (on the right side in FIG. 14), but can be manually fed.

A sheet feeding roller 110 is arranged at an end of the sheet cassette 109, and the sheet 112 in the sheet cassette 109 is fed to a conveyance path.

The sheet 112 onto which the unfixed toner image has been transferred as described above is conveyed to a fixing unit 150 arranged behind the photosensitive drum 101 (on the left side in FIG. 14).

The fixing unit 150 includes a fixing roller 113 having a fixing heater therein, and a pressurizing roller 114 arranged so as to be in pressure contact with the fixing roller 113.

Then, the sheet 112 conveyed from the transferring roller 108 is heated while being pressed by the pressure contact portion between the fixing roller 113 and the pressurizing roller 114, thereby the unfixed toner image on the sheet 112 is fixed.

A sheet discharging roller 116 is arranged behind the fixing unit 150, and the sheet 112 on which the toner image has been fixed is discharged to the outside of the image forming apparatus 104.

Although not shown in FIG. 14, the printer controller 111 also controls each member in the image forming apparatus 104 such as the motor 115, a polygon motor in the light scanning apparatus 1100, and the like in addition to the above-described data conversion.

Further, although the image forming apparatus 104 for a single color has been described above, the above-described structure can also be applied to a color image forming apparatus for a plurality of colors.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-148571, filed Aug. 30, 2024, which is hereby incorporated by reference herein in its entirety.

What is claimed is:

1. A light scanning apparatus, comprising:
a deflecting unit configured to deflect a light flux from a light source to scan a surface in a main scanning direction; and
a first optical system configured to guide the light flux deflected by the deflecting unit to the surface to be scanned,
wherein a width of the light flux immediately before being incident on a first deflecting surface of the deflecting unit is smaller than a width of the first deflecting surface in a main scanning cross section, and
wherein only a part of the light flux incident on the deflecting unit is deflected toward the surface to be scanned by the first deflecting surface when the first deflecting surface is at a first angle in the main scanning cross section.

2. The light scanning apparatus according to claim 1, further comprising a light receiving element configured to receive the part of the light flux deflected by the first deflecting surface at the first angle,
wherein the light receiving element is arranged on the same side as the light source with respect to an optical axis of the first optical system in the main scanning cross section.

3. The light scanning apparatus according to claim 1, further comprising:
a second optical system configured to cause the light flux from the light source to be incident on the deflecting unit;
a light receiving element configured to receive the part of the light flux deflected by the first deflecting surface at the first angle; and
an optical element configured to guide the part of the light flux deflected by the first deflecting surface at the first angle to the light receiving element,
wherein a width of an incident surface of the optical element is smaller than a width of an optical surface closest to the deflecting unit on an optical path of the second optical system in the main scanning cross section.

4. The light scanning apparatus according to claim 1, further comprising:
a light receiving element configured to receive the part of the light flux deflected by the first deflecting surface at the first angle; and
a reflecting element configured to reflect the part of the light flux deflected by the first deflecting surface at the first angle,
wherein a following condition is satisfied:
$${θ}_{BD} < {θ}_{BDm}$$
where θ_{BD} represents an angle formed by a traveling direction of a principal ray of the light flux immediately before being incident on the reflecting element with respect to an optical axis of the first optical system in the main scanning cross section, and θ_{BDm} represents an angle formed by the traveling direction of the principal ray of the light flux immediately after being reflected by the reflecting element with respect to the optical axis of the first optical system in the main scanning cross section.

5. The light scanning apparatus according to claim 4, wherein a following condition is satisfied:
$${θ}_{BD} < {θ}_{i} \leq {θ}_{BDm}$$
where θᵢ represents an angle formed by the traveling direction of the principal ray of the light flux immediately before being incident on the deflecting unit with respect to the optical axis of the first optical system in the main scanning cross section.

6. The light scanning apparatus according to claim 1, wherein another portion of the light flux which is not deflected by the first deflecting surface among the light flux incident on the deflecting unit is deflected by a second deflecting surface adjacent to the first deflecting surface when the first deflecting surface is at the first angle.

7. The light scanning apparatus according to claim 1, wherein only a part of the light flux incident on the deflecting unit is deflected toward the surface to be scanned by the first deflecting surface when the first deflecting surface is at a second angle in the main scanning cross section.

8. The light scanning apparatus according to claim 7, wherein the part of the light flux deflected by the first deflecting surface at the second angle travels to an effective region of the surface to be scanned.

9. The light scanning apparatus according to claim 8, wherein the part of the light flux deflected by the first deflecting surface at the second angle travels to an outermost off-axis image height on a side of the surface to be scanned opposite to a side on which the light source is arranged.

10. The light scanning apparatus according to claim 1, wherein a following condition is satisfied:
$$5.5 \leq φ - K \times N \times ( N - 1 ) \leq 13.$$
where φ [mm] represents a diameter of a circumscribed circle in the main scanning cross section of the deflecting unit, N represents a number of deflecting surfaces of the deflecting unit, and K represents a predetermined value of 0.52 or more and 0.56 or less.

11. The light scanning apparatus according to claim 1, wherein a width of the part of the light flux deflected by the first deflecting surface at the first angle is smaller than a width of the light flux immediately before being incident on the first deflecting surface in the main scanning cross section.

12. The light scanning apparatus according to claim 1, wherein a following condition is satisfied:
$$6. < \frac{ϕ + 15}{N} < 7.4$$
where φ [mm] represents a diameter of a circumscribed circle in the main scanning cross section of the deflecting unit, and N represents a number of deflecting surfaces of the deflecting unit.

13. The light scanning apparatus according to claim 1, wherein a following condition is satisfied:
$$22.6 < \frac{{Y}_{max +}}{( \frac{ϕ}{N} )} < 37.$$
where φ represents a diameter of a circumscribed circle in the main scanning cross section of the deflecting unit, N represents a number of deflecting surfaces of the deflecting unit, and Yₘₐₓ₊ represents a distance in the main scanning direction between an on-axis image height and an outermost off-axis image height on a side on which the light source is arranged on the surface to be scanned.

14. The light scanning apparatus according to claim 1, wherein a following condition is satisfied:
$$1.78 < \frac{{θ}_{i} + {θ}_{max +}}{{θ}_{BD}} < 2.33$$
where θᵢ represents an angle formed by a traveling direction of a principal ray of the light flux immediately before being incident on the deflecting unit with respect to an optical axis of the first optical system in the main scanning cross section, θₘₐₓ₊ represents an angle formed by the traveling direction of the principal ray of the light flux traveling to an outermost off-axis image height on a side on which the light source is arranged immediately after being deflected by the deflecting unit with respect to the optical axis of the first optical system in the main scanning cross section, and θ_{BD} represents an angle formed by the traveling direction of the principal ray of the light flux traveling to a center of a light receiving surface of a light receiving element immediately after being deflected by the deflecting unit with respect to the optical axis of the first optical system in the main scanning cross section.

15. The light scanning apparatus according to claim 1,
wherein the first optical system is formed by a single optical element, and
wherein a following condition is satisfied:
$$0.23 < \frac{{θ}_{BD} + {θ}_{max +}}{( \frac{360}{N} )} < 0.35$$
where θₘₐₓ₊ [°] represents an angle formed by a traveling direction of a principal ray of the light flux traveling to an outermost off-axis image height on a side on which the light source is arranged immediately after being deflected by the deflecting unit with respect to an optical axis of the first optical system in the main scanning cross section, θ_{BD} [°] represents an angle formed by the traveling direction of the principal ray of the light flux traveling to a center of a light receiving surface of a light receiving element immediately after being deflected by the deflecting unit with respect to the optical axis of the first optical system in the main scanning cross section, and N represents a number of deflecting surfaces of the deflecting unit.

16. The light scanning apparatus according to claim 1,
wherein the first optical system is formed by a plurality of optical elements,
wherein the part of the light flux deflected by the first deflecting surface at the first angle is received by a light receiving element without passing through the first optical system, and
wherein a following condition is satisfied:
$$\frac{360}{N} - 45 < {θ}_{BD} - {θ}_{max +} < \frac{( \frac{360}{N} )}{2}$$
where θₘₐₓ₊ [°] represents an angle formed by a traveling direction of a principal ray of the light flux traveling to an outermost off-axis image height on a side on which the light source is arranged immediately after being deflected by the deflecting unit with respect to an optical axis of the first optical system in the main scanning cross section, θ_{BD} [°] represents an angle formed by the traveling direction of the principal ray of the light flux traveling to a center of a light receiving surface of the light receiving element immediately after being deflected by the deflecting unit with respect to the optical axis of the first optical system in the main scanning cross section, and N represents a number of deflecting surfaces of the deflecting unit.

17. The light scanning apparatus according to claim 1,
wherein the first optical system is formed by a plurality of optical elements,
wherein the part of the light flux deflected by the first deflecting surface at the first angle is received by a light receiving element after passing through at least one optical element included in the first optical system, and
wherein a following condition is satisfied:
$$0.145 < \frac{{θ}_{BD} + {θ}_{max +}}{( \frac{360}{N} )} < 0.182$$
where θₘₐₓ₊ [°] represents an angle formed by a traveling direction of a principal ray of the light flux traveling to an outermost off-axis image height on a side on which the light source is arranged immediately after being deflected by the deflecting unit with respect to an optical axis of the first optical system in the main scanning cross section, θ_{BD} [°] represents an angle formed by the traveling direction of the principal ray of the light flux traveling to a center of a light receiving surface of the light receiving element immediately after being deflected by the deflecting unit with respect to the optical axis of the first optical system in the main scanning cross section, and N represents a number of deflecting surfaces of the deflecting unit.

18. The light scanning apparatus according to claim 1, wherein a following condition is satisfied:
$${W}_{BD} < {W}_{max -} < {W}_{max +}$$
where W_{BD} represents a width of the light flux deflected by the first deflecting surface and then travels to a center of a light receiving surface of a light receiving element in the main scanning cross section, Wₘₐₓ₊ represents a width of the light flux deflected by the first deflecting surface and then travels to an outermost off-axis image height on a side on which the light source is arranged in the main scanning cross section, and Wₘₐₓ₋ represents a width of the light flux deflected by the first deflecting surface and then travels to an outermost off-axis image height on a side opposite to the side on which the light source is arranged in the main scanning cross section.

19. The light scanning apparatus according to claim 1, wherein a following condition is satisfied:
$$47. \leq {θ}_{max +} \leq 57.$$
where θₘₐₓ₊ [°] an angle formed by a traveling direction of a principal ray of the light flux traveling to an outermost off-axis image height on a side on which the light source is arranged immediately after being deflected by the deflecting unit with respect to an optical axis of the first optical system in the main scanning cross section.

20. An image forming apparatus, comprising:
the light scanning apparatus according to claim 1; and
a developing unit configured to develop an electrostatic latent image formed on a surface to be scanned by the light scanning apparatus.
